(19) United States
(12) Patent Application Publication
(10) Pub. No.: US 2026/0178850 A1
(43) Pub. Date: Jun. 25, 2026

(54) REFINING ITEM DESCRIPTIONS USING VISUAL MEDIA INPUTS

(71) Applicant: Block, Inc., Oakland, CA (US)

(72) Inventors: Katherine CHUNG, New York City, NY (US); Xiao WEN, Toronto, ON (CA); Alice HAU, New York City, NY (US); Andy ALMONTE, Port St. Lucie, FL (US)

(73) Assignee: Block, Inc., Oakland, CA (US)

(21) Appl. No.: 18/988,126

(22) Filed: Dec. 19, 2024

(51) Int. Cl. G06F 40/47

(52) U.S. Cl. CPC G06F 40/47

(57) ABSTRACT

Technologies are described herein for refining, using visual media inputs, generative artificial intelligence (AI) model outputs that include item descriptions. In some implementations, a method includes receiving, from a first device, a component list for an item that is to be included in a menu of items, the list including multiple components. Using a first generative AI model, a text natural language response is generated that includes a description for the item based on the component list. The text natural language response and visual media data of the item are provided to a second generative AI model that modifies the description for the item in the text natural language response based on detection of at least one component in the visual media data. The modified description is provided to the first device for inclusion in the menu of items.

### TECHNICAL FIELD

Artificial Intelligence (AI) models, such as large language models (LLMs), often rely on user prompts to create an output. For example, an LLM may receive a user prompt and generate a response to the prompt based upon the text contained therein. Furthermore, users seeking different responses often must rewrite their prompt or input modifying prompts many times until a desired output is returned.

The description provided herein is for the purpose of presenting the context of the disclosure. Content of this section, as well as aspects of the description that may not otherwise qualify as prior art at the time of filing, are neither expressly nor impliedly admitted as prior art against the present disclosure.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram showing aspects of an illustrative operating environment and several logical components provided by the technologies described herein;

FIG. 2 is a flow diagram illustrating a method to generate and refine descriptions of items based on input including visual media data, according to some implementations;

FIG. 3 is a flow diagram illustrating a method to determine input data to generative AI model to generate and refine descriptions of items, according to some implementations;

FIG. 4 is a flow diagram illustrating a method to detect components of component list in visual media data to refine descriptions of items, according to some implementations;

FIG. 5 is a flow diagram illustrating a method to generate and refine a playlist of media content items based on input including visual media data, according to some implementations;

FIG. 6 is a flow diagram illustrating a method to determine input data to one or more machine learning models for generating a playlist of media content items, according to some implementations;

FIG. 7 is a diagrammatic illustration of an example user interface which can enable a user to specify and modify input and prompts to a generative AI model, according to some implementations;

FIGS. 8A-8C are diagrams showing another example user interface which can enable a user to specify and modify input and prompts to a generative AI model, according to some implementations;

FIGS. 9A-9B are diagrams showing another example user interface which can enable a user to specify and modify input and prompts to a generative AI model, according to some implementations;

FIG. 10 is a flow diagram illustrating aspects of a method of training a machine learning model, according to some implementations;

FIG. 11 illustrates an example environment that may employ the techniques presented herein, according to an implementation presented herein;

FIG. 12 illustrates another example environment that may employ the techniques presented herein, according to an implementation presented herein; and

FIG. 13 illustrates another example environment that may employ the techniques presented herein, according to an implementation presented herein.

### DETAILED DESCRIPTION

The following detailed description is related to technologies for improving output relevancy from artificial intelligence (AI) models by providing visual media data in prompts. The visual media data can enhance the prompt such that both search and response generation are more accurate and computationally efficient. For example, AI models may include generative AI models that leverage existing data to create new content. One type of generative AI model may include a large language model (LLM). Other AI models, including models operative to generate different forms of outputs (e.g., media, audio, video, images, etc.), are also applicable.

Many different users may use generative AI models for a variety of purposes, including generating summaries of existing documents, generating images and/or sequences of images based on descriptive text, generating bibliographic data from a plurality of sources, and other generative purposes, based on a user prompt provided by the user.

A user prompt in this context may be a natural language text prompt or input describing a task that a generative AI model is requested to perform. Prompts may include some examples of data requested, which can be automatically retrieved from a database with document retrieval, sometimes using a vector database. In conventional generative AI models, standard, text-based user prompts may be correlated to an overall quality of the output of a generative AI model. For example, as an amount of descriptive text in the user prompt increases, an accuracy and/or relevancy of the output may also increase in some circumstances.

However, outputs of AI models may still be limited even given greater amounts of descriptive text. In some cases, an increase in descriptive text of a user prompt may trigger an undesirable output and/or an output of reduced relevancy and/or accuracy. For example, conflicting language, run-on sentences, improper punctuation, and other grammatical aspects of a user prompt may lead to an irrelevant or sometimes incorrect output from an AI model. Further, the need to input large amounts of descriptive text may become burdensome for a user. Additionally, in some examples, user prompts of differing grammar and/or sentence structure may provide dramatically different outputs.

Some users may attempt to perform “prompt engineering” or other methods of prompt structuring in an attempt to overcome these drawbacks. Prompt engineering is a process of structuring text that can be interpreted and understood by the generative AI model. Given a query, a document retriever is called to retrieve relevant documents (e.g., which can be measured by first encoding the query and the documents into vectors, then finding the documents with vectors closest in Euclidean norm (or other information distance metrics) to the query vector). The generative AI model then generates an output based on both the query and the retrieved documents. Depending upon the user prompt, the generative AI model may retrieve documents ranked as more relevant based on processing of the input user prompt. In prompt engineering, if an output is irrelevant and/or otherwise unwanted, the user would modify the prompt, usually by adding descriptive text to the initial prompt. This can be a tedious process, with many iterations of modification by a user prior to receiving an output that is satisfactory. Each iteration to modify a prompt utilizes significant computational resources, with the generative AI model analyzing the user inputs leading up to and including the current modification, retrieving relevant documents for each user input, generating outputs based on the individual user inputs and respective retrieved documents, and generating a relevant output for each.

In some examples, descriptions of items that are to be displayed in online presentations such as menus, event descriptions, and other descriptive formats have styles, tones, and/or formats that must be customized for a particular use. In other examples, media content that is played in particular physical locations may have requirements in style, tone, and/or format for the location. AI models may not provide a desired style or format in generated descriptions or content recommendations, leading to users rewriting their prompts many times until a satisfactory output is returned.

However, as described herein, example implementations may provide systems, methods, and apparatuses configured to provide visual media data to improve output relevancy of generative AI models while conserving processing resources and network transmissions by reducing the number of prompt iterations required to achieve a desired output.

In some implementations, a first AI system may receive a text prompt from a first device that includes a text component list that describes, in text, multiple components of an item. For example, the item can be a food item that includes ingredients as components. The first ML model generates a text natural language response that includes a description for the item based on the component list. For example, the generated description can be a menu description for a food menu that provides descriptions for food items offered by a restaurant or other food service. The ML system, such as a second ML model in some implementations, obtains an image of the item that depicts, in the pixels of the image, one or more components of the item (such as ingredients of a food item) from the list of components. An AI model (trained to detect features in images) modifies the description for the item based on detection in the image of one or more components in the component list by the AI model, and provides the modified description for inclusion in the menu of items.

In other examples, the item can be a catalog item or product (e.g., an item for sale such as accessories, clothing, tools, home products, and others) that includes a list of sub-components or features for the product. The first ML model generates a test natural language response that includes a description for the product based on the sub-components and/or features. For example, the generated description can be a catalog description, website description, and/or “blurb” that provides a summary description of the product for sale to consumers. The ML system, such as a second ML model in some implementations, obtains an image of the product that may contain supplemental and/or additional information about the product in visual form. An AI model trained to detect image features may modify the first description of the product based on detection of various supplemental and/or additional features contained in the image.

In some implementations, visual media data can be used by one or more of the AI models in other ways. For example, visual media data can be combined with initial text input as a multi-modal input prompt to one or more AI models that can generate an accurate description based on both the text input and sub-components or features detected in the visual media data. In some implementations, visual media data can be the initial prompt to one or more AI models, e.g., without accompanying text input, prompt, or list, and the AI model(s) can generate an accurate description of a depicted item based on sub-components and/or features detected in the visual media data.

Other example implementations may provide systems, methods, and apparatuses configured to provide a playlist of relevant media items based on prompts that include visual media data such as images or videos. For example, in some implementations, context data related to the playlist includes visual media data that depicts a physical area of a merchant where the playlist is to be played. The context data is provided to a content recommendation service that includes machine learning model(s) and which searches a catalog based on the context data to provide a list of recommended content items. The list of recommended content items and the context data, including the visual media data, are provided to a generative AI model, which filters and ranks the recommended content items into an ordered playlist of content items based on the context data. The playlist is thus highly relevant to the physical area in which it will be played, based in part on images depicting the area.

In another example, context data related to the playlist includes visual media data that visually depicts one or more aspects of a merchant requesting the playlist (e.g., images of a merchant space, typical products sold by the merchant, images of patrons in the merchant space (waiting in line or seated), and/or other aspects). The context data is provided to the content recommendation service that includes machine learning model(s) and which searches a catalog based on the context data to provide a list of recommended content items. The list of recommended content items and the context data, including the visual media data, are provided to a generative AI model, which filters and ranks the recommended content items into an ordered playlist of content items based on the context data and identified aspects of the merchant. The playlist is thus highly relevant to one or more features depicted in the visual data (e.g., a coffee shop may receive playlist recommendations based on typical listening habits of coffee patrons in a particular geographic area; a toy store may receive playlist recommendations based on a season of sale or target demographic depicted in the visual data; a gym may receive playlist recommendations based on an intended area of listening (e.g., cardio area, weightlifting area, rest area, etc.); and others).

In some implementations, based on the generated text description and the associated visual media data, a generative AI model may generate text descriptions and/or images that are more relevant to a presentation and context than those generated by conventional techniques. For example, as one or more images are input to format a prompt, the formatted prompt may be more relevant to an intended output requested by the user. Furthermore, as context associated with an initial list of components or context data is retained and implemented in the formatted prompt, results that are relevant to a context associated with that data may be more readily output by the generative AI model.

As described herein, these and other technical effects and benefits overcome drawbacks associated with conventional generative AI models and associated outputs. For example, as a formatted prompt is generated automatically, user interaction (e.g., by way of multiple rounds of user inputs) with the generative AI model for manual prompt refinement may be reduced. In this manner, associated bandwidth for repetitive prompt refinement iterations may be reduced. For example, by using visual media data that makes a prompt provided to the generative AI model more relevant to the user, less inputs are needed to get a desired output to the initial user prompt, thus consuming fewer resources and network transmissions to achieve a result. Furthermore, by providing relevantly formatted prompts to the generative AI model, fewer model execution cycles are necessary to arrive at a relevant generative output, thereby reducing compute cycles, memory usage, and network bandwidth.

Additionally, the input to a machine learning model is more likely to achieve a desired result without repetitive typing and/or additional inputs by a user. In this manner, the utility of the generative AI model may be improved with reduced effort as compared to retraining the generative AI model (e.g., the inputs are more likely to provide relevant results, thereby reducing a need for retraining); deployment of new generative AI models (e.g., the inputs are more likely to provide relevant results with an outdated model, thereby reducing a frequency of new model deployment due to irrelevant results); etc.

Described generative AI models may be deployed at a service provider network, in some implementations. As such, data associated with a particular service offered by the service provider network may be accessible to the generative AI models. In this example, outputs that are relevant to both a user and an associated service or entity operated or consumed by the user (e.g., business of the user) may be realized (e.g., personalization of outputs), thereby further improving the utility of the generative AI model and the user experience associated with using the generative AI model. For example, by providing images that are relevant to the user and a service or entity operated by or consumed by the user, the generative AI model is also more likely to provide a desired output with less computational cycles, less storage resources, and less bandwidth.

These and other technical effects and benefits will become apparent in this disclosure.

In the following detailed description, references are made to the accompanying drawings that form a part hereof, and which are shown by way of illustration as specific implementations or examples. Referring now to the drawings, aspects of computing systems and methodologies for visual media data prompts for improving generative AI outputs are described in detail.

It should be appreciated that the subject matter presented herein may be implemented as a computer process, a computer-controlled apparatus, a computing system, or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures, and other types of structures that perform particular tasks or implement particular abstract data types.

Those skilled in the art will also appreciate that aspects of the subject matter described herein may be practiced on or in conjunction with other computer system configurations beyond those described herein, including multiprocessor systems, microprocessor-based or programmable consumer electronics, minicomputers, mainframe computers, handheld computers, personal digital assistants, e-readers, mobile telephone devices, tablet computing devices, special-purposed hardware devices, network appliances, and the like. The configurations described herein may be practiced in distributed computing environments, where tasks may be performed by remote computing devices that are linked through a communications network. In a distributed computing environment, program modules may be located in both local and remote memory storage devices.

In the following detailed description, references are made to the accompanying drawings that form a part hereof, and that show, by way of illustration, specific configurations or examples. The drawings herein are not drawn to scale. Like numerals represent like elements throughout the several figures (which may be referred to herein as a “FIG.” or “FIGS.”).

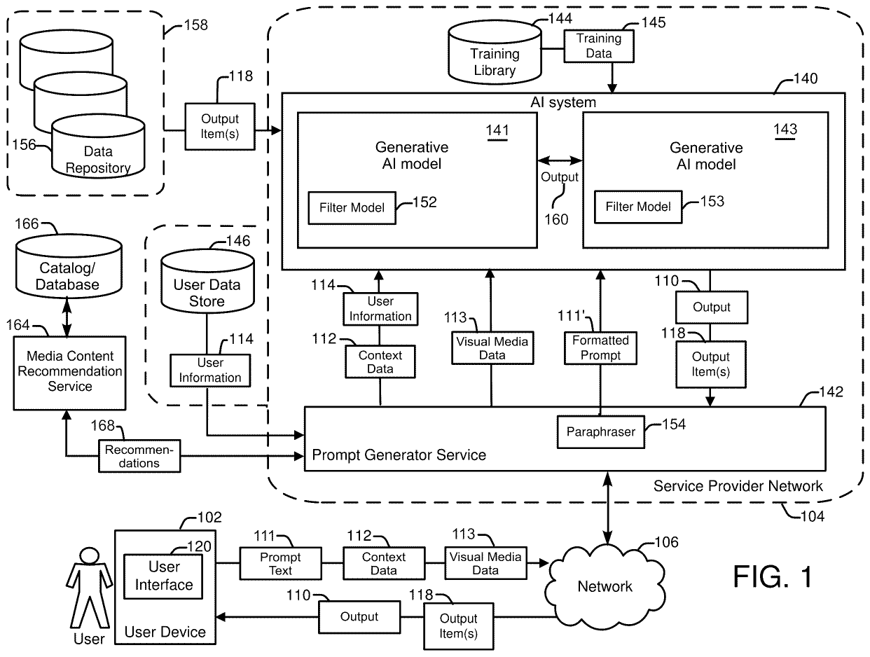

FIG. 1 illustrates an operating environment and several logical components provided by the technologies described herein. In particular, FIG. 1 is a diagram showing a system 100, according to one implementation.

System 100 is provided for illustration. In some implementations, the system 100 may include the same, fewer, more, or different elements configured in the same or different manner as that shown in FIG. 1.

The system 100 may include a user device 102 and a service provider network 104, connected via a network 106. While a single user and user device are illustrated, differing numbers of users and user devices may be operatively connected to the network 106 and/or in operation with the system 100.

User device 102 may include any suitable computing device, for example a personal computer (PC), point-of-sale (POS) terminal, mobile device (e.g., laptop, mobile phone, smart phone, table computer, netbook computer, wearable device, etc.), network-connected television, audio/video componentry with Internet access, network-connected cable set-top box, network-connected audio/video device (e.g., HDMI-interfaced smart component configured to display video and provide audio to a television or monitor), automobile head-unit with network-access (e.g., car stereo or car console device), or other suitable device.

User device 102 may be associated with a user. User device 102 may include one or more instances of a user interface 120 configured to execute thereon. In some implementations, the user interface 120 includes computer-executable code configured to implement the technologies as described herein. User interface 120 may be configured to provide one or more graphical user interfaces (GUI), receive user profile data, receive user selections, output the selections, output user prompt text, and others.

For example, in some implementations, user interface 120 is configured to present a GUI. The GUI may be configured to receive prompt text 111 from a user and context data 112. Context data 112 may include characteristics data related to the user and/or an environment, entity, activity, event, item, etc. associated with the user, and is to be used by the service provider network 104 for generative AI purposes.

In some implementations, prompt text 111 may be received from one or more other sources. For example, prompt text 111 may be received from a different user interface, from a third-party service (e.g., short message system text message, email, etc.), from a text-from-speech processor or service (e.g., based on input speech captured at a microphone or on a phone-call), from an image processor or service, from a video processor or service, and/or from other suitable sources.

Prompt text 111 may include text representative of a desired output of a generative AI model, e.g., including a request for a particular output. For example, prompt text 111 may include words in a first language. The words in the first language may be arranged as part of an intended output, in some implementations. For example, in some example implementations described herein, a user may input prompt text that describes an instruction to be performed, such as to generate a description for an item, or generate a custom playlist of media content items. For example, a user may input prompt text that describes merchant-related functions, such as to generate a food item menu including food items and descriptions of the food items including item ingredients. In other example, a user may input prompt text that describes attributes of a playlist of music tracks, e.g., name, genre of content, etc.

In some implementations, prompt text 111 may also include words in one or more coding languages (e.g., C++, C #, Java, HTML, pseudocode, etc.). For example, a user may input prompt text describing a webpage to be created in HTML (e.g., a webpage including a menu of items or media content selections in a playlist) or a function to be created in JavaScript. Other examples may include, but are not limited to, generating a database script, generating a custom function to perform a particular computer-related task, and other examples.

In some implementations, prompt text 111 may include a user-specified output format (e.g., menu, playlist, memorandum, webpage template, narrative, etc.). For example, a user may input prompt text describing a page type, language format, an active voice, a passive voice, and others. For example, a user may input prompt text describing a food item menu, a style and tone or mood of the business or service that offers the menu, and other attributes of an output format. Other examples include, but are not limited to, page sizes, formal or informal language, length of descriptions, intended recipient(s), intended audience, and others.

In some implementations, the prompt text may be a natural language sentence that describes the desired output in plain English or in another language. For example, a user may input prompt text as one or more sentences describing a desired output, e.g., an activity to be performed (play a playlist, present a menu, etc.).

In some implementations, the prompt text 111 may also include context data indicating one or more contexts. For example, a user may input prompt text describing an intended audience or recipient, or an activity related to the output. For example, a user may input prompt text describing a prior output to be refined or a prior input prompt to be expanded upon. Contextual data may also include user contextual data such as user demographics, user account history, user listening history, user purchase history, user location history, and other user data.

Other variations of prompt text, types of prompts, formats of prompts, and others, may be applicable to some example implementations.

Context data 112 may include selections of various aspects or characteristics of various entities or objects. For example, context selections may include characteristics that, although they can change, are generally inherent to a user or to an entity (e.g., business), activity, item, etc. associated with the user. Examples of context data (or user information) may include demographic information, a business operated by the user (e.g., a merchant user), address, phone number, and the like. As such, context data 112 may include one or more of: user demographics, user name, user employment data, user identification (ID), user age, and other profile data.

For example, context data may include data that can describe an environment, event, activity, item or object, or situation associated with the user. Examples of context data may include current location, current time (e.g., of the day, week, year, etc.), history of recent media content consumption, recent transaction history, recent interactions with other users, recent job history, recent requests from a generative AI model, and the like. Context data may also include user contextual data such as user demographics, user account history, user listening history, user purchase history, user location history, and other user data.

In some implementations, context data (and/or user information 114) may include characteristics of a business that is operated by the user (e.g., a merchant user). For example, the characteristics can include the name of the business, the type of the business (e.g., restaurant/food service, retail of certain product types, service or repair of certain product types, etc.), a merchant classification code (MCC) associated with the business, one or more locations associated with the business, hours that the business operates, and the like. In some implementations, a style, mood, or tone description associated with the business can be included in context data.

With regards to user data and context data, users are provided with control over whether programs or features collect user information about that particular user or other users relevant to the program or feature. Individual users for which information is to be collected are presented with options (e.g., via a user interface) to allow a user to exert control over the information collection relevant to that user, to provide permission or authorization as to whether the information is collected and as to which portions of the information are to be collected. For instance, users can opt-in to have all, some, or none of the user data and context data be shared with the service provider to be used in prompt generation. This can be presented in a user interface or via any suitable means for configuring such data sharing settings. Once selections are made by the user, the user data and context data can be leveraged by the service provider without further user input according to the user-defined settings, thus reducing the number of prompt refinements needed to achieve a satisfactory result.

In various implementations described herein, visual media data 113 that includes one or more images and/or videos can also be provided by the user device (and/or can be obtained from other sources as described herein). “Visual media,” “visual media data,” “visual media content,” or “visual media content items,” as used to herein refers to images, videos, animated images (e.g., animated GIFs), or other visual media formats that depict imagery, e.g., in pixels. The visual media data can be considered another form of context data that can indicate characteristics related to the context of use of the output to be generated by the generative AI system. For example, in some implementations in which text descriptions of a menu item are requested to be generated by the generative AI system, one or more images or videos that depict the item may be included in visual media data 113. In some implementations in which a playlist of media content items is requested to be generated by the generative AI system, one or more images or videos that depict a physical location at which the playlist is to be played (e.g., output on speakers and/or display screen) are included in visual media data 113, such as a dining area of a physical restaurant, a retail space, a space with gym equipment, etc. Images or videos depicting other characteristic data related to the context of use for the output can also or alternatively be included in visual media data 113 (e.g., images of a place or item that provide a style or mood that is desired for a playlist or description to evoke; e.g., an image of a birthday party as a characteristic for a context to prompt the generative AI system to generate a playlist of festive music, an image of a seasonal sale in the fall for context to prompt the generative AI system to generate a playlist of seasonal hits, etc.).

Prompt text 111, context data 112, and visual media data 113 can be transmitted to the service provider network 104 over the network 106. In some implementations, the prompt text 111, context data 112, and/or visual media data 113 can be received by the service provider network 104 directly from the user device 102, and/or can be received from other data sources and devices connected to network 106 (e.g., other users of service 104, an online platform, site, database, or server that stores context data for the user, etc.).

In some implementations, network 106 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

The service provider network 104 may be a platform including one or more servers having one or more computing devices (e.g., a cloud computing system, cluster of physical servers, etc.). The service provider network 104 may be configured as a software-as-a-service (SaaS) platform, a financial services platform, a media content platform, a social networking platform, or as another computing platform configured to provide services to a variety of users.

The service provider network 104 may include an AI system 140 that can include one or more instances of an AI model 141 (e.g., a generative AI model or other model type, but referred to hereafter as “generative AI model 141”) and a prompt generator service 142.

Prompt generator service 142 may include computer executable code configured to provide prompts to AI system 140 based on data received from the user. In some implementations, the prompt generator service 142 is a back-end software service executing on one or more servers of the service provider network 104. In this example, the prompt generator service 142 provides back-end service to the user interface 120, which serves as a front-end.

In some implementations, prompt generator service 142 is a functional back-end and front-end providing access to generative services of the service provider network as software-as-a-service (SaaS) platform. In this example, prompt generator service 142 may be accessible to user device 102 through a website, a mobile application, a desktop application, or other suitable program.

In some implementations, prompt generator service 142 provides the functionality of user interface 120, as well as back-end functionality as described herein. In this example, user interface 120 may be used interchangeably with prompt generator service 142.

In some implementations, prompt generator service 142, and/or other component(s) of service 104, provide moderation of input data (e.g., prompt text 111, context data 112, visual media data 113, and other obtained input data) to detect potentially harmful content in text and images of this data and remove such content before formatting it and/or providing it to AI system 140.

In some implementations, prompt generator service 142 includes a paraphraser component 154. Paraphraser component 154 may be a software component configured to output a formatted prompt 111′. The formatted prompt 111′ may be a formatted version of the prompt text 111. For example, the formatted prompt 111′ may include at least a portion of the prompt text 111 and additional data (e.g., text) provided by paraphraser component 154.

In some implementations, the additional text provided by paraphraser component 154 may include one or more items from user data store 146. For example, the additional text provided by the paraphraser component may also include one or more selections indicated in context data 112, such as data related to the user and/or an entity associated with the user, such as an organization or business. For example, the additional text provided by the paraphraser component may also include context data extracted from user information 114 from user data store 146.

In some implementations, prompt generator service 142 and/or AI system 140 (or portions thereof) can be executed on user device 102. In some examples, user device 102 can download one or more generative AI models 141 and/143 and run the model(s) locally on the device, which can improve data privacy and reduce use of network and communication resources in some implementations.

In some implementations, user data store 146 may be stored in a non-transitory computer readable memory (e.g., random access memory), a cache, a drive (e.g., a hard drive), a flash drive, a database system, or another type of component or device capable of storing data. The user data store 146 may also include multiple storage components (e.g., multiple drives or multiple databases) that may also span multiple computing devices (e.g., across multiple server computers, in a distributed storage system, etc.).

In some implementations, context data may be obtained from one or more other devices connected over network 106, instead of or in addition to data from user data store 146.

Prompt generator service 142 can provide formatted prompt 111′, context data 112, and visual media data 113 to AI system 140. In some implementations, the formatted prompt 111′ is provided by paraphraser component 154 to AI system 140. In some examples, paraphraser component 154 provides the formatted prompt 111′ to prompt generator service 142, and prompt generator service 142 provides the formatted prompt 111′ to AI system 140. In some implementations, formatted prompt 111′ includes visual media data 113, and in other implementations, formatted prompt 111′ does not include visual media data 113 until a different stage of input.

AI model system 140 can include one or more pre-trained generative AI models 141, in some implementations. In some implementations, the generative AI models can include LLMs and/or other neural network-based models. In some implementations, a single AI model 141 is used to process the input data. In some implementations, multiple AI models can be used to process various portions of data. In some examples, AI model 141 and AI model 143 can be used, and/or additional AI models. For example, in some implementations, prompt text 111′ and/or context data 112 can be provided to AI model 141 which can generate a first output result based on this data. For example, the first output result can include a text description of an item, or can include a playlist of media content items. In some implementations, the first output result, along with visual media data 113, can be input to AI model 143 to allow AI model 143 to refine the first output result based on the visual media data. In some of these implementations, AI model 141 can be trained specifically to provide text output based on text input, and AI model 143 can be trained specifically to modify text input based on received images to produce refined text output. Thus, relevant results based on training specialization in different AI models can be obtained. In some implementations, AI model 141 and/or AI model 143 can be a multimodal model, which can include, in some implementations, encoding components (e.g., modality encoder(s)) that extract features from visual media data to provide a more compact and streamlined representation of the data, that are sent to a modality interface that aligns the features into a form that is sent to and interpretable by a language model (e.g., LLM) in the model 141 and/or 143. In some implementations, the language model that receives these features can also receive text data in the data input to the model 141 or 143, e.g., text data in formatted prompt 111′ and context data 112 and/or encoded versions thereof.

In some implementations, a single AI model (e.g., 141) can be trained for the generative tasks and used, e.g., receive data 111′, 112, and 113 and output results (e.g., a refined text description or playlist of media content items) based on these inputs. In some implementations, a generative AI model can include functionality associated with the AI model 141 and the AI model 143 integrated therein, e.g., as sub-models.

In some examples, a user may select a type of model and/or a particular model (or sub-model) from multiple AI models in AI system 140 based on a prepopulated listing provided at the user interface 120. For example, one or more generative AI models with descriptions of relevant functionality may be presented to a user for selection. Upon selection (e.g., via user input to the user interface 120 or other input), the selected model(s) may be configured to receive formatted prompts as described herein. In some cases, a model preference may be stored with user data 146 to be included with the formatted prompt 111′, such that model selection can be accomplished automatically at the time the prompt 111 is received and without additional user input.

The AI system 140 may be configured to receive, as input, user information 114, context data 112, and/or the formatted prompt 111′.

In some implementations, data repositories 156 may be stored in a non-transitory computer readable memory (e.g., random access memory), a cache, a drive (e.g., a hard drive), a flash drive, a database system, or another type of component or device capable of storing data. The data repositories 156 may also include multiple storage components (e.g., multiple drives or multiple databases) that may also span multiple computing devices (e.g., across multiple server computers, in a distributed storage system, etc.). In some implementations, the data repositories 156 are part of a data repository network 158. In some implementations, the data repositories 156 are part of the service provider network 104.

Media content recommendation service 164 (“content recommendation service”) can be used in some implementations to provide one or more recommendations of content based on input received by the service. For example, the content recommendation service can include or be in operative communication with one or more machine learning models that can search a connected catalog or database 166, and/or an index of the catalog, for content items that correspond to or are related to the input, such as prompt text 111 and context data 112 received from the user and/or user information 114 from user data store 146.

In some implementations, content recommendation service 164 and/or catalog 166 can be included in AI model system 140 and/or service 104, and/or service 164 can use or access generative AI models 141 and/or 143 to search catalog 166 as described herein.

In some implementations, prompt generator service 142 can formulate a prompt for content recommendation service 164. Prompt generator service 142 can provide context data 112 and/or user information 114 in a prompt provided for recommendation service 154. For example, user information 114 may be associated with a user account ID. In some implementations, user information 114 can include a consumption history (e.g., listening, watching, reading, etc.) associated with the user account ID, such as the media content items the user account ID has consumed, media content items that the user account ID skipped or replayed, context associated with consumption (e.g., time of day, time of year, activity being performed, device connections such as speakers or headphones, etc.), media content items that the user account ID has saved, “liked,” favorited, added to a playlist, or “disliked,” and the like. The machine learning models of recommendation service 164 may use context data 112 and/or user information 114 to generate media content recommendations 168. In some cases, the machine learning models may additionally or alternatively receive as input other information provided by the user in prompt text 111 (such as particular genres, artists, media content items, demographic information, and the like), other playback history, device identifiers and history, and/or others, as inputs to determine media content recommendations 168.

Media content recommendation service 164 can provide recommendations 168 to prompt generator service 142, which can include a playlist of content items that are recommended by service 164. In some implementations, content recommendation service 164 can also provide the actual content items, e.g., media data (such as audio data, image data, video data, etc.) that is to be played to provide output from a playing device, e.g., when playing a playlist of content items. For example, in some implementations, such content item data can be included in output items 118 provided to the user device 102.

In some implementations, content recommendation service 164 can embed and index candidate content items in catalog 166. For example, a prompt can be input to a generative AI model 141 and/or 143 to determine content items. An embedding machine learning model can be used to embed the determined content items in embeddings. The embeddings can be indexed using a search and analytics service. In some implementations, the index can be a vector-based catalog index that can be searched using a prompt.

Responsive to receipt of the formatted prompt 111′, the generative AI models 141 and/or 143 may retrieve data such as output items 118 from data repository 156 and/or catalog 166. For example, the retrieved one or more output item(s) 118 may include relevant text descriptions, media content items (e.g., music tracks, audio files, videos, images, etc.), webpages (e.g., food menus of online restaurant websites), articles, documents, art, and/or other data.

In some implementations, generative AI model 141 and/or model 143 generate output 110, based on the formatted prompt 111′, context data 112, visual media data 113, and/or the output item(s) 118. For example, the generative AI model 141 can interpret the output item(s) 118 and the formatted prompt 111′ to generate the output 110.

For example, output 110 may be a natural language output (e.g., text output, audio output, etc.) that describes one or more components of an item described in the formatted prompt 111′ and/or output item(s) 118. For example, output 110 may include one or more documents (e.g., menus, item catalogues, etc.) generated in response to the formatted prompt 111′, user information 114, and/or context data 112. In some cases, a menu and/or item catalogue generated in response to the formatted prompt 111′ may be organized by the generative AI model 141 and/or 143 into categories, such as meal courses or item types, respectively. In other examples, output 110 may include a playlist of media content items.

In some implementations, AI models 141 and/or 143 and/or prompt generator service 142 moderate data provided by the AI models 141 and/or 143 to detect potentially harmful content in text and images of the data, and removes or discards such content such that output 110 sent to user device 102 does not include this content.

The generative AI models 141 and/or 143 may be trained to generate the output 110 in a supervised or semi-supervised manner. In one implementation, the generative AI models 141 and 143 are trained in a supervised training process where training data 145 is retrieved from a training library 144.

In some implementations, the training library 144 may be stored in a non-transitory computer readable memory (e.g., random access memory), a cache, a drive (e.g., a hard drive), a flash drive, a database system, or another type of component or device capable of storing data. The training library 144 may also include multiple storage components (e.g., multiple drives or multiple databases) that may also span multiple computing devices (e.g., across multiple server computers, in a distributed storage system, etc.). The training data 145 may include a plurality of records. Individual records of the plurality of records may include a prompt and a relevant output.

In some implementations, the generative AI model 141 and/or model 143 is a preconfigured model that does not require training.

In some implementations, multiple generative AI models 141, 143, and/or others are provided, where the AI models are customized for specialized types of input/output and/or customized for particular users. For example, if an item description is to be generated, multiple different AI models can be provided, each specialized for generating a description for a different type of item (e.g., food items, retail items, media content items, clothing, electronics, etc.) since different types of items may have different styles, different emphases on particular characteristics (color, ingredients, age suitability, etc.). If a playlist is to be generated, different customized AI models can be specialized for different types of media (e.g., music, video, movies, television shows, etc.) and/or different genres within a type of media (e.g., classical music, jazz, rock music, etc.). A customized AI model can be trained on descriptions and context data for the particular type of item or playlist. In some implementations, prompt generator service 142 or other component of service 104 can determine type(s) of a description or playlist that is being requested, e.g., based on input data such as prompt text 111, context data, and/or visual media data 113, and can route the input data (and/or a formatted prompt 111′) to an appropriate customized generative AI model 141, 143, or other model associated with that type, among multiple available customized AI models. In some implementations, customized generative AI models can be customized for different users (or business of users), e.g., based on the user's associated entity such as a business (e.g., types of products or services sold, ambience of retail spaces, etc.). A customized user AI model can be trained based on context data and product data for a particular user. The prompt generator service 142 or other component of service 104 can route the input data (and/or a formatted prompt 111′) to an appropriate customized generative AI model 141, 143, or other model associated with the requesting user, among multiple such available AI models.

In some implementations, the prompt generator service 142 and/or paraphraser component 154 may be trained in a supervised or semi-supervised manner, and/or trained in a supervised training process where training data 145 is retrieved from the training library 144. In one implementation, the paraphraser component 154 is trained in a supervised training process where training data 145 is retrieved from the training library 144. The paraphraser component 154 may be trained to format the prompt text 111, based on context and/or profile data 146 and/or user information 114 to create the formatted prompt 111′.

In some implementations, both generative AI model 141 and generative AI model 143 are used such that the AI system generates output 110 based on formatted prompt 111′, context data 112, and/or user information 114, and also based on visual media data 113. For example, in some implementations, generative AI model 141 generates output 160 based on the formatted prompt 111′, context data 112, and/or the output item(s) 118. The output 160 is provided to generative AI model 143 that generates output 110 based on the output 160 and visual media data 113. For example, in some implementations, generative AI model 143 has been trained based on input such as text and visual media data 113, and generative AI model 141 has been trained based on input such as text.

For example, the output 110 may be a natural language output (e.g., text output, audio output, etc.) that describes one or more components of an item described in the formatted prompt 111′ and/or output item(s) 118. For example, the output 110 may include one or more documents (e.g., menus, item catalogues, etc.) generated in response to the formatted prompt 111′, user information 114, and/or context data 112. In some cases, a menu and/or item catalogue generated in response to the formatted prompt 111′ may be organized by the generative AI model 141 and/or 143 into categories, such as meal courses or item types, respectively. In other examples and implementations, output 110 may include a playlist of media content items.

During operation or runtime, AI system 140 receives input data including formatted prompt 111′, context data 112, user information 114, and/or visual media data 113. Based on this input data, the generative AI models 141 and/or 143 filter one or more datasets of the data repositories 156 to obtain a filtered dataset or datasets.

AI system 140 (e.g., generative AI models 141 and/or 143), based on the formatted prompt 111′, may retrieve output item(s) 118. Based on the output items and the input data, the generative AI model generates output 110. The output 110 and output item(s) 118 (optional) may be received by the prompt generator service 142 or another component. After receipt (or at substantially the same time), the prompt generator service 142 is configured to provide the output 110 and/or output item(s) 118 (optional) to user interface 120 for presentation to the user.

As described above, the system 100 provides output based on a variety of inputs including visual media data. The user may use the user device 102 to input relevant data to a target output (e.g., select one or more options in a user interface presented by the user interface 120). The user interface 120 may provide prompt text 111, context data 112, and visual media data 113 to the prompt generator service 142 over network 106. The prompt generator service 142 can provide the prompt text 111 to paraphraser component 154.

In some implementations, the paraphraser component 154 can receive the prompt text 111 from the user interface 120. The paraphraser may generate the formatted prompt 111′. The paraphraser component 154 can provide the formatted prompt 111′ to the AI system 140. In various implementations, generative AI models 141 and/or 143 can receive the formatted prompt 111′, user information 114, context data 112, and/or visual media data 113. In some implementations, generative AI models 141 and/or 143 may retrieve output item(s) 118 from the filtered datasets. The generative AI models 141 and/or 143 may generate the output 110 based on the input data and/or output item(s) 118.

The generative AI model 140 may provide, as an output, the output 110 and/or the output item(s) 118 to the prompt generator service 142. The prompt generator service 142 may transmit the output 110 and/or the output item(s) 118 to the user device 102. Other variations of these operations may also be applicable.

For example, in some implementations, the prompt generator service 142 may provide some or all of the functionality of the user interface 120. In some implementations, the user interface 120 may provide some or all of the functionality of the prompt generator service 142 and/or paraphraser component 154.

Hereinafter, functionality associated with the above-described operating environment is described in detail.

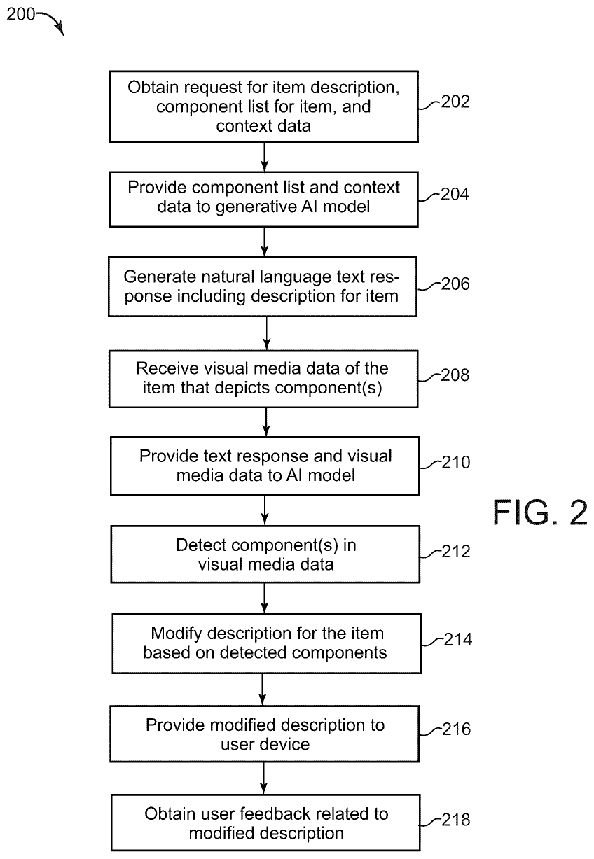

FIG. 2 is a flow diagram illustrating a method 200 to generate and refine descriptions of items based on input including visual media data, according to some implementations. In some implementations, method 200 may be executed by one or more components of the service provider network 104 and/or system 100. Method 200 can be performed (or repeated) in a different order than described herein and/or one or more blocks can be omitted and/or one or more additional functions may be added without departing from the scope of this disclosure. Additionally, portions of the method 200 may be rearranged and/or combined with other methods without departing from the scope of this disclosure. Furthermore, portions of the method 200 may be combined and performed in sequence or in parallel, according to specific implementations, and without departing from the scope of this disclosure. Method 200 may begin at block 202.

In block 202, a request for generation of a description (“requested description”) for an item, a component list for the item, and/or context data for the item are obtained from one or more devices. In some implementations, a user (“requesting user”) provides, via a user device, the request, the component list, and/or at least a portion of the context data to the service provider network 104 to request generation of the description that is related to the item and components. In some implementations, the requesting user provides the request, and the component list and context data is obtained from other devices (e.g., data sources, other devices of other users, etc.). In some implementations, the component list can be accompanied by a name, type, and/or identification of the item. In some implementations, the component list is not accompanied by any identifications of the item, and the item is identified by the AI model(s) based on the components in the component list.

In some implementations, the item is an object or group of objects for which a text description is to be generated. In some examples, the user device is associated with a merchant or seller user, and the item is a food menu item (e.g., a single dish, a group of multiple food items, etc.) that is to be provided on a menu that customers of the merchant user will view as options to select or purchase. The component list can include ingredients of the food menu item. In additional examples, the item can be an object or group of objects to be described in a merchant's catalog, a summary, or other text description, where the object is made up of multiple components. For example, the item can be a desktop computer system item and the component list includes a main CPU unit, a monitor, a keyboard, a mouse, etc. In another example, the item can be a suit of clothing and the component list includes pants, shirt, coat, etc.

Context data (also referred to as “characteristics data” herein) can also be received and/or identified in block 202. For example, the context data can be representative of or associated with the requested description. In some implementations, a context may be explicitly stated in the context data. In some implementations, the context may be inferred by the receiving system, e.g., by a paraphraser component 154 and/or a prompt generator service 104 as in FIG. 1.

For example, the received context data can include context data 112 as described for FIG. 1. The context data can include context data related to or associated with the item. The context data can explicitly describe a type, style, format, etc. of the requested description. For example, context data can include text keywords or other text descriptors provided by a user that are to be associated with the description to be generated by the receiving system. Such descriptors can include keywords indicating a particular length for the requested description (e.g., terse or short, long) as well as style and/or mood of the requested description (e.g., cheerful, funny, etc.). Such descriptors can include examples of descriptions of other items that are to be imitated in style, length, mood, etc. when generating the requested description. Such descriptors can include user feedback (e.g., from sellers and/or customers)

The context data received in block 202 can also include data related to the user requesting the generated description and/or other users. For example, if user permission has been obtained, the context data can include user information such as user information 114 related to the requesting user from a user data store 146 as described for FIG. 1 (e.g., name of a business or other entity operated by the user, location of the business and/or the user, business or user identification (ID), a user profile, demographic information such as age, education, employment, etc.). In some implementations, if user permission has been obtained, a user profile, user input, and/or user history can be obtained, e.g., from a profile data store or other data source. For example, the user history can include previous item descriptions generated for and accepted by the user, previous modifications the user has made to generated descriptions, etc.

The context data can include user feedback from the user and/or other various users (e.g., seller users and/or customer users in a merchant context).

In some implementations, the requesting user is provided options and prompts which the user can select, to cause generation of additional context data that is received in block 202, to select one or more machine learning models to use to generate the requested description, etc.

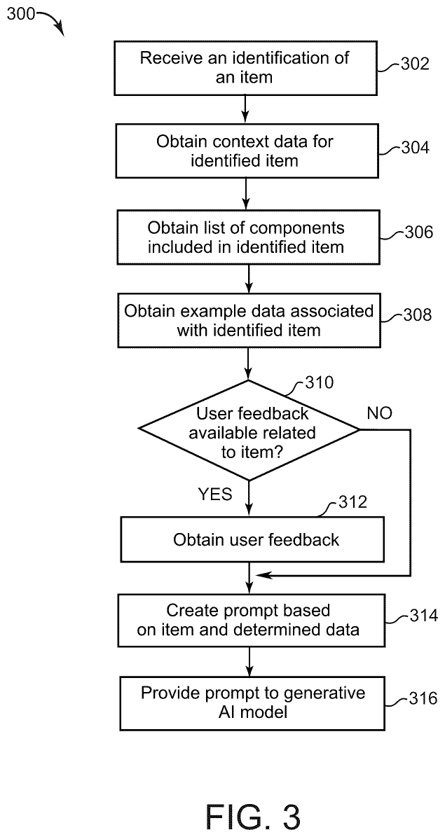

Various examples of context data are described herein, e.g., with reference to FIGS. 3-9. Block 202 may be followed by block 204.

In block 204, the component list and context data are provided to one or more generative AI models. In some implementations, the component list and context data are first formatted into a prompt that may cause the AI model to generate a more accurate or relevant targeted description than if the component list and context data were directly input to the AI model. In some implementations, the formatted prompt includes at least respective portions of the information received in block 202, e.g., each type of the received information.

In some implementations, a prompt generator service generates the formatted prompt. In some implementations, a paraphraser component generates the formatted prompt.

In some implementations, the formatting of the prompt may include formatting to include additional information including context data, user information and past history, or other data that may not have been included in the information received in block 202. For example, the prompt can be formatted to include data such as information related to the business of the requesting user, information related to the item that is to be described, example descriptions of other similar items, etc. In an example, a geographical area of the user's business can be obtained to help determine a preferred style of the description that may vary based on the geographical location of the business and/or the locations of the customer base for the business. The additional information can be retrieved from connected databases and data stores (e.g., 146 or 156 of FIG. 1), if the requesting user has consented to such information use. In some implementations, the context information may be used to select which information to include in the formatted prompt, thus reducing data transmitted over the network when the prompt is communicated to the service provider.

In some implementations, the input data or prompt is provided to a single generative AI model that, for example, has been trained to generate text descriptions based on component lists and context data. In some implementations, multiple generative AI models can receive the input data. Block 204 may be followed by block 206.

In block 206, a text natural language response is generated that includes a description for the item. The generative AI model that received the input data in block 204 generates the description based on the component list and based on context data (if any) provided to the model. The output is a natural language text response. The generative AI model is a machine learning model that has been trained to generate text descriptions based on such input data. For example, the generative AI model can be an LLM and/or other type of neural network, e.g., provided in various types of ML models. Block 206 may be followed by block 208.

In block 208, visual media data of the item is received, where the visual media data depicts one or more components of the component list. The one or more components can be depicted in pixels of the visual media data. For example, the visual media data can be visual media content items that are one or more images, one or more videos, or other visual media types.

In some implementations, the image may only depict some of the components of the item. For example, some ingredients of a food item may be visible, such as dressing on a salad, distinct side dishes, etc. Some ingredients of a food item may be hidden, e.g., mixed with other ingredients such that they are not visually distinguishable in an image.

Block 208 can be implemented at various times in method 200, e.g., simultaneously with any of blocks 202-206, etc. In some implementations or cases, the visual media data can be received from the user device of the requesting user, and/or or can be received from a different device (e.g., a user account of a different user or different business of the requesting user, a database or data store, the internet, etc.). For example, the visual media data can be obtained from one or more user accounts of one or more different merchants that have similar businesses to the requesting user. In other examples, the visual media data can be stock images or videos from a database, service 104, or other source, and/or generated by the one or more generative AI models of service 104 for use in method 200. Block 208 may be followed by block 210.

In block 210, the text response of block 206 and the visual media data of block 208 are provided to a generative AI model. In some implementations, the generative AI model has been trained to generate text responses based on text and visual media data input (e.g., images, videos, etc.). For example, the image-trained generative AI model can be trained to detect features (such as objects, landscape features, etc.) in images and videos, such as by semantic segmentation and/or other computer vision techniques in which a model or algorithm is trained to identify objects in images. In some implementations, the image-trained AI model is the same AI model used in block 206. In some implementations, the image-trained AI model is a different AI model than the generative AI model used in block 206 to generate the text response. Block 210 may be followed by block 212.

In block 212, at least one component from the component list is detected in the visual media data input in block 210 using the image-trained AI model. In some implementations, the image trained AI model detects components that are visible in the visual media data. For example, for a food menu item, ingredients can be detected such as a topping on food (e.g., cream, pepper, garnish, etc.), a base food under the topping if visible, side dishes, etc. Some components may not be visible in the visual media data, e.g., ingredients that are mixed into a food item, or a component within a housing of an item.

In some cases or implementations, there may be additional objects (or portions of those objects) or other features depicted in the visual media data that are unrelated to the item. For example, in an image of a food dish, silverware such as a fork, knife, or spoon may be visible; and/or a hand of a person eating, napkins, table setting, décor in background, etc. The image-trained AI model can be trained to focus on components related to the particular item and to ignore such objects that are not components of the item. For example, the AI model can be trained to segment visual media data such as images and videos into various objects. In some implementations, the image-trained AI model can be trained to ignore segmented objects that are detected to be of a particular category, e.g., with relation to a food item, the objects in categories of silverware, persons or appendages thereof, napkins, background objects such as furniture, lamps, etc. can be ignored. In some implementations, detected objects in the image can be assigned a relevance score based on trained examples, and objects that are detected to be below a threshold relevance score associated with an item that can be ignored. In some implementations, relevance scores and threshold can be determined during training of the model using examples of objects and/or one or more image recognition techniques.

In some implementations, one or more characteristics of the item (and/or characteristics of detected components of the item) can be detected in the visual media data using the image-trained AI model. For example, one or more colors, surface textures, styles, sizes, brand names, or other characteristics can be detected and used in the refinement of the text description, e.g., if such characteristics are not in the text description or are different from characteristics in the text description, similarly as described below for differences in components.

Block 212 may be followed by block 214.

In block 214, the description of the item (the description included in the text response generated in block 206) is modified based on the component(s) detected in the visual media data. For example, the description can be refined based on visual content in the visual media data. In some cases, there may be one or more differences between the components detected in the visual media data and the components in the component list, and this can cause the image-trained AI model to modify the description to reduce or eliminate such differences. In some cases, there may be one or more differences in characteristics of components detected in the visual media data and the same components in the component list, where these characteristics may not be accurately indicated in the text description. This can cause the image-trained AI model to modify the description to reduce or eliminate such differences. In this way, more accurate text descriptions can be automatically generated by an AI model, thus reducing the use of computational resources to send additional or modified prompts to the AI model to generate a more accurate text description.

In some examples, one or more components that are missing from the component list received in block 202 are detected in the visual media data, and the description is refined to include a text description of the visible missing components. For example, a food menu item may have listed the components of a main dish of the menu item, but may have omitted one or more side dishes that come with the menu item; if one or more of these side dishes are visible in the visual media data, the description is refined to include a text description of these visible side dishes.

In further examples, one or more extra components that are present in the component list received in block 202 are not detected in the visual media data, and the description may be refined to remove text description of the extra components. For example, the text description of a food menu item may list ingredients of a topping on the food item, but the visual media data does not include such a topping, and the AI model can refine the description to remove the text description of this topping.

In some implementations, the image-trained AI model may be trained to ignore particular types of differences between the visual media data and the text description. For example, such types of differences can include differences between particular types of components of items. For example, a merchant user may not want to show side dishes in visual media data, yet the food menu item does include those side dishes; in such cases, text description of those side dishes would not be removed. In some implementations, particular types of components such as ingredients mixed into a food item that are not be visible in depictions of the food item in visual media data, and the absence of such components in the visual media data can be ignored by the AI model.

In further examples, there may be one or more differences between characteristics of components detected in the visual media data and the same components in the component list, where these characteristics are not accurately indicated in the text description. In some examples, some types of components may have particular characteristics causing disadvantages or adverse effects on some users, and these characteristics should be noted in the text description of the item. If the image-trained AI model detects components in the visual media data (and/or in the text description) that may have such particular characteristics and determines that the text description of the item does not include any indication of these particular characteristics, then the AI model can modify the text description to include such an indication. For example, the AI model may detect a particular ingredient of a food item in the visual media data (or in the component list) that is an allergen to some customers. A notification or warning about the possible allergen is added to the text description by the AI model.

In some implementations, one or more characteristics of the description are modified in block 214. The characteristics can include at least one of a length of the description (e.g., number of words or sentences), a tone or mood of the description (e.g., funny, bubbly, serious, lighthearted, exaggerated, etc.), a style of the description (e.g., using complex words or simple words, short sentences, etc.), etc. In some implementations, these characteristics can be determined based on the visual media data and/or the other context data. For example, the visual media data may show a brightly lit scene with vivid colors as background for the depicted item, indicating a cheerful mood or tone. The business context data may indicate a more serious type of restaurant, indicating a more serious mood. Block 214 may be followed by block 216.

In block 216, the modified text description generated in block 214 is provided to the user device that requested the description of the item. For example, a user issuing the original request may receive the output via a user interface or another interface of the user device. The user interface may be configured to display, share, store, and/or otherwise interact with the provided output. In some implementations, the output may be displayed with options to “share” or transmit an email, message, or other form of communication with the provided output included therein. Other variations are also applicable.

In some implementations, output items are also retrieved. For example, additional visual media data that depict the item, or generated visual media data that depicts the item, can be provided to the user device. Block 216 may be followed by block 218.

In block 218, user feedback data may be obtained from the requesting user that is related to the modified description provided in block 324. For example, the requesting user may select an interface control such as a thumbs-up or thumbs-down button, or may further modify the modified description, e.g., by changing or deleting words of the description and/or adding additional words. In some implementations, user feedback can include an indication that the user changed the modified description and/or indications of the actual changes made to the modified description by the user, and/or an indication that the user used the generated description and the description that was used, e.g., by providing the description in a menu offered to customers.

Such user feedback data can be stored in accessible storage devices and indexed based on the type or other characteristics of the identified item. For example, such user feedback can be used in determining a prompt as described below for blocks 306 and 308.

In some implementations, after receiving the modified text description in block 216, the user may provide a retry request so that a different description or the received description be refined further by the generative AI model(s). For example, the user can send the modified text description along with any of the previous context data and additional context data, such as additional instructions, keywords or other descriptors, a modified component list, etc. to the service provider network 104 which receives the data similarly to block 202 and proceeds to generate a response similarly as above, including processing the new data received to provide a different output text response. In some implementations, the retry request may be a request to execute the method 200 again without new user input (e.g., automatically reformat a user prompt into a different format to alter the received output).

In some implementations, the user provides a request to generate a second description of the item. A prompt previously created to generate the first description (as described for FIG. 3) is modified based on the user feedback data and is input to a generative AI model to generate the second description of the item.

Method 200 provides a technique for providing visual media data with other input to a generative AI model system and receiving output including a text description (and/or other types of data) from the AI model system that is more accurate and/or relevant to a requesting user, and by extension the intended audience of the output, than those that would be received based on text input alone. For instance, the generative AI model(s) can provide more relevant results by taking into account visual media data. Such processing can decrease the number of “trials” by the user requesting accurate and relevant output, thus reducing storage and/or transmission of irrelevant results, reducing network traffic and reducing computational cycles to achieve a desired result.

In some implementations, the image-trained AI model of blocks 210-214 can receive input data and provide the modified description in block 216, e.g., without use of the AI model described above for blocks 204 and 206. For example, the visual media data of block 208 can be combined with initial text input from block 202 as a multi-modal input prompt to the image-trained AI model that generates a description based on both the text input and sub-components or features detected in the visual media data, without generating the intermediate text response in block 206. In some implementations, visual media data can be the initial prompt to the image-trained AI model, e.g., without accompanying text input, prompt, or list. For example, blocks 202-206 can be omitted, the visual media data is input to the image-trained AI model in block 210 without the text response described above, and the image-trained AI model generates a description of a depicted item in block 214 based on sub-components and/or features detected in the visual media data.

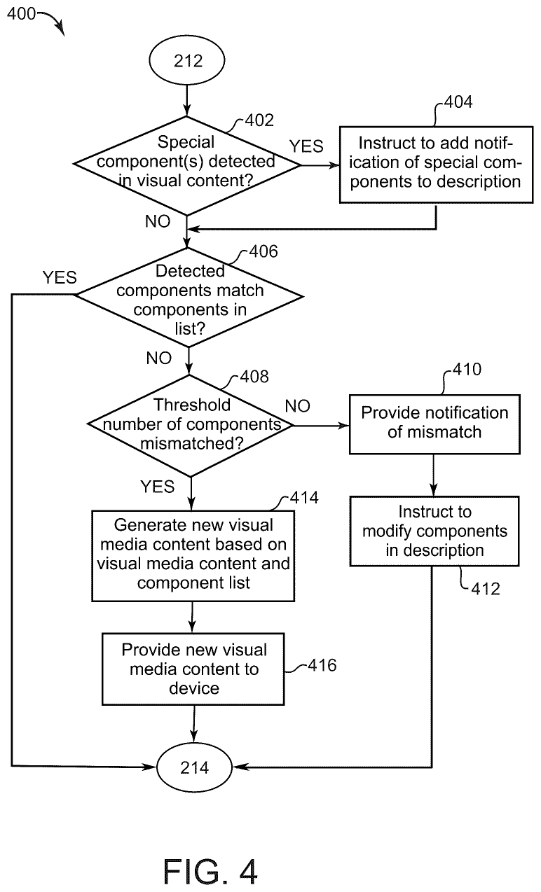

FIG. 3 is a flow diagram illustrating a method 300 to determine input data to a generative AI model to generate and refine descriptions of items, according to some implementations. Method 300 includes one or more features that may be combined or used with method 200 of FIG. 2 and/or method 400 of FIG. 4. For example, method 300 can be performed in or for block 202 of method 200.

In some implementations, method 300 may be executed by one or more components of the service provider network 104 and/or system 100. Method 300 can be performed (or repeated) in a different order than described herein and/or one or more blocks can be omitted and/or one or more additional functions may be added without departing from the scope of this disclosure. Additionally, portions of the method 300 may be rearranged and/or combined with other methods without departing from the scope of this disclosure. Furthermore, portions of the method 300 may be combined and performed in sequence or in parallel, according to specific implementations, and without departing from the scope of this disclosure. Method 300 may begin at block 302.

In block 302, an identification of an item is received from a user device. In some implementations, a user (“requesting user”) provides the item identification to the service provider network 104 to request generation of a description (“requested description”) that is related to the item and components. In some implementations, the item is an object or group of objects for which a text description is to be generated, and/or the requesting user is a seller user, similarly as described above for method 200. In some implementations, the identification of the item is received from a different device, e.g., instructed by the user device.

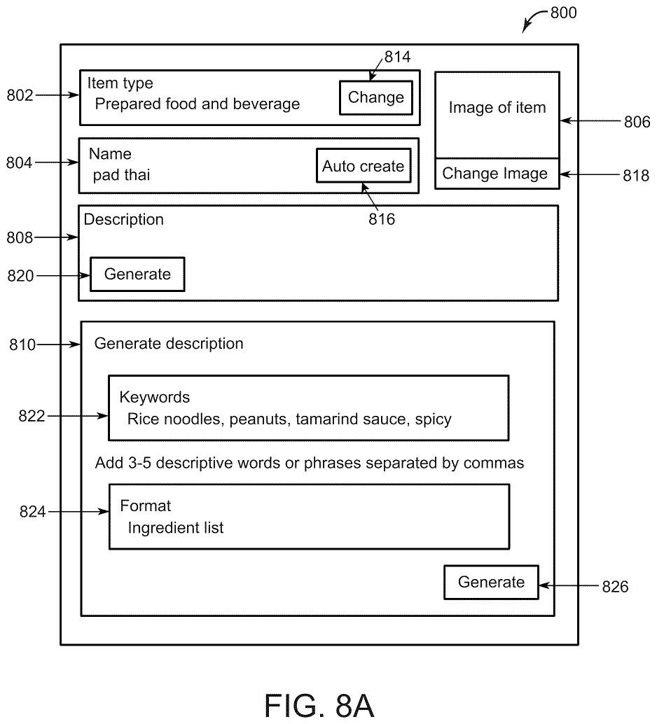

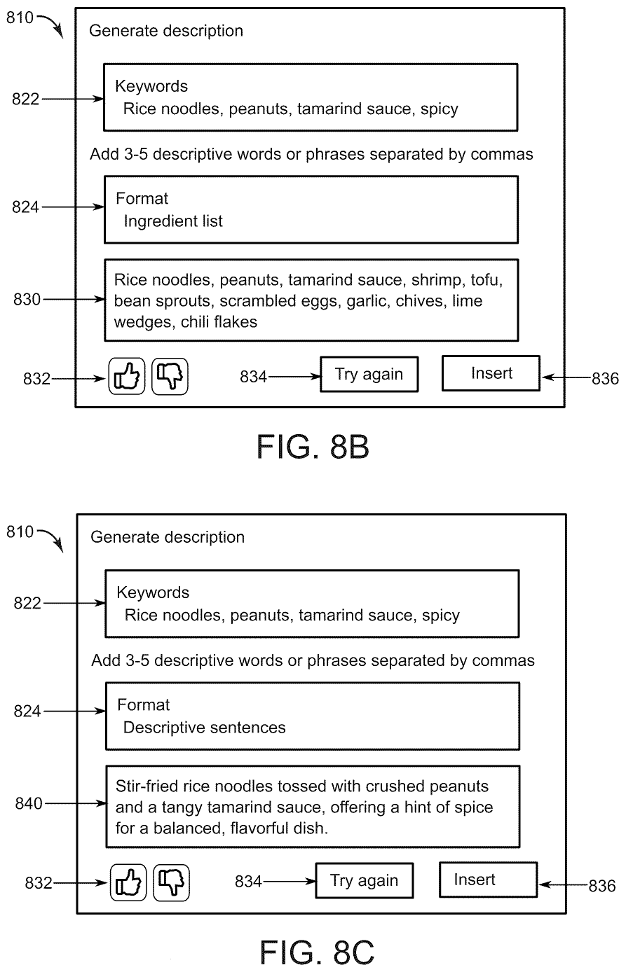

In some implementations, the identification can include a name and/or type of an item, such as “Pad Thai” for a particular type of food dish (as in examples for FIGS. 8A-8C). In some implementations, an item identification is received from the requesting user without additional context data. In some implementations, the item identification and context data are received from the requesting user. In some implementations, the identification of the item is visual media data, e.g., an image or video depicting the item, and the receiving system identifies the item based on the depiction in the image or video, e.g., using image recognition techniques and/or ML models similarly as described for block 212 of FIG. 2. In some implementations, this visual media data can be different than the visual media data obtained in block 208 of FIG. 2 to refine the description (e.g., a different depiction of the item). In some of these implementations receiving visual media data, no text is received in block 302.

In block 304, context data can be obtained for the item identified in block 302. In some implementations or cases, context data of varying types can be obtained in block 304, which can indicate one or more characteristics of the identified item, the requesting user, and/or the requested description. In some examples, the context data can include data similar to the context data described above for method 200. The context data can be received from the requesting user (via a user device) and/or obtained from one or more other devices such as data sources. For example, context data can be obtained such as user information 114 that is associated with the requesting user and/or the user's business, etc. In some implementations, if user consent has been obtained, the context data can include such information as a name of the requesting user, a business associated with the requesting user for which the item will be presented or sold, geographic location of the business, a type, category, or other characteristics of the item, etc.

In some implementations, the requesting user is provided options or configurations which the user can select, e.g., to cause generation of additional context data for the item, to indicate one or more particular machine learning models to use to generate the requested description, etc. In some implementations, no context data is obtained in block 304. Block 304 may be followed by block 306.

In block 306, a list of components is obtained, the components being included in the identified item. The list of components can be considered context data for the identified item. For example, the list of components can be obtained from a user device, or can be partially or completely generated automatically by the service provider network 104 based on the data obtained in blocks 302 and 304, e.g., the identification of the item and/or other received context data.

In some implementations, the list of components can be generated by obtaining data from various data sources such as the Internet, knowledge bases, data stores, data repository 156, etc. that list the components of various items. In some implementations, the list of components can be generated by a machine learning model such as a generative AI model that has been trained to provide components of items when provided the identification of the item and/or context data (if applicable). For example, if the identified item is a food item, the list of components can include ingredients of the identified food that are obtained from data sources (internet sites, knowledge bases, etc.) or can be generated by an AI model. In some implementations, the generative AI model can be the same model used to generate text responses in block 314 (described below).

In some implementations, the identification of the item received in block 302 is visual media data, and the list of components is generated based on the visual media data, e.g., based on components depicted in the visual media data and/or based on obtaining data from various data sources based on an identification of the item in the visual media data as described above. Block 306 may be followed by block 308.

In block 308, in some implementations, example data is obtained that includes text descriptions associated with other items that are different than, but associated with, the identified item. The example data can be considered context data for the identified item. For example, the other items can be similar to, the same type as, or otherwise associated with the identified item. The example data can include text descriptions that are associated with one or more other items that are different than the item and include one or more characteristics of the item. For example, the example descriptions may have a requested style, mood, length, and/or other characteristics that may be indicated by context data received or obtained for the identified item. For example, if the identified item is a food item, descriptions of other food items similar to the identified food item can be obtained, e.g., food items that have the same type or category as the identified food item (e.g., sold in the same section of a menu or store) or have many of the same ingredients (e.g., at least a threshold percentage of the same ingredients). For example, a data source can be accessed such as a catalog of items and associated text descriptions that have previously been generated for these items. For example, the catalog may be indexed based on type and/or other characteristics of items. In some implementations, the example data can include descriptions of items that are top-selling products or recently-added items in the merchant user's product catalog. One or more of the example descriptions can be retrieved as example data, such that relevant descriptions of similar or associated items can be retrieved as context data. Block 308 may be followed by block 310.

In block 310, it is determined whether user feedback is available that is related to previously generated descriptions for items, and whether user feedback is available that is related to the item identified in block 302. For example, as described with respect to block 218, user feedback may have been collected in previous iterations of method 200 and/or 300 (and/or method 400) that indicate user opinions related to previously generated descriptions for items. Such user feedback can include positive and negative indications (e.g., thumbs up or thumbs down buttons selected) and other direct opinions or commentary from users relating to generated results, and/or can include user actions made during a previous description generation process. For example, user actions can include user modification of a generated prompt or a generated description, e.g., replacing, adding, or deleting words in the prompts or descriptions. The user feedback can be determined to be related to the identified item if the feedback applies to item(s) that are similar to the identified item in type, category, characteristics, etc. (similarly as described above for example data for other items).

If relevant user feedback is determined to not be available in block 310, then the process continues to block 310, described below. If relevant feedback is determined to be available, the process continues to block 312.

In block 312, the related user feedback is obtained. The user feedback can be considered context data for the identified item. For example, the user feedback can be stored in and accessed from a database that can be indexed based on item types and other characteristics. In some implementations in which requesting users are sellers or merchants of the items, the user feedback can include seller feedback that was provided by seller users who requested generation of text descriptions for their items. In some implementations, the user feedback can include customer feedback that was provided by customer users who read the text descriptions in a commercial environment (e.g., reading descriptions of food items on a restaurant menu to purchase one or more such items). Block 312 may be followed by block 314.

In block 314, a prompt is created based on the identified item and determined data. In various implementations, the determined data can include data obtained in blocks 302, 304, 306, 308, and/or 312 (e.g., from the user device of the requesting user and/or from other devices, models, and/or data sources).

In some implementations, the prompt is generated and formatted by prompt generator service 142. For example, the prompt can include, or is formatted based on, the item identification and/or type, as well as obtained context data such as characteristics of the requesting user (e.g., user information and history) and the item, examples of related items, related user feedback, etc. as described above.

In some implementations, the prompt can include or be based on context data that includes information that is generated based on data obtained in blocks 302 and 304, such as the list of components generated in block 306. For example, the generated list of components can be included in the prompt similarly as described above in block 204 of method 200 of FIG. 2.

In some implementations, the prompt can be generated based on particular rules for formatting prompts (e.g., having particular types or formats of information such as keywords, instructions, etc.), and/or based on statistics that have been collected over time from multiple previous instances of generating descriptions for similar items (e.g., items that have the same or similar category or type) including user feedback on the descriptions. Statistics may also be collected over time for the performance of items in a commercial environment, e.g., how many items have been purchased. For example, collected statistics may indicate that an item sold in greater amounts after a particular item description in a menu or catalog was changed, such that the description that is associated with greater sales is included in the prompt.

In some implementations, a machine-learning model can determine the prompt. For example, the generative AI model that is used to generate the text response, e.g., as in block 206 of method 200, can be used to generate the prompt, or a different AI model can be used. For example, the data obtained in blocks 302, 304, 306, 308, and 312 can be input to the machine learning model that has been trained to generate prompts based on such input.

In some implementations, a paraphraser component 154 of the prompt generator service generates the formatted prompt. Block 314 may be followed by block 316.

In block 316, the prompt is provided to a generative AI model. For example, block 316 can be similar to block 204 of method 200. The prompt may provide an input that enables the AI model to generate a more accurate or relevant targeted description than if data were directly input to the AI model. In some implementations, the input data or prompt is provided to a single generative AI model that, for example, has been trained to generate text descriptions based on component lists and context data. In some implementations, multiple generative AI models can receive the input data.

Based on the prompt, the generative AI model can generate a natural language text response, as in block 206 of method 200.

Method 300 provides a technique for providing input to a generative AI model system that is more accurate and/or relevant to a user, and by extension the intended audience of the output, than those that would be received based on standard text user input. For instance, context data based on generated lists of components, example data, and user feedback data are provided to a machine learning model to enable more accurate generated output from the model. Such processing can decrease the number of “trials” by the user requesting accurate and relevant output, thus reducing storage and/or transmission of irrelevant results, reducing network traffic and reducing computational cycles to achieve a desired result.

FIG. 4 is a flow diagram illustrating a method 400 to detect components of a component list in visual media data to refine descriptions of items, according to some implementations. Method 400 includes one or more features that may be combined or used with features of method 200 of FIG. 2 and/or method 300 of FIG. 3. For example, method 400 can be performed in or after block 212 of method 200.

In some implementations, method 400 may be executed by one or more components of the service provider network 104 and/or system 100. Method 400 can be performed (or repeated) in a different order than described herein and/or one or more blocks can be omitted and/or one or more additional functions may be added without departing from the scope of this disclosure. Additionally, portions of the method 400 may be rearranged and/or combined with other methods without departing from the scope of this disclosure. Furthermore, portions of the method 400 may be combined and performed in sequence or in parallel, according to specific implementations, and without departing from the scope of this disclosure.

Method 400 may begin after block 212 of method 200 of FIG. 2, or method 400 may be included in the operations of block 212. In block 212, at least one component from the component list is detected in the visual media data using the image-trained AI model. In some implementations, the image trained AI model detects components that are depicted and/or at least partially visible in the visual media data.

In block 402, it is determined whether any of the components detected in the visual media data are special components. For example, the generative AI model may have been trained to detect certain types of categories of components that may have particular characteristics causing hazards, e.g., disadvantages or adverse effects, on some users. For example, the AI model may detect a particular ingredient of a food item in the visual media data (or in the component list) that is an allergen to some customers. In another example, the AI model may detect a component of an electric device that may have a sharp edge, or may carry a high voltage when connected to a power supply.

If one or more special components are not detected in block 402, the method continues to block 406, described below. If one or more special components are detected in block 402, the method continues to block 404, in which it is determined to instruct the generative AI model to add one or more notifications of the special components to the generated item description, as needed. In some implementations, the notifications may be provided if it is determined that the existing text description does not include any description of the characteristics of the special components, e.g., there are one or more differences in characteristics of components detected in the visual media data and the same components in the component list, such that these characteristics may not be accurately indicated in the text description. The text description can be modified to include such an indication. For example, a particular ingredient of a food item may have been in the visual media data (or in the component list) that is a potential allergen to some customers. A notification or warning about the potential allergen is instructed to be added to the text description using the AI model if such a notification is not already present in that description. In some implementations, an instruction to add a notification can also be provided if the text list of components includes a special component and the text response does not include such a notification.

For example, the notification can be additional text added to the description that describes a special status (e.g., potential hazard) of the detected special components of the item. For example, a phrase of “Warning: contains peanuts” can be added at the end of a description of a food item that is detected to include peanuts, which is a potential allergen to some customers of the food item. In some implementations, block 404 can include generating a prompt, the additional text of the notification, and/or a message that is to be provided to the image-trained generative AI model used in block 214 of method 200 that causes the AI model to include the notification in the text description when modifying the text response in block 214. Block 404 may be followed by block 406.

In block 406, it is determined whether the detected components in the visual media data match the components in the list. The number and/or types of components can be checked for equivalence. For example, the text list of components may list ten components included in the item, while six components have been detected in an image that depicts that item. When checking for a match between types of components, it can be determined whether the types of components in the text list are matched to the types of components detected in the image. For example, for a food item, the text list may specify components such as meat, vegetables, and carbohydrate foods, while the detected components from the visual media data may include only meat and vegetables. This determination can include determining whether there are additional or missing component(s) detected in the visual media data compared to the text list of components.

In some implementations, the image-trained AI model may be trained to ignore particular types of differences between the visual media data and the text description when determining a match. For example, such types of differences can include differences between particular types of components of items. In some examples, a merchant user may not want to show side dishes in the provided visual media data, yet the food menu item includes those side dishes. In some implementations, the side dish components can be ignored and if the other components in the text list and the visual media data match, then a match is determined. In some implementations, as described above with reference to block 212 of method 200, additional objects (or portions of those objects) or other features depicted in the visual media data that are unrelated to the item are not detected. For example, in an image of a food item, silverware such as fork, knife, or spoon may be visible; and/or a hand of a person eating, napkins, table setting, décor in background, etc., which are not detected as item components.

If it is determined in block 406 that there is a match between the components in the list and the detected components of the visual media data, then the method continues to block 214 of method 200 to modify the text response based on the visual media data (e.g., based on factors other than mismatched or differing components). In some implementations, an instruction (e.g., included in a prompt) can be provided for the model to not remove or add any components to the description.

If it is determined in block 406 that there is not a match (e.g., there is a mismatch or difference(s)) between the components in the list and the detected components of the visual media data, then the method continues to block 408.

In block 408, it is determined whether at least a threshold number of components that are mismatched or differ between the list and the detected components of the visual media data. In some implementations, the threshold number can be a percentage based on the total number of components of the item (e.g., in the list), e.g., a threshold of 30% of the components in the list, or other thresholds can be used.

If it is determined in block 408 that fewer than the threshold number of components are mismatched (e.g., a negative result), then the method continues to block 410 to provide a notification of the mismatch (e.g., difference(s) in components). The notification can be a separate notification sent to the requesting user (e.g., with output 110) that the mismatch is present, so that the user is aware of the mismatch. In some implementations, the notification can specify the mismatched components, e.g., as text descriptions and/or as visual media data focusing on the mismatched components. Block 410 may be followed by block 412.

In block 412, it is determined to instruct the AI model of block 214 to modify the components in the description. The instruction to modify the components can be included in a prompt or message to the AI model to modify the text response when performing block 214, to change, add, or remove one or more components of the list of components when generating the description. For example, if it has been determined that the visual media data includes two components that were not in the component list, and those two components are of a type that is not ignored, then the instruction can instruct the AI model to add text descriptions of those two components to the text response being refined in block 214. Examples of modifying the text response to change, add, or remove components are described above with reference to block 214 of method 200. Block 412 may be followed by block 214 of method 200.

In some implementations, if it is determined in block 408 that at least a threshold number of components are mismatched, then the method continues to block 414 in which new visual media data may be generated. For example, an image and/or a video can be generated. For example, a prompt can be generated by the prompt generation service 142 and the prompt can be input to the AI model used in block 214 or to a different AI model (e.g., a model trained to generate images or videos from text and/or visual media data) to generate the new visual media data. In some implementations, the prompt can include the components that are common between the component list and the visual media data, and can exclude the components that are not present in both the list and the visual media data. In some implementations, the prompt can include the components in both the list and the visual media data. In some implementations, the prompt can include the context data as described with reference to method 200, and/or can include the visual media data received in block 208 of method 200. The AI model generates new visual media data, which can be visual media data depicting new content or can be a modified version of the existing visual media data (e.g., to depict additional or changed components along with original components), based on these inputs. Block 414 may be followed by block 416.

In block 416, the new visual media data is provided, e.g., to the user device of the requesting user. In some implementations, the new visual media data is sent over the network to the user device, e.g., within output 110, as output item 118, and/or separately from a text response. Block 416 may be followed by block 214 of method 200.

In some implementations, if there are any differences in the components of the list and the visual media data, new visual media data is generated to include the components from the list and the visual media data.

The described features can cause the image-trained AI model to modify the description of an item to reduce or eliminate differences between a text list of components of the item and components depicted in visual media data. In this way, more accurate text descriptions can be automatically generated by an AI model, thus reducing the use of computational resources to send additional or modified prompts to the AI model to generate a more accurate text description.

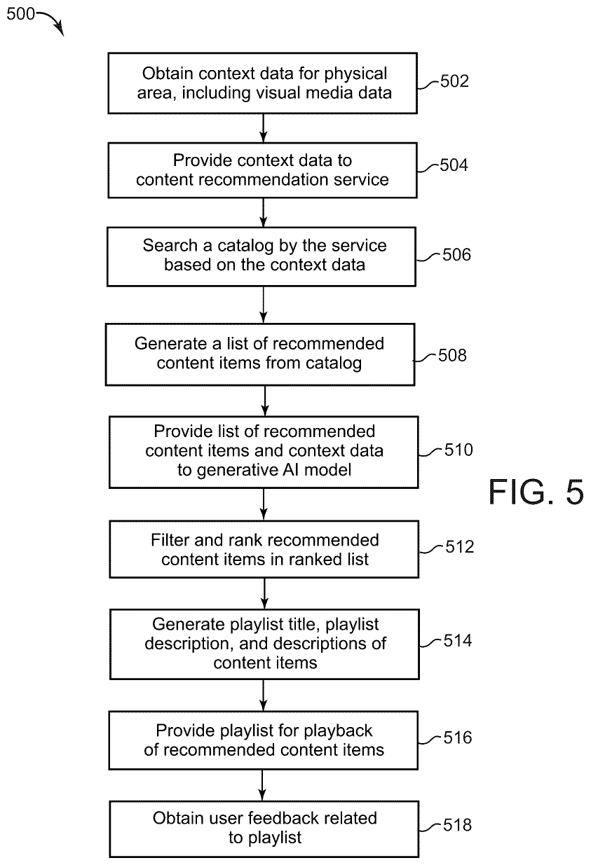

FIG. 5 is a flow diagram illustrating some aspects of a method 500 to generate and refine a playlist of media content items based on input including visual media data, according to some implementations. In some implementations, method 500 may be executed by one or more components of the service provider network 104 and/or system 100. Method 500 can be performed (or repeated) in a different order than described herein and/or one or more blocks can be omitted and/or one or more additional functions may be added without departing from the scope of this disclosure. Additionally, portions of the method 500 may be rearranged and/or combined with other methods without departing from the scope of this disclosure. Furthermore, portions of the method 500 may be combined and performed in sequence or in parallel, according to specific implementations, and without departing from the scope of this disclosure. In various implementations, portions or features of methods 500 and 600 can be combined with methods 200, 300, and 400. Method 500 may begin at block 502.

In block 502, a request to generate a playlist of media content items and context data associated with a physical area associated with a requesting user are obtained, where the context data includes visual media data that depicts the location. In some implementations, the request and at least a portion of the context data are received from a user device used by a requesting user, as a request to the service provider network 104. In some implementations, the request is received from the user device and at least some of the context data is obtained from other device(s) (such as data sources, e.g., databases).

The physical area can be an area in which media content items of the playlist are to be played, e.g., output by display devices and/or audio output devices located in the physical area. In some examples, the user device is associated with a merchant or seller user, and the physical area is a place of a business that is associated with the merchant user. For example, if the business includes a food service and the physical area is an eating area in a restaurant, the playlist is to include media content items, such as music tracks, that are appropriate to play accompanying eating and talking at the eating area by customers. If the physical area is a retail space of the business that offers goods or services to purchase, the playlist is to include media content items, such as music or video, that are appropriate to play accompanying customers browsing the goods and services offered for sale by the business.

Context data can also be obtained (e.g., received and/or identified) in block 502. For example, the context data can be associated with one or more characteristics of the physical area, the business associated with the physical area, the requesting user, and/or the requested playlist. In some implementations, a context may be explicitly stated in the context data. In some implementations, the context may be inferred by the receiving system, e.g., by a paraphraser component 154 and/or a prompt generator service 142 as in FIG. 1.

In some implementations, the context data can include text data indicating a name of the playlist, and/or a type, style, tone, mood, or other characteristics of the physical area and/or the playlist. In some implementations, the request is not accompanied by an identification of the physical area, and the physical area is determined by the service 104 based on context data such as business name, requesting-user name, geographic location data, and/or other context data. For example, the service 104 can consult a database that stores physical area information for various businesses and geographic locations.

For example, the received context data can include context data 112 as described for FIG. 1. The context data can include context data related to or associated with the physical area. The context data can include text indicating the type of business providing the physical area, the goods or services offered at the physical area, a requested style or mood to be presented at the physical area, a geographic location of the physical area, a noise level at the physical area, etc. The context data can include text indicating a genre, type, style, tone or mood, format, etc. of the playlist that is requested. For example, context data can include text keywords or other text descriptors provided by a user that are to be associated with the physical area and/or the playlist to be generated by the receiving system. Such descriptors can include keywords indicating a particular mood or style for the playlist (e.g., pleasant, cheerful, soothing, etc.). Such descriptors can include examples of other playlists that are to be imitated in style, mood, etc. when generating the requested playlist.

The context data received in block 502 can also include data related to the user requesting the generated playlist. For example, if user permission has been obtained, the context data can include user information such as user information 114 related to the requesting user from a user data store 146 as described for FIG. 1 (e.g., identification or name of a business or other entity operated by the user, geographical location of the business and/or the user, function of a location or building, business or user identification (ID), a user profile, demographic information such as age, education, employment, etc.). In some implementations, the context data can include data related to customers, such as non-user-specific data indicating general characteristics or demographics for typical customers of the business providing the physical area.

The context data can include user feedback from various users (e.g., seller users and/or customer users in a merchant context).

In some implementations, user information associated with the requesting user can be obtained as context data. For example, a user profile, user input, and/or user history can be obtained, e.g., from a profile data store or other data source. For example, the user history can include one or more of a playback history of music or video on the service provider network, creation history for an artist associated with the service provider network, etc.

The context data can include characteristics of the business and/or the physical area, such as the times of most popular use of the area by customers, which can be associated with a higher noise level and a particular mood or style of media content items (e.g., louder, more upbeat, higher tempo, flashy visuals, etc.).

In some implementations, the requesting user is provided options (e.g., selective context options in a user interface) which the user can select to cause generation of additional context data that is received in block 502, to select one or more machine learning models to use to generate the requested description, etc. The selective context options can be determined based on other context data, such as user information, business information, visual media data, etc. Some selective context options (e.g., keyword selections) can be generated by the generative AI model(s), examples of which are described below.

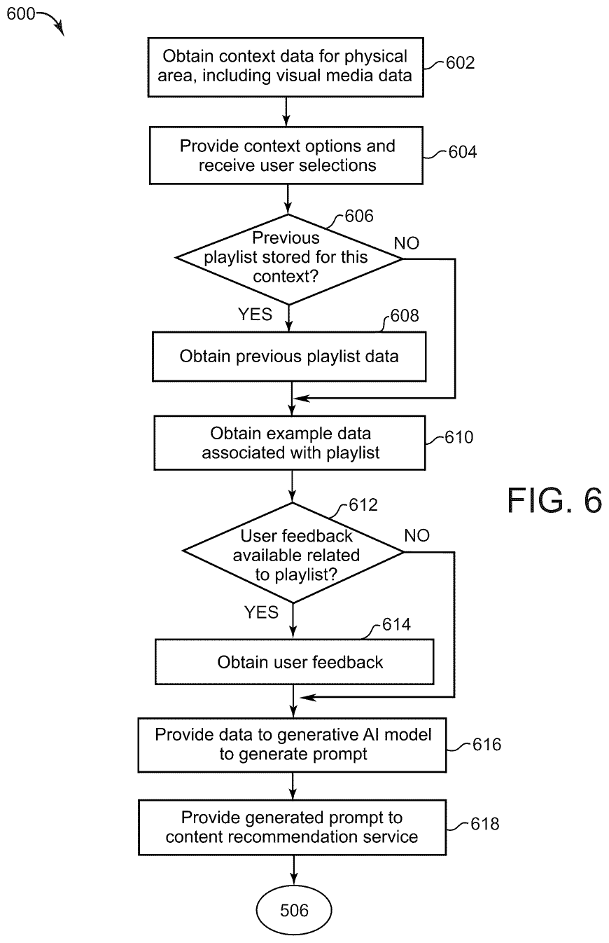

Various examples of context data are described herein, e.g., with reference to FIGS. 6-9B.

The visual media data that depicts the physical location can include one or more images, videos, or other visual media data. The physical location is shown in pixels of the visual media data. In some cases or implementations, the visual media data is provided by the requesting user, e.g., as photos or videos of the physical area. In some cases or implementations, the visual media data can be obtained by the service 104, e.g., by accessing databases or internet sites that have visual depictions of a place of business and geographic location identified for the physical area.

In some implementations, the obtained visual media data can include images or videos depicting features or scenes that do not show the physical area and are to be used as context data. For example, images that indicate a particular mood, ambience, noise level, or other context can be obtained. For example, a cheerful mood can be conveyed by an image depicting a sunlit scene, laughing persons, etc. and not showing the physical area, and this image can indicate a request for a playlist that includes media content conveying a cheerful or humorous mood. Block 502 may be followed by block 504.

In block 504, the context data is provided as a request to a content recommendation service to request media content items. For example, in some implementations, the content recommendation service can employ one or more machine learning models to process a request and determine media content items from a database that match criteria indicated in the request. In some implementations, the context data is first formatted into a prompt that may cause the content recommendation service to generate a more accurate or relevant playlist than if the context data were directly input to the AI model. In some implementations, the formatted prompt includes at least respective portions of the information received in block 502, e.g., each of the types of the received information. In some implementations, a prompt generator service generates the formatted prompt, and/or a paraphraser component generates the formatted prompt. Some examples of formatting a prompt are described below with reference to FIG. 6.

In some implementations, the content recommendation service can use a rules-based approach to determine content recommendations based on context data. For example, particular genres and styles of media content can be searched if particular keywords are present in the received context data.

In some implementations, the formatting of the prompt may include formatting to include additional information including context data, user information and past history, or other data that may not have been included in the information received in block 502. For example, the prompt can be formatted to include data such as information related to the business of the requesting user, information related to the physical area, examples of other playlists, etc. In an example, a geographical area of the user's business can be obtained to help determine a preferred style of the playlist that may vary based on the geographical location of the business and/or the locations of the customer base for the business. The additional information can be retrieved from connected databases and data stores (e.g., 146 and/or 156 of FIG. 1), if the requesting user has consented to such information use.

Block 504 may be followed by block 506.

In block 506, a catalog is searched by the content recommendation service based on the context data. For example, this search can be based on the formatted prompt if such a prompt was created in block 504. The content recommendation service can access a large variety of media content items stored in various databases, which are indexed based on various characteristics. For example, music tracks, videos such as movies, television series, music videos, and other videos, etc. can be available in the catalog. In some implementations, the catalog includes a vector-based catalog index that can be searched using a prompt to the content recommendation service. Block 506 may be followed by block 508.

In block 508, a list of recommended content items from the catalog is generated based on the search performed in block 506. The machine learning model(s) of the content recommendation service can determine which media content items to retrieve based on model training and the received context data including the visual media data. For example, the generative AI model can be an LLM and/or other type of neural network. For example, the context data can indicate a mood (emotions, vibe, atmosphere, etc.), genre, and/or style of media content which is used as search criteria by the content recommendation service to determine the list of recommended content items. The output can be a list of media content item identifications that identify particular media content items such as music tracks, video files, etc.

In some implementations, content item information such as descriptions of or information about the content items in the list of recommended content items can also be determined in block 508 by the content recommendation service. For example, the selected media content items may have associated item information stored in the catalog which can be retrieved. In some implementations, machine learning model(s) used by the service can generate content item information as text descriptions of the selected content items, e.g., based on other information in the catalog, such as artists or studios that created the content items, genre of categorization, year of release, etc. In some implementations, retrieved and/or generated content item information can be included in the context data that is provided to the image-trained generative AI model of block 510. Block 508 may be followed by block 510.

In block 510, the list of recommended content items and context data is provided to an image-trained generative AI model. The context data can include the visual media data that depicts the physical location. In some implementations, the context data includes content item information retrieved and/or generated in block 508 for the recommended content items. In some implementations, the context data is formatted into a prompt for the image-trained generative AI model. For example, this prompt can be different from the prompt provided to the content recommendation service in block 504. In some examples, the context data can include any of the context data used for the content recommendation service, or can be a subset of that context data. In some implementations, one or more additional visual media data can be obtained (e.g., from the user device 102, from a database or other data source based on the list of recommended content items, and/or generated by one or more generative AI models based on the context data and/or the list of recommended content items) and included in the context data provided to the generative AI model to cause the model to further refine the list of recommended content items.

In some implementations, this generative AI model has been trained to generate text responses based on text and visual media data input (e.g., images, videos, etc.). In some implementations, the image-trained AI model is the same machine learning model used in blocks 506 and 508. In some implementations, the image-trained AI model is a different machine learning model than the model used in blocks 506 and 508 to generate the playlist response. For example, the image-trained generative AI model is trained on visual media data while the machine learning model used in the content recommendation service may not have been trained with visual media data and only processes text inputs, such that the list output in block 508 is not based on the visual media data in the context data. Block 510 may be followed by block 512.

In block 512, the recommended content items are filtered and ranked by the image-trained generative AI model in a ranked list based on the context data. For example, the image-trained generative AI model modifies or refines the list of recommended content items based on the context data including the visual media data. In some implementations, the image-trained generative AI model is able to refine the list based on the visual media data in the context data, while the content recommendation service may not have based its list on the visual media data or may not have considered characteristics depicted in the visual media data such as depicted mood, style, etc. of the physical location or other scenes.

In some implementations, the image-trained generative AI model can rank the media content items in the list based on the context data including the visual media data. For example, if a context of sophisticated, quiet, and an expensive mood and style for the physical location is conveyed by the context data, then media content items that are music tracks providing a smooth, low-key, sophisticated music are ranked higher than other media content items that may provide a beat, higher tempo, louder or noisy sound, etc. One or more media content items that have greater than a threshold amount of a particular characteristic (e.g., tempo or beat) or have a threshold number of characteristics conflicting with the conveyed context can be removed from (filtered out of) the list completely.

The output of the image-trained generative AI model is a ranked list that ranks the media content items of the list to be more relevant to the context data and, in some cases, may have had one or more media content items of the received list removed.

In some implementations, the generative AI model can determine a style or mood of the playlist based on at least a portion of the context data, such as the visual media data. The filtering and ranking of the recommended content items can be based on the determined playlist style or mood. For example, the visual media data depicting a sophisticated dining area may cause the AI model to filter out silly or flippant music tracks from the list of recommended content items. In some implementations, the generative AI model uses the content information about the recommended content items in the filtering and ranking of the recommended content items, e.g., to determine genres, categories, tempos, etc. of the content items. Block 512 may be followed by block 514.

In block 514, a playlist title, playlist description, and/or descriptions of associated context items are generated or obtained by the image-trained generative AI model. For example, the playlist title can be a title relevant to the genre, mood, style, and/or other characteristics of the media content items in the ranked list. The playlist description can be a text response describing the characteristics of the media content items in the ranked list. The descriptions of the associated content items can describe a style, mood, tempo, and other characteristics of the media content items. In some implementations, the playlist title and description may be generated by the AI model. In some implementations, the content item descriptions can be generated by the AI model, and/or may have been retrieved or generated by the content recommendation service as described above for block 508. Block 514 may be followed by block 516.

In block 516, a playlist including the ranked list of content items is provided to the user device that requested the playlist. The requesting user can play the playlist on the user device or other device, e.g., at the physical area indicated by context data, or at another location. For example, a user issuing the original request may receive the output via a user interface or another interface of the user device. The user interface may be configured to display, edit, share, store, and/or otherwise interact with the provided output playlist. In some implementations, the output may be displayed with options to “share” or transmit an email, message, or other form of communication with the provided playlist included therein. Other variations are also applicable.

In some implementations, output items 118 are also provided to the user device from one or more datasets. For example, the data for the media content items in the playlist can be provided to the user device, and/or associated other content data (e.g., images or video associated with music tracks, supplemental information associated with the media content items, etc.). Block 514 may be followed by block 516.

In block 518, user feedback may be obtained from the requesting user that is related to the playlist provided in block 516. For example, the requesting user may select an interface control such as a thumbs-up or thumbs-down button, or may modify the playlist, e.g., by changing, adding, or deleting media content items to the playlist, rearranging the order of media content items in the playlist, etc. In some implementations, user feedback data can include an indication that the user skipped or repeated playback on one or more content items in the playlist; an indication that the user changed the playlist (e.g., changed the order of media content items played, deleted or added media content items, etc.) and indications of the actual changes made to the playlist list by the user; and/or an indication that the user played the playlist at the physical area.

Such user feedback can be stored in accessible storage devices and indexed based on the type or other characteristics of the identified item. For example, such user feedback can be used in determining a prompt as described with reference to FIG. 6.

In some implementations, after receiving the playlist in block 516, the user may provide a retry request so that a different playlist is provided or the received playlist is refined further by the generative AI model(s). For example, the user can send the playlist along with any of the previous context data and/or additional context data, such as additional instructions, keywords or other descriptors, a modified playlist, etc. to the service provider network 104 which receives the data similarly to block 502 and proceeds to generate a playlist similarly as above, including processing the new data received to provide a different output response. In some cases or implementations, the retry request may be a request to execute the method 500 again without new user input (e.g., automatically reformat a user prompt into a different format to alter the received output).

In some implementations, the user can provide a request to generate a second playlist. A prompt previously created to generate the first playlist (as described for FIG. 6) can be modified based on the user feedback data and can be input to a generative AI model to generate the second playlist.

Method 500 provides a technique for providing visual media data with other input to a generative AI model system and receiving output including playlist of media content items from the AI model system that is more relevant to a physical area, and by extension the intended audience of the output, than those that would be received based on text input alone. For instance, the generative AI model(s) can provide more relevant results by taking into account the visual media data. Such processing can decrease the number of “trials” by the user requesting accurate and relevant output, thus reducing storage and/or transmission of irrelevant results, reducing network traffic and reducing computational cycles to achieve a desired result.

FIG. 6 is a flow diagram illustrating aspects of a method 600 to determine input data to one or more machine learning models for generating a playlist of media content items, according to some implementations. Method 600 includes one or more features that may be combined or used with method 500 of FIG. 5. For example, method 600 can be performed in block 504 of method 500 to generate a prompt that is provided to a machine learning model of a content recommendation service.

In some implementations, method 600 may be executed by one or more components of the service provider network 104 and/or system 100. For example, method 600 can be performed by prompt generation service 142, a generative AI model 141 or 143, and/or related components.

Method 600 can be performed (or repeated) in a different order than described herein and/or one or more blocks can be omitted and/or one or more additional functions may be added without departing from the scope of this disclosure. Additionally, portions of the method 600 may be rearranged and/or combined with other methods without departing from the scope of this disclosure. Furthermore, portions of the method 600 may be combined and performed in sequence or in parallel, according to specific implementations, and without departing from the scope of this disclosure. Method 600 may begin at block 602.

In block 602, context data associated with the physical area described with reference to method 500 is obtained. The context data includes visual media data depicting the physical location, such as one or more images or videos. As described for method 500, context data of varying types can be obtained in block 604, which can indicate one or more characteristics of the physical area, the requested playlist, and/or the requesting user, or other characteristics that are related to the requested playlist. The context data can include user information related to the requesting user. In some implementations, the context data can include text or visual media data describing or depicting items that are to be used or purchased in the physical area in which the playlist is to be played (e.g., food items to be served in a restaurant area where the playlist is to be played). In some implementations, the visual content data is obtained without any other context data. In various implementations, the context data can be received from the requesting user and/or from other devices (e.g., data sources). Block 602 may be followed by block 604.

In block 604, one or more context options are generated and presented to the user device based on the context data received in block 602, and user selections of the context options are sent to the receiving system to provide additional context data for the generation of the playlist. For example, context options can be a variety of suggestions to allow the user to indicate a particular style, genre, mood, etc. for the requested playlist. In some examples, multiple different keyword suggestions can be generated based on the context data received in block 602 and presented at the user device in a user interface as buttons which the requesting user can select to submit as additional context data. In some examples, if a request for playlist indicates music tracks, context option buttons that show keywords indicating different styles of music can be sent to the user device for presentation in a user interface to allow the user to selection one or more of the keyword buttons to indicate desired context data. Other forms of options can also be presented, such as fields to allow the user to input text, a set of images (e.g., stock images retrieved from a database) in which images may indicate different moods or styles can be presented for the user to select, a tree of hierarchical option categories that allow a user to indicate greater specificity at lower levels of the hierarchy, etc. Block 604 may be followed by block 606.

In block 606, in some implementations, it is determined whether there is a previous playlist stored for the current context, e.g., for the same business and/or physical area. For example, the requesting user may have previously requested generation of a playlist for the physical area and may have played the playlist. Identifications of media content items included in such previous playlists can be stored for later access.

If previous playlists are determined to not be stored in block 606, then the process continues to block 610, described below. If relevant feedback is determined to be available, the process continues to block 608.

In block 608, one or more previous playlists are obtained. For example, the identifications of the media content items included in the previous playlists, the order of media content items in previous playlists, the genres, styles, moods, and other characteristics of the previous playlists, etc., can be obtained. The previous playlist can be used as a base or starting point for generating the requested playlist in method 500. For example, the requested playlist can be generated as a modification of a previous playlist that had been generated for the same physical area and business activity. Differences between the previous playlist and the requested playlist can be determined and these differences can be indicated in the prompt generated in block 618 below and/or the generative AI models that generate and/or refine the playlist can modify the previous playlist based on the differences. For example, if the previous playlist was generated to be played at a time of day having peak business and the most customers present at the physical area, and the requested playlist is to be played at a different time of day with fewer customers present in the physical area, then the previous playlist can be instructed to be modified accordingly in the generated prompt, e.g., to be quieter, have lower tempo music, etc. (e.g., these characteristics specified as additional context data). Block 608 may be followed by block 610.

In block 610, in some implementations, example data associated with the playlist may be obtained. For example, example data is obtained that includes playlists that include descriptions of media content items that are different than, but associated with, the requested playlist. The example data can be considered context data for the identified item. For example, the other playlists can include media content items that have one or more characteristics that are the same as or similar to characteristics of media content items desired for the requested playlist; such characteristics can include media genre, style, mood, length, etc. For example, if the requested playlist is for music tracks in a smooth jazz genre, example playlists for smooth jazz music tracks can be obtained and used as example data. In some implementations, the example data can be obtained by the service 104 automatically; or the example data can be obtained based on one or instructions from the requesting user. For example, a data source can be accessed and searched such as a database of media content items and associated text descriptions that have previously been generated for playlists having the same or similar characteristics. For example, the database may be indexed based on genre, style, artist, and/or other characteristics of items. Block 610 may be followed by block 612.

In block 612, in some implementations, it is determined whether user feedback is available that is related to previously-generated playlists, and whether user feedback is available that is related to the requested playlist. For example, as described with respect to block 518, user feedback may have been collected in previous iterations of method 500 and/or 600 that indicate user opinions related to previously-generated playlists of media content items. Such user feedback can include direct feedback such as positive and negative indications (e.g., thumbs up or thumbs down buttons selected) and other direct opinions or commentary from users relating to generated results, and/or can include indirect feedback in the form of user actions made during or after a previous playlist generation process. For example, user actions can include user modification of a generated prompt or a generated description, e.g., replacing, adding, or deleting words in the prompts or descriptions, playing a generated playlist, skipping or repeating content items of a generated playlist in playback, etc. The user feedback can be determined to be related to the requested playlist if the feedback applies to media content item(s) that are similar to media content items of the requested playlist in style, genre or other category, mood, etc. (similarly as described above for example data for other playlists).

If relevant user feedback is determined to not be available in block 612, then the process continues to block 616, described below. If relevant feedback is determined to be available, the process continues to block 614.

In block 614, the related user feedback is obtained. The user feedback can be considered context data for the identified item. For example, the user feedback can be stored in and accessed from a database that can be indexed based on item types and other characteristics. In some implementations in which requesting users are sellers or merchants of a business that includes the physical area, the user feedback can include seller feedback that was provided by seller users who requested generation of playlists for their items. In some implementations, the user feedback can include customer feedback that was provided by customer users who experienced the media content items at the physical area, e.g., in a commercial environment of the business. Block 614 may be followed by block 616.

In block 616, the obtained data is provided to a generative AI model that generates a prompt based on the data. In some implementations, the prompt is generated by prompt generator service 142 that includes the generative AI model. For example, context data including characteristics of physical area and playlist, and requesting user, previously-generated playlist data, example data, and user feedback as determined above can be provided to the generative AI model. For example, in various implementations, the determined data can include data obtained in blocks 602, 604, 606, 608, and/or 612 (e.g., from the user device of the requesting user and/or from other devices, models, and/or data sources). In some implementations, the generative AI model has been trained to generate a prompt having a particular format. For example, in some implementations, the generated prompt that is suitable for a content recommendation service that searches a vector-based catalog as in some examples described with reference to FIGS. 1 and 5.

In some examples, the generated prompt can include data derived from input that includes visual media data (e.g., images or videos depicting various content such as the physical space, and/or subjects conveying particular moods or themes, etc.) and other context data as described above. In some implementations, text descriptions based on the visual media data can be generated by the model and included in the prompt. In some implementations, the generative AI model can be trained to determine characteristics such as moods (e.g., including emotions, atmosphere, etc.), tones or styles based on visual depictions in the visual media data (e.g., visual depictions of a crowded location, a traditional simple location, or a quiet and dark location, can indicate moods such as “trendy”, “rustic”, or “lonely,” respectively). In some implementations, such characteristics can achieve high vector similarity with a catalog of content items searched by the content recommendation service, e.g., more similarity than other types of characteristics such as lighting, color, architecture style, etc.

In some implementations, the generative AI model can generate data to be included in the prompt, and the generated data includes, or is derived from, one or more characteristics of context data that is received or selected by the user. For example, if visual media data (and/or text) is received as context data that depicts or describes a food item, the generative AI model can generate prompt data that includes or is related to one or more characteristics of the food item, such as the country or city of origin of the food item, the flavors or texture of the food item (spicy, hot, smooth, etc.), etc. Such characteristics or data can be included in the prompt to cause the content recommendation service to find media content items related to those characteristics such as the country of origin, etc. Other characteristics related to indicated items or locations can also be determined and included as prompt data, e.g., authors or artists, climate of country of origin (hot, rainy, etc.), cost of the item, etc.

In some implementations, the prompt can be generated based on particular rules for formatting prompts (e.g., having particular types or formats of information such as keywords, instructions, etc.), and/or based on statistics that have been collected over time from multiple previous instances of generating prompts for playlist generation including user feedback on the playlists. Statistics may also be collected over time for the performance of playlists in a commercial environment, e.g., how many purchases during playlist playback. For example, collected statistics may indicate sales occurred in greater amounts after a particular item description in a menu or catalog was changed, such that the description that is associated with greater sales is included in the prompt.

Block 616 may be followed by block 618.

In block 618, the prompt generated in block 616 is provided to one or more machine learning models, such as the content recommendation service as described above with reference to block 504 of method 500. Block 618 may be followed by block 506 of method 500 as described above with reference to FIG. 5.

The generated prompt may provide an input that enables the content recommendation service to generate a more accurate or relevant playlist than if context data were directly input to the service. Method 600 provides techniques for providing various forms of context data and generation of a prompt that enable generation of relevant playlists to a user, and by extension the intended audience of the output (e.g., persons located in the physical area), than those that would be received based on text user input alone. Such processing can decrease the number of “trials” by the user requesting accurate and relevant output, thus reducing storage and/or transmission of irrelevant results, reducing network traffic and reducing computational cycles to achieve a desired result.

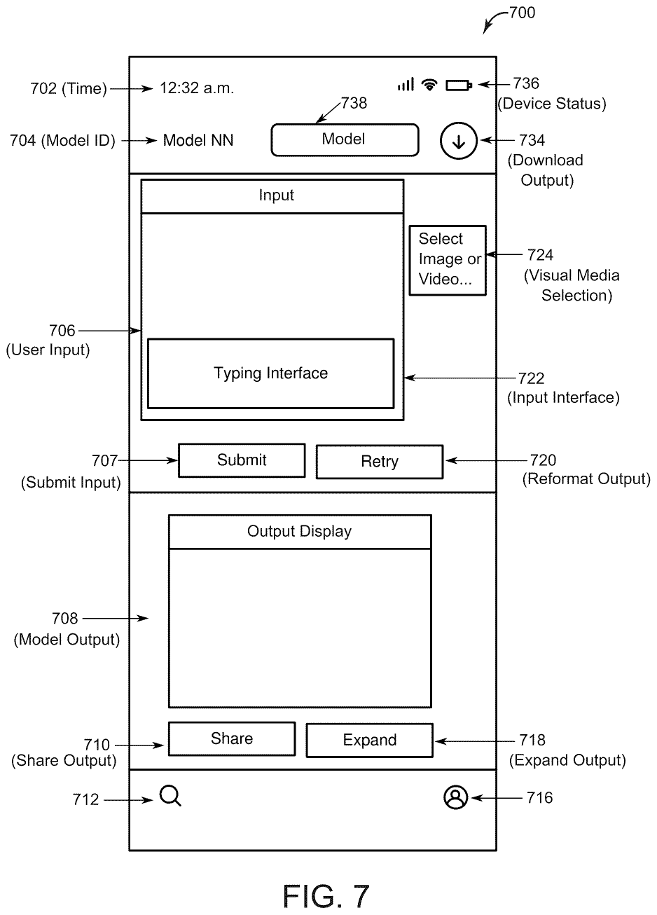

FIG. 7 is a diagram of an example user interface 700 which can enable a user to specify and modify input and prompts to a generative AI model, according to some implementations described herein. User interface 700 may be rendered on a display device of a computing device, such as user device 102, in some implementations. The display device may include any suitable display device, including, for example, a display screen, touch-sensitive display screen, portable device screen, and/or other suitable display device. Furthermore, input devices such as a touchscreen, electronic pens, mouses, trackpads, keyboards, etc. may be used by a user to provide input via user interface 700.

In some implementations, user interface 700 can include a display of a current time 702, a model ID 704, user input interface 706, input/typing interface 722, model selection interface 738, and controls 707 and 720 to submit or retry inputs.

Model ID 704 identifies an AI model selected to receive user input provided in user interface 700. Model ID 704 may include a service provider designation, a user designation (e.g., “software generative AI”, “natural language generative AI,” etc.) or another designation for a selected AI model. In some implementations, model selection interface 738 may be used to select a particular model from one or more models, where the selected model receives input provided in user input interface 706. In some implementations, multiple AI models can be selected and multiple model IDs 704 are displayed in user interface 700.

In some implementations, user interface 700 may display and/or enable user selection of other data (not shown). For example, user profile data can be displayed, which may include identifying information for a user, user profile and/or user account data and settings, and other settings that may be adjustable by a user, user preference selections for a user, selectable data sources or datasets for a user, available output formats or options for a user (e.g., output options such as type of output such as document, natural language output, computer code, etc.), etc.

User input interface 706 may allow a user to input text. In some instances, text may be typed (e.g., in input interface 722), copy-pasted, spoken, written with gestures, or others. Other variations may also be applicable. The text is provided to the selected model 704 as input.

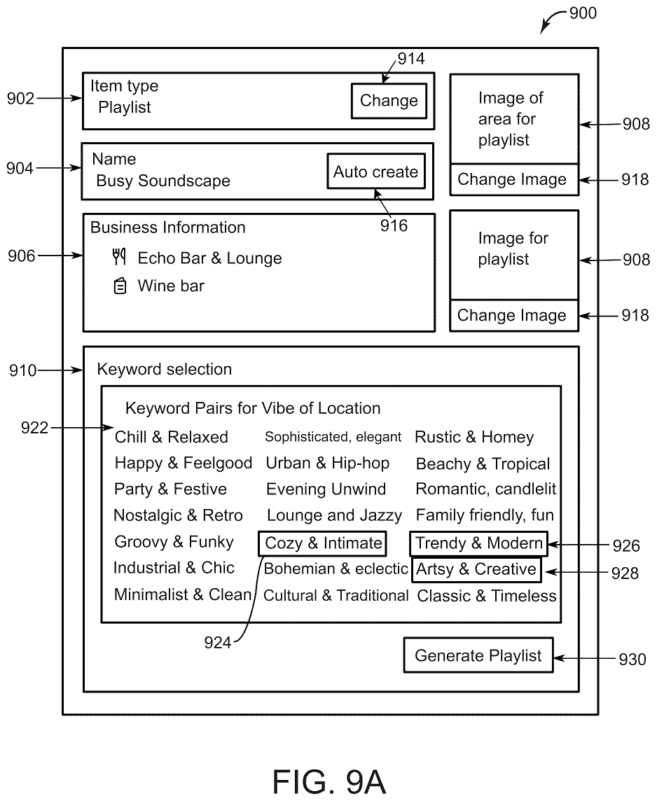

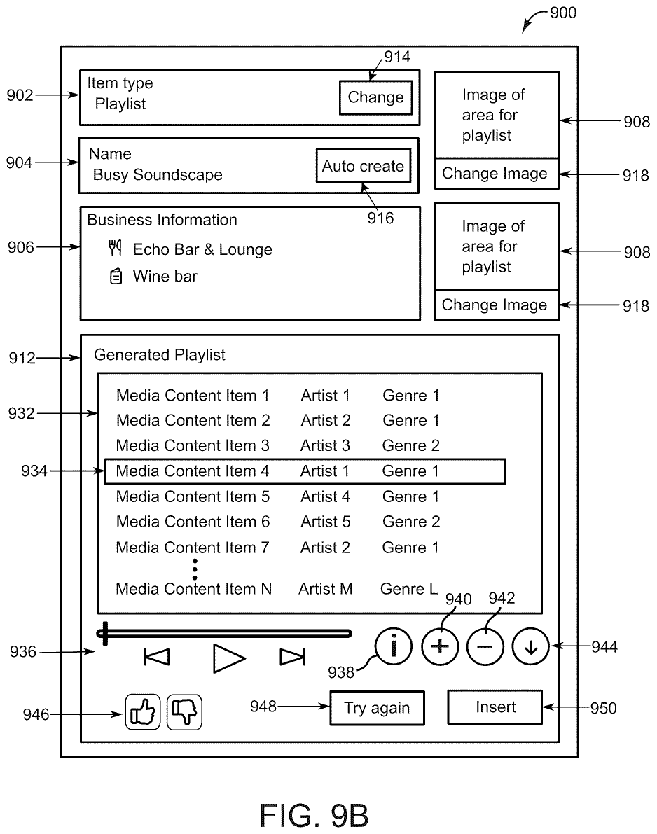

In some implementations, user interface 700 can enable a user to provide other input that is provided to the generative AI model. Some examples of selection of types of items and presented keywords is described below with reference to FIGS. 8A-9B.

User interface 700 also includes a visual media input control 724. A user may submit visual media data, such as images and/or videos, to the selected model 704 as input. For example, selection of control 724 allows the user to select one or more images or videos from a storage location, and those images or videos are submitted to model 704 as input. In some implementations described herein, visual media data can be selected and submitted via control 724 after an initial text response is received in output display 708, e.g., to refine the initial response. In some implementations, suggested visual media data can be displayed in user interface 700 (e.g. in a separate display section of interface 700, not shown) which has been selected or generated by the model 704 (or other model) based on previous input from the user in interface 706 and 724, and/or based on previous text or visual media output from the model, e.g., in display 708.

User interface 700 also includes a model output display 708 and output controls 710 and 718. For example, an output provided by a model identified at 704 (and/or selected at 738) may be displayed at 708. Furthermore, a user may share the output using element 710 and/or request to expand the output further with expand element 718.

In some implementations, the sharing element 710, when selected, causes a display of a new interface element that allows a user to transmit, send, or otherwise share a generative AI output with another person or persons.

It is noted that in some implementations, both retry element 720 and expand element 718 may operate somewhat similarly. In some implementations, retry element 720, when selected, directs a service provider network to reformat a prompt without providing additional user input. In this example, the service provider network may direct a software component (e.g., such as a paraphraser component) to reformat a prompt into a different format to elicit a different response from the generative AI model.

In some implementations, expand element 718, when selected, directs a service provider network to reformat a prompt with additional descriptive terms requesting a longer format or larger volume of output text. In this example, the service provider network may direct a software component (e.g., such as a paraphraser component) to reformat a prompt into a format to elicit a lengthier response from the generative AI model.

User interface 700 also includes a search function 712 and user profile access 716. Search function 712 may initiate a text-input-display such that a user can input text or other data to use in a search of available generative AI models and/or prior outputs or text prompts. User profile access 716 may initiate access to change user preferences, update account information, update profile information, and others. In some implementations, user profile access requires password protection and/or other secure techniques to secure user data.

User interface 700 also includes a device status 736 and a download function 734. Device status 736 may include information received from the user device, software components executing thereon, and/or hardware components associated therewith. In at least one implementation, device status 736 is controlled by an underlying operating system of the user device. In some cases, device status 736 may provide context data for prompt formatting as described in implementations above, such as location, time, other applications that are executing on the device, biometric information, and the like, should the user opt-in to providing such information. Download function 734 initiates a download of a current generative AI output to the user device, e.g., user device 102, for example. The downloaded data can be descriptions of one or more items, a playlist of media content items, the content data of the media content items), etc.

In some instances, other displays of data and/or elements may be appropriate. For example, different highlighting, gradients, shading, and other visual indicators may be displayed based upon a current model, input text, or otherwise. In these examples, the visual indicators may be based on context, runtime, output types, datasets, and other contextual data. For example, a prior response or output may be displayed differently or in a different color than a new output. Similarly, an output based on context that a user is contemporaneously in an office environment or receiving output for work product may be displayed differently than an output for personal use. In these and other examples, the format of display may be altered to make different UI elements more visible (e.g., highlighted portions of relevance or importance), with larger text and/or simplified elements (e.g., if a user is working in a restaurant or in a low-visibility area), with more selectable options (e.g., when a user requests are associated with work product, there may be more refined options for tailoring outputs), and others.

User interface 700 may be transmitted to a user device upon request, similar to the illustration of FIG. 1. Furthermore, use of user interface 700 may generally allow input of a plurality of user prompts or inputs (e.g., an item description, a list of components of an item, playlist context data, particular user preferences for relevancy, particular user preferences for profile data to use in formatting, and others.

It is noted that variations of the particular form and aesthetics of user interface 700 may be applicable, and all such variations are within the scope of this disclosure.

FIGS. 8A-8C are diagrams showing another example of a user interface 800 which can enable a user to specify and modify input and prompts to a generative AI model described herein, according to some implementations. User interface 800 may be rendered at a display device of a computing device associated with a user, a merchant, and/or a subscriber. In various implementations, one or more features of user interface 800 can be combined with features and elements of user interface 700.

In this example, user interface 800 can include a number of user interface elements 802, 804, 806, 808, and 810. A user may provide input to one or more of the user interface elements presented in the user interface to instruct input or output between the user device and a system providing generative AI models. In this example, user interface 800 is used to input and generate context data that is included in a prompt provided to a generative AI model to generate a description of an item (such as a menu item) similarly to at least some features described herein, e.g., in FIGS. 2-4. User interface 800 can also be used to input data to cause generation of descriptions such as playlists of media content items (examples described with respect to FIGS. 5 and 6) or generation of other output.

User interface 800 can include item type element 802 which displays a currently-selected type of item for which to generate a description. In some implementations, the user can select change control 814 to select any of multiple item types for which a description is to be generated. In some implementations, user selection of change control 814 causes a menu of different item types to be displayed that are available for selection. For example, “prepared food and beverage” item type is currently selected; other available item types can include “physical good,” “event,” “playlist,” etc. In some implementations, each of one or more of the item types can be associated with its own process of prompt generation to generate a prompt for the generative AI model(s) that is tailored for the selected item type. In some implementations, a user can input text to select an item type; e.g., input text can be recognized by user device 102 or service 104 and the available item type most closely matching the text is selected.

In some implementations, additional elements can be presented in user interface 800 that enable a user to further define the item and/or description that is requested. For example, a selection can be provided to indicate that the description is for a menu item in a food menu, a catalog item in a sales catalog, or other type of context. For example, the specification of a food menu item can represent a user request for a natural language text-based response that is in an appropriate length and quality to convey menu item descriptions to restaurant customers. In some implementations, a category of item (e.g., type of food, etc.) and/or an intended recipient or audience for the description (e.g., customer browsing a food item menu), etc. can be input as text or selected from a presented menu.

Name element 804 displays a currently-selected name of an item for which a description is requested. For example, a user can input text in name element 804 to specify the name, which can be recognized by the client device and/or service 104. In some implementations, the user can select auto create control 816 to cause the user device or service 104 to automatically create a name of an item. For example, if the user has input an image or video of the item via control 806, a text name for a primary object in the image or video can be determined and displayed in element 804.

Image element 806 displays visual media data such as an image or video that portrays the item (or portrays a scene associated with the item) for which a description is requested. The visual media data can be provided by the user, or can be retrieved by the client device or service 104 if requested by the user, e.g., based on input such as item type in element 802 and/or name in element 804. In some implementations, a user can select a change image control 818 to input or browse to select a particular visual media data item (e.g., image or video) to display in element 806.

Description element 808 displays a text description of the item specified in elements 802-806. Prior to the description being generated, as shown in FIG. 8A, a user can select a generate control 820, or input a different command, to initiate generation of the description. For example, selection of control 820 can cause another interface element 810 to be displayed.

Generate description element 810 can be displayed in response to a user selecting generate control 820, or can be generally displayed in user interface 800. In some implementations, element 810 includes a keywords element 822 and a format element 824.

Keywords element 822 can display keywords and/or receive input for keywords that are associated with the item identified in elements 802-806. For example, the keywords can be words that describe the item, components of the item, and/or characteristics of the item. In some implementations, one or more keywords can be generated by the generative AI model, e.g., based on the name and type of the item in elements 802 and 804. Such generated keywords can be an initial description of the item based on limited context data. The user is able to provide input in element 822 to add to, remove, or change any of the generated keywords.

In this example, the item is a Pad Thai food item, and keywords include components that are ingredients of the food item (e.g., “rice noodles,” “peanuts,” and “tamarind sauce”) and can include characteristics of the item (e.g., “spicy”). In this example, the first three keywords shown in FIG. 8A have been generated by a generative AI model as an initial description based on the name and type of item, and the user has added a fourth keyword (“spicy”) to provide additional context data.

Format element 824 can be displayed in element 810 to enable a user to select a format type for the description that is generated. In some implementations, the format types can include a component list to provide a description that includes a listing of the components of the item. As shown in FIG. 8A, the component list is shown as “ingredient list” as appropriate for the food item type.

A generate control 826 can be provided in generate description element 810. When selected, control 826 causes the generative AI model to generate a description based on the context data available, e.g., in elements 802-806, keywords displayed in keyword element 822, and the format selected in format element 824. Examples of generated descriptions are described below with reference to FIGS. 8A and 8B.

In some implementations, the item type element 802 of user interface 800 allows a more appropriate text description to be generated for an item by the generative AI model. For example, a “food and beverage” type of item can cause a prompt to be formatted that generates a description more in style and tone of a food menu, e.g., without as much persuasive language. A description for an item type of “physical good” can cause the description to include more persuasive or promotional language, as appropriate for such items.

FIG. 8B shows an example of generate description element 810 of user interface 800 of FIG. 8A after the user has selected the generate control 826 of element 810 (shown in FIG. 8A) to cause a generative AI model to generate a description for an identified item that has a format of a list of components.

As shown, a description 830 has been generated by the generative AI model and displayed in generate description element 810 of user interface 800. A list of several ingredients has been generated, in the list format selected in format element 824. The generated ingredient list is a more complete list of ingredients than the ingredients displayed as keywords in keyword element 822, because the AI model has used the context data to generate description 830, including the visual media data in element 826 and any added or modified keywords added to keyword element 822 by the user. The user is able to provide input in element 810 to add to, remove, or change any of the generated description 830.

In some implementations, element 810 can display response controls which can be selected by the user in response to the generation of the description 830. For example, feedback controls 832 enable a user to input direct user feedback, such as a selection indicating whether the generated description 830 is satisfactory or not (thumbs up or thumbs down); other feedback input controls can alternatively be provided in element 810 (e.g., comment field to receive user text comments, etc.). Retry control 834 enables the user to select to command the generative AI model to generate another description based on the context data in place of generated description 830. In some implementations, the generative AI model can generate a new description based on the previous description 830, e.g., with negative weights assigned thereto. Insert control 836, when selected by the user, causes the generated description 830 (or any new description generated in place of description 830) to be accepted by the user and, for example, inserted into a document or file as the description of the item. For example, for a merchant user who has requested a description for an item that is a menu item in a food menu, the description 830 can be inserted into a menu document or form for the identified food item. Selection of retry control 834 and/or insert control 836 can also be stored as (indirect) user feedback that indicates the satisfaction or dissatisfaction of the user with a generated description.

FIG. 8C shows an example of generate description element 810 of user interface 800 of FIG. 8A after the user has selected the generate control 826 of element 810 (shown in FIG. 8A) to cause a generative AI model to generate a description for an identified item with a format of descriptive sentences.

As shown, a description 840 has been generated by the generative AI model and displayed in generate description element 810 of user interface 800. A descriptive sentence has been generated, as per the format selected in format element 824. The selection of descriptive sentence as the format causes the prompt to the generative AI model to include an instruction to generate the description as a natural language sentence that includes the main ingredients and also includes verbs and adjectives. The user is able to provide input in element 810 to add to, remove, or change any of the generated description 840.

In some implementations, element 810 can display response controls which can be selected by the user in response to the generation of the description 840, similarly as described above in FIG. 8B but applied to generated description 840, such as feedback controls 832, repeat control 834, and insert control 836.

It is noted that variations of the particular form and aesthetics of the user interface 800 may be applicable, and all such variations are within the scope of this disclosure.

FIGS. 9A-9B are diagrams showing another example of a user interface 900 which can enable a user to specify and modify input and prompts to a generative AI model, according to some implementations. User interface 900 may be rendered at a display device of a computing device associated with a user, a merchant, and/or a subscriber. In various implementations, one or more features of user interface 900 can be combined with features and elements of user interface 700 and/or 800.

In this example, user interface 900 can include a number of user interface elements 902, 904, 906, 908, 910, and 912. A user may provide input to one or more of the user interface elements presented in the user interface to instruct input or output between the user device and a system providing generative AI models. In this example, user interface 900 is used to input and generate context data that is included in a prompt provided to a generative AI model to generate a playlist of content media items similar to at least some features described herein, e.g., FIGS. 5 and 6. User interface 900 can also be used to input data to cause generation of descriptions for items or generation of other output similarly as described above.

As shown in FIG. 9A, user interface 900 can include item type element 902 which displays a currently-selected type of item for which to generate a description. In some implementations, the user can select change control 914 to select any of multiple item types for which a description is to be generated similarly as described above for element 802. For example, “playlist” item type is currently selected. In some implementations, each of one or more of the item types can be associated with its own process of prompt generation to generate a prompt for the generative AI model(s) that is tailored for the selected item type. In some implementations, a user can input text to select an item type; e.g., input text can be recognized by user device 102 or service 104 and the available item type most closely matching the text is selected.

Name element 904 displays a currently-selected name of a playlist that is requested. For example, a user can input text in name element 904 to specify an identifier for the playlist. In some implementations, the user can select auto create control 916 to cause the user device or service 104 to automatically create a name of a playlist. For example, if the user has input an image or video of the item via control 906, a text name for a playlist appropriate for the image or video can be determined and displayed in element 904.

Business information 906 displays business information that is related to the requested playlist and/or the requesting user. For example, name and type of business are shown in FIG. 9A. Other information can also be displayed, such as geographic location, hours of operation, etc.

In some implementations, additional elements can be presented in user interface 900 that enable a user to specify context data to further define the requested playlist and/or physical area or environment in which the playlist is to be played. For example, in some implementations, the user input may specify a type of playlist to create. The type of playlist may include, for example, a restaurant playlist, a wine bar playlist, a dance playlist, a gym playlist, and others. For example, a gym playlist can represent a request for a listing of individual music tracks that are upbeat or described or tagged as being typical for workouts. In some examples, a genre or category of content (e.g., music, video, movie, etc.), a use of the playlist, and/or intended recipients or audience for the playlist (e.g., customer eating in a restaurant, people exercising in a gym, browsing customers in a retail space, passing pedestrians, etc.), etc. can be input as text or selected from a presented menu.

Image elements 908 each display visual media data such as an image or video that portrays a scene associated with the item for which a playlist is requested. For example, the visual media data can be an image of a physical area in which customers visit the user's business, such as an eating area in a restaurant, a retail space in a store, etc. The visual media data can be provided by the user, or can be retrieved by the client device or service 104 if requested by the user, e.g., based on input such as name in element 904 and/or business information 906. In some implementations, a user can select change image controls 918 to input or browse to select particular visual media data items (e.g., images or videos) to display in elements 908.

Keyword selection element 910 includes a keyword pairs element 922 that displays keywords and/or receives input for keywords that are associated with the requested playlist to be generated as identified in elements 902-906. For example, the keywords can be words that describe the playlist, characteristics of the playlist, the physical area in which the playlist is to be played, and/or the business which is to play the playlist. In this example, keyword pairs are generated to more fully describe the playlist, physical area, and/or business than single keywords. In this example, the playlist is to be played in a particular restaurant scene depicted in an image in element 908, and keyword pairs have been generated that are based on the scene in the image. In this example, the keyword pairs indicate a particular mood or “vibe” for the depicted physical area.

In some implementations, a standard list of keyword pair candidates is presented in element 922 as shown. In some implementations, one or more of the presented keyword candidates can be generated by the generative AI model, e.g., based on the data in elements 902-908. In some implementations, the generative AI model can select one or more of the presented keyword candidates based on the context data in elements 902-908. For example, the visual media data indicated in elements 908 can be used to generate keywords associated with the scenes depicted in this data by a generative AI model that is trained on both images and text. In this example, the model has selected candidates 924, 926, and 928 based on the context data.

The user can provide input to deselect one or more of these selected candidates and/or select other or additional candidates to specify mood (e.g., emotion, atmosphere), tone, theme, and/or vibe that are to be associated with the media content items requested for the playlist. In some implementations, the user is able to provide input in element 922 to add to, remove, or change any of the generated keywords.

A generate playlist control 930 can be provided user interface 900. When selected, control 930 causes the generative AI model to generate a playlist based on the context data available, e.g., in elements 902-908 and selected keywords in keyword element 922. Some examples of a generated playlist are described below with reference to FIG. 9B. In some implementations, the user can input a different command to initiate generation of the playlist.

In some implementations, additional controls can be provided in user interface 900 to allow the user to specify or indicate additional context data for the requested playlist. For example, in some implementations, a displayed element (e.g., similar to any of the elements 902-910, e.g., in place of element 910) can present a list of images instead of or in addition to the keywords described above to specify context data for the playlist, where the images convey different moods, styles, tones, etc. In some examples, the displayed element enables a user to create a spatial composition (e.g., “mood board”) or other composition as context data used in forming a prompt to the generative AI model. In some examples, the composition can be a displayed area or window that allows a user to arrange a variety of text and images in particular patterns or spatial arrangements. In some examples, the user can be presented with a list of images from which the user can select one or more particular images for the composition that describe a mood or style that is to be conveyed with playback of content items in the requested playlist.

FIG. 9B shows an example of a generated playlist displayed in user interface 900 of FIG. 9A, after the user has selected the generate playlist control 930 (shown in FIG. 9A) to cause a generative AI model to generate a playlist. The AI model has used the context data to generate a playlist, including the visual media data in elements 908 and selected keywords in keyword selection element 910.

For example, the generated playlist can be displayed in place of the keyword selection element 910 of FIG. 9A (as shown in FIG. 9B for simplicity), or can be displayed in addition to the keyword selection element 910 to allow the user to change keyword input in element 910 and command generation of additional playlists based on those changes.

As shown, a generated playlist element 912 is displayed in user interface 900 in which generated playlists are shown. In some implementations, a generated playlist can be presented as a text description such as a list of text names of media content items included in the playlist in a particular order. In the example of FIG. 9B, playlist 932 has been generated by the generative AI model and displayed in playlist element 912 of user interface 900.

Playlist 932 includes an ordered list of identifiers of recommended media content items, e.g., titles or other identifiers of music tracks, images, videos, etc., up to N total media content items. In this example, additional information is also displayed, such as artists (or producers) who created the media content items, and categories or genres of the media content items.

In some implementations, a user can select any one (or multiple) of the media content item identifiers displayed in playlist 932 to manipulate the selected media content item(s). For example, media content item 934 is selected in FIG. 9B. The user can move selected media content item 934 to a different position in the order of media content items, e.g., by dragging the content item. Playback controls 936 can be selected by the user to play the selected media content item 934 (e.g., download content data of media content items to a user device, output audio content on speakers, cause a separate window to be displayed that plays video content of the selected content item, etc.), to skip to a different media content item in the playlist, etc. as with standard playback controls. An information control 938 or other controls can be selected by the user to cause additional information about the selected media content item to be displayed, e.g., to display artist information, album information, other playlists in which the selected media content item is included, etc. Add control 940 can be selected to add additional media content items to the playlist, e.g., above or below the selected media content item 934. Delete control 942 can be selected to delete the selected media content item from the playlist. A download control 944 can enable a user to download the content data of the selected media content item (or of the entire playlist) to a storage device accessible to the user, e.g., on a local device such as user device 102 or other device. Other controls can also be provided in user interface 900 (not shown), such as a share control to share selected media content items or the playlist to other users of the service 104, a favorites control to designate the playlist or particular media content item(s) as favorites of the user (e.g., add the selected items to a favorites list), an account access control to initiate access to an account of the user on the service 104 to, e.g., change user preferences, update account information, etc. (which may require password protection and/or other secure techniques to secure user data), etc.

In some implementations, playlist element 912 can display additional controls which can be selected by the user in response to the generation of the playlist 932. For example, feedback controls 946 enable a user to input direct user feedback, such as a selection indicating whether the playlist 932 is satisfactory or not (thumbs up or thumbs down); other feedback input controls can alternatively be provided in element 912 (e.g., comment field to receive user text comments, etc.). Retry control 948 enables the user to select to command the generative AI model to generate another playlist based on the context data, e.g., in place of generated playlist 932 or as another playlist. In some implementations, the generative AI model can generate a new playlist including context data that is playlist 932, e.g., with negative weights assigned to content items and/or ordering of items in playlist 932. Insert control 950, when selected by the user, causes the generated description of playlist 932 (or any new description generated in place of playlist 932) to be accepted by the user and, for example, inserted into a schedule for playback. For example, for a merchant user who has requested the playlist for a physical area of a business, the playlist 932 can be inserted into a schedule for playback at one or more times of day at the physical area, such that the media content data corresponding to the media content items is retrieved and output by output devices (e.g., speakers, display screens, etc.) at the physical area.

Selection of retry control 948 and/or insert control 950, as well user selection of other controls to add or delete media content items to the playlist 932, rearrange the order of content items in the playlist 932, add media content items to a favorites list, etc., can also be stored as (indirect) user feedback that indicates the satisfaction or dissatisfaction of the user with a generated playlist.

It is noted that variations of the particular form and aesthetics of the user interface 900 may be applicable, and all such variations are within the scope of this disclosure.

Various features can be provided in described user interfaces, such as user interfaces 120, 700, 800, and 900, to enable seller users to create and edit menus of items they are selling and/or as playlists of media content items. For example, seller users can manage various distributed menus across service 104 and other services in one place with features such as inheritance and pricing customization. For example, with inheritance enabled, settings at a parent menu or menu group level automatically apply to child menus and elements of that parent. Inheritance can be bypassed when needed.

In some implementations, menus and other operations for various item types can be managed within one user interface. For example, item types handled within one interface can include prepared food and beverages, physical goods (items like clothing, jewelry), events (sell tickets to events), digital files for download by customers, donations, service (bookable services like massage, hair styling), media content playlists, etc.

User interface functionality can include displaying item variations within a single menus, where different items and/or types of items have different options for specifying the generation of descriptions, input context data, etc. The unified user interface can allow sellers to customize (e.g., expose or hide) critical item fields in the user interface to provide menu variations.

Time-based menus can be provided, including time-based menu options and time-based pricing for items, where particular menu options and/or pricing for items can be designated to available and/or visible at particular specified time ranges. Sellers can create and store menu drafts in service 104 and can schedule menu changes in advance to automatically occur at specified times. Menu availability can be connected and/or synchronized with menu availability of other services or parties.

Standard user interface controls can be provided across various channels, location groups, and locations offered in a service (such as service 104). Pricing designations and strategies can be provided at item level or at higher levels (e.g., groups of items, categories of items, etc.).

Menu editing or playlist editing can be provided in POS devices, which enables sellers to edit their menu or playlist directly within the POS device, e.g., without needing to navigate to a web view, thus reducing the number of clicks and latency while improving the overall experience.

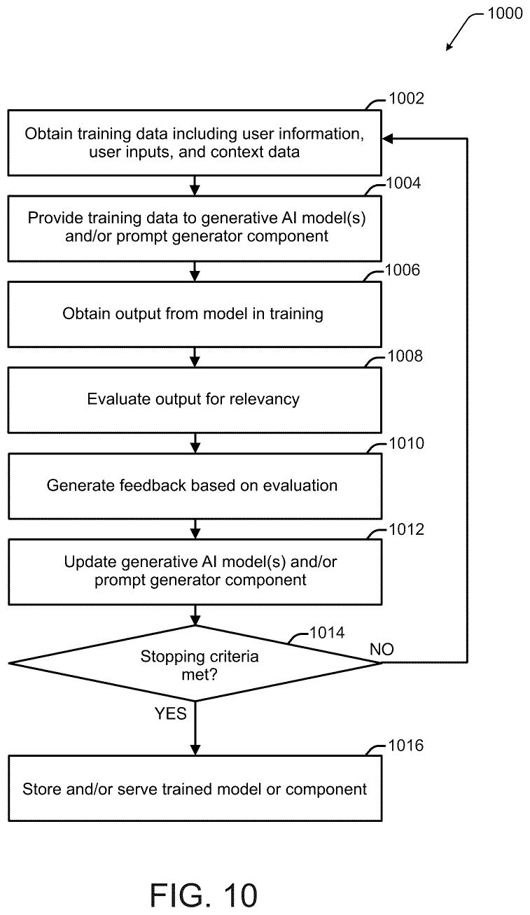

FIG. 10 is a flow diagram illustrating aspects of a method 1000 for training a prompt generator component and/or a generative AI model, according to some implementations presented herein. Method 1000 can be performed (or repeated) in a different order than described herein and/or one or more blocks can be omitted and/or one or more additional functions may be added without departing from the scope of this disclosure. Additionally, portions of method 1000 may be rearranged and/or combined with other methods without departing from the scope of this disclosure. Furthermore, portions of method 1000 may be combined and performed in sequence or in parallel, according to specific implementations, and without departing from the scope of this disclosure.

In some implementations, one or more deployed generative AI models are a pre-configured large language model that do not require training. In some implementations, one or more deployed generative AI models are pre-trained and/or preconfigured generative AI models that do not require training.

Method 1000 may begin at block 1002. In block 1002, training data comprising a plurality of records is obtained. In some implementations, records in the training data include user information (e.g., profile data), user inputs, and context data. For example, the training user inputs can include user selections of keywords, user feedback data, and other user input. For example, the training context data can include business information (e.g., geographical location, physical areas, etc.), user-provided names, previously generated descriptions (e.g., menu descriptions and/or playlists), etc. For image-trained generated AI models used as described herein, the training user inputs and/or context data can include visual content data such as images and videos, e.g., user-submitted visual content data, previously generated images associated with previous user requests for descriptions and playlists, etc. Block 1002 may be followed by block 1004.

In block 1004, the training data is provided to the prompt generator component and/or the generative AI model. Block 1004 may be followed by block 1006.

In block 1006, an output is obtained from the model or component in training. For example, when training a prompt generator component, the output may be a formatted prompt. For example, when training or configuring a generative AI model, the output may be a natural language response, playlist, image(s), or other response, based on the training data provided. Block 1006 may be followed by block 1008.

In block 1008, the output is evaluated for relevancy to the provided training records. Block 1008 may be followed by block 1010.

In block 1010, feedback is generated for the model or component in training based on the output generated at block 1006 and the evaluation at block 1008. In some implementations, feedback may be generated based on the user input in individual records in the training data and corresponding output. For example, the feedback may be obtained from a feedback generator based on the user input and the output in the record.

In some implementations, the feedback generator may include a hard-coded loss function.

Block 1010 may be followed by block 1012. In block 1012, the model or component under training may be updated based on the generated feedback. For example, one or more parameters, weights, values, and/or architecture details may be updated based on the generated feedback. Block 1012 may be followed by block 1014.

In block 1014, it is determined if a stopping criterion for model or component training has been met. For example, if a threshold number of records have been evaluated from the training dataset (e.g., 100 records, 1,000 records, 10,000 records, etc.), it may be determined that the stopping criterion has been met. In another example, an evaluation of the model output (the generated output and training input) may be performed and if the model has reached a threshold level of accuracy, it may be determined that the stopping criterion has been met. In some implementations, combinations of different stopping criteria may be used.

If the stopping criterion has been met, block 1014 is followed by block 1016. Else, block 1016 is followed by block 1002, where additional training data is obtained.

In block 1016, the trained model or component is stored and/or deployed at a service provider network, e.g., network 104.

While the above-described examples and implementations are described with reference to a general example of a user requesting a generative AI output in a plurality of different forms, the same may be varied to include different generative options based on a plurality of different example use cases. Hereinafter, a plurality of different methods of improving output relevancy of a generative AI model are presented in the context of different real-world example implementations. It is noted that such example implementations are illustrative, and are not limiting of every implementation nor are they preferred implementations or use-cases.

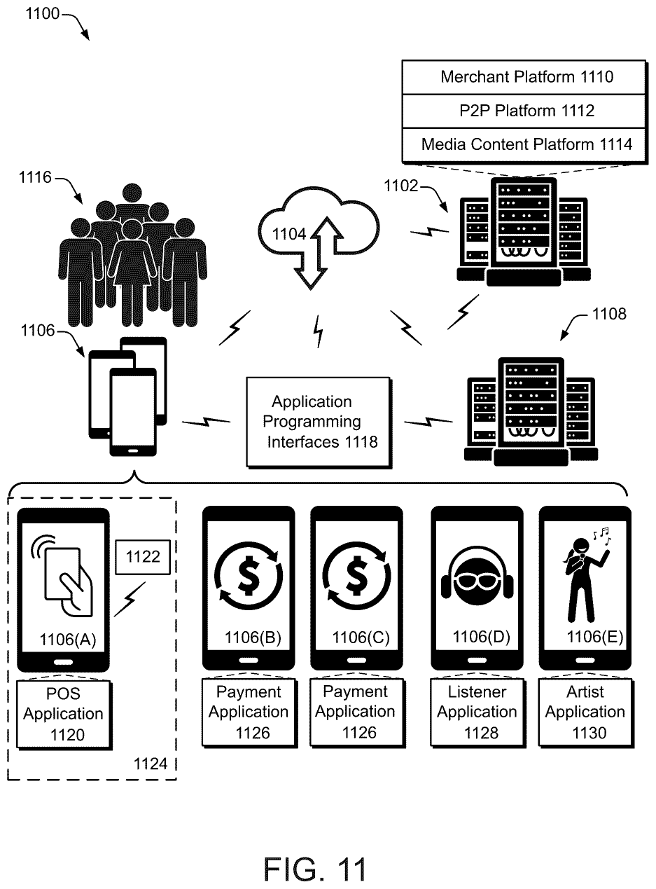

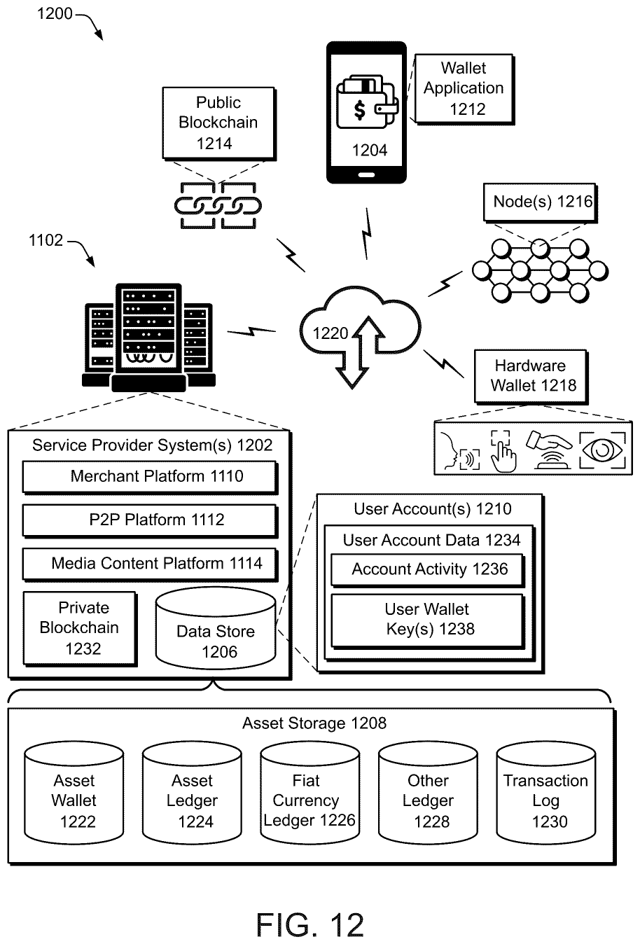

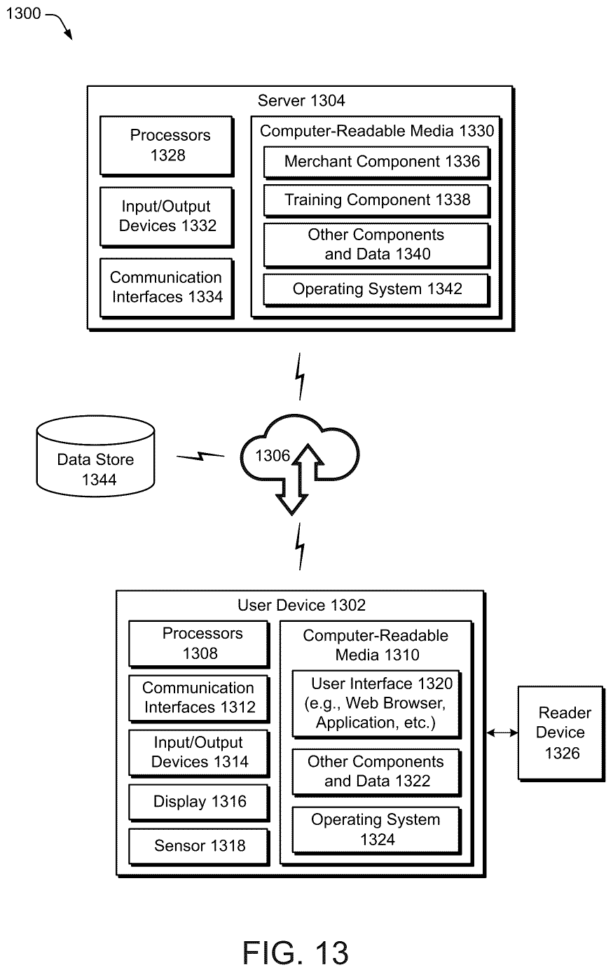

Hereinafter, different example environments that may be suitable for one or more implementations described herein, are presented with reference to FIG. 11, FIG. 12, and FIG. 13.

FIG. 11 illustrates an example environment 1100. The environment 1100 includes server(s) 1102 that can communicate over a network 1104 with end user devices 1106 and/or server(s) 1108 associated with third-party service provider(s). In various examples, the end user devices 1106 may comprise one or more seller devices 1106(A), one or more user devices 1106(B) and/or 1106(C) in a peer network, one or more content consumption devices 1106(D), one or more artist devices 1106(E), combinations of these examples, or other categories of user devices. The server(s) 1102 can be associated with one or more service providers that can provide one or more services for the benefit of users 1116, as described below. For example, the server(s) 1102 may enable services of service providers such as in association with a seller platform 1110 (which may further include a buyer or customer platform), a peer-to-peer (P2P) payment platform 1112, a media content platform 1114, a combination of these platforms, or other platforms associated with other service providers. While services and features are referenced throughout in connection with a particular one of the seller platform 1110, the P2P payment platform 1112, or the media content platform 1114, it should be understood that any of these platforms may perform the functionality described in relation to any of the other platforms. Actions attributed to the service provider(s) can be performed by the server(s) 1102.

For example, in some implementations, a user interface such as interface 120 may be deployed at end user devices 1106. In this manner, listeners, users, artists, content creators, and others may leverage the techniques described herein to receive relevant outputs from generative AI models.

In some examples, individual ones of the end user devices 1106 can be operable by users 1116. The users 1116 (individually referred to herein as “user 1116”) can be referred to as customers, buyers, merchants, sellers, borrowers, employees, employers, payors, payees, couriers, artists, musicians, listeners, fans, supervisors, hosts, audience members, and so on. The users 1116 can interact with the end user devices 1106 via user interfaces presented via the end user devices 1106. In at least one example, a user interface can be presented via a web browser, or the like. Alternatively or additionally, a user interface can be presented via an application, such as a mobile application or desktop application, which can be provided by the seller platform 1110, the P2P payment platform 1112, and/or the media content platform 1114, or which can be an otherwise dedicated application. In some examples, individual end user devices 1106 can have an instance or versioned instance of an application, which can be downloaded from an application store, for example, which can present the user interface(s) described herein.

In at least one example, the users 1116 can include merchants that can operate the seller device(s) 1106(A) that are configured for use by merchants. For the purpose of this discussion, a “merchant” can be any entity that offers items (e.g., goods or services) for purchase or other means of acquisition (e.g., rent, borrow, barter, etc.). The merchants can offer items for purchase or other means of acquisition via brick-and-mortar stores, mobile stores (e.g., pop-up shops, food trucks, etc.), online stores, event venues, combinations of the foregoing, and so forth. In some examples, at least some of the merchants can be associated with the same entity but can have different merchant locations and/or can have franchise/franchisee relationships.

In additional or alternative examples, the merchants can be different merchants. For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

The seller device 1106(A) can have an instance of a point of sale (“POS”) application 1118 stored thereon. The POS application 1118 can configure the seller device 1106(A) as a POS terminal, which enables the merchant to interact with one or more customers. In at least one example, interactions between the customers and the merchants that involve the exchange of funds (from the customers) for items or services (from the merchants) can be referred to as “transactions.” In at least one example, the POS application 1118 can determine transaction data associated with the POS transactions. Transaction data can include payment information, which can be obtained from a reader device 1120 associated with the seller device 1106(A), user authentication data, purchase amount information, point-of-purchase information (e.g., item(s) purchased, date of purchase, time of purchase, subscription type, etc.), etc. The POS application 1118 can send transaction data to the server(s) 1102 such that the server(s) 1102 can track transactions of the customers, merchants, and/or the users 1116 over time. Furthermore, the POS application 1118 can present a UI to enable the merchant to interact with the POS application 1118 and/or the seller platform 1110 via the POS application 1118.

In at least one example, the seller device 1106(A) can be a special-purpose computing device configured as a POS terminal (via the execution of the POS application 1118). In at least one example, the POS terminal may be connected to a reader device 1120, which is capable of accepting a variety of payment instruments, such as credit cards, debit cards, gift cards, short-range communication based payment instruments, and the like, as described below. In at least one example, the reader device 1120 can plug in to a port in the seller device 1106(A), such as a microphone port, a headphone port, an audio-jack, a data port, or other suitable port. In additional or alternative examples, the reader device 1120 can be coupled to the seller device 1106(A) via another wired or wireless connection, such as via Bluetooth®, BLE, and so on. In some examples, the reader device 1120 can be a software solution executing on the POS terminal, e.g., a mobile phone. In some examples, the reader device 1120 can read information from alternative payment instruments including, but not limited to, wristbands and the like.

In some examples, the reader device 1120 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards, hardware wallets, fobs, or devices configured for tapping). The POS terminal may provide a rich user interface, communicate with the reader device 1120, and communicate with the seller platform 1110, which can provide, among other services, a payment processing service. The server(s) 1102 associated with the seller platform 1110 can communicate with server(s) 1108, as described below. In this manner, the POS terminal and reader device 1120 may collectively process transaction(s) between the merchants and customers. In some examples, multiple POS terminal(s) may be connected to a number of other devices, such as “secondary” terminals, e.g., back-of-the-house systems, printers, line-buster devices, reader devices, speakers, and the like, to allow for information from the secondary terminal to be shared between the primary POS terminal(s) and secondary terminal(s), for example via short-range communication technology. This kind of arrangement may continue operation in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 1120 of the POS system 1122 are shown as separate devices, in additional or alternative examples, the POS terminal and the reader device 1120 can be part of a single device. In some examples, the reader device 1120 can have a display integrated therein for presenting information to customers of a merchant. In additional or alternative examples, the POS terminal can have a display integrated therein for presenting information to the customers of the merchant. POS systems, such as the POS system 1122, may be mobile, such that POS terminals and reader devices may process transactions in disparate locations across the world. POS systems can be used for processing card-present transactions and card-not-present (CNP) transactions.

A card-present transaction is a transaction where both a customer and the customer's payment instrument are physically present at the time of the transaction. Card-present transactions may be contact or contactless transactions processed by swipes (e.g., by sliding a magnetic strip through a reader device), dips (e.g., by inserting an embedded microchip into a reader device), taps (e.g., by wirelessly, through Bluetooth, NFC or other short range technology hover or tap a payment instrument into a reader device), or any other interaction between a physical payment instrument (e.g., a card), or otherwise present payment instrument, and a reader device 1120, whereby the reader device 1120 is able to obtain payment data from the payment instrument.

A CNP transaction is a transaction where a card, or other payment instrument, is not physically present at the POS such that payment data is manually keyed in (e.g., by a merchant, customer, etc.), or payment data is required to be recalled from a card-on-file data store, to complete the transaction.

The POS system 1122, the server(s) 1102, and/or the server(s) 1108 may exchange payment information and transaction data to determine whether transactions are authorized. For example, the POS system 1122 may provide encrypted payment data, user authentication data, purchase amount information, point-of-purchase information, etc. (collectively, transaction data) to server(s) 1102 over the network(s) 1104. The server(s) 1102 may send the transaction data to the server(s) 1108.

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. In at least one example, the service provider can serve as an acquirer and connect directly with the card payment network.

The card payment network (e.g., the server(s) 1108 associated therewith) can forward the fund transfer request to an issuing bank (e.g., “issuer”). The issuer is a bank or financial institution that offers a financial account (e.g., credit or debit card account) to a user. The issuer (e.g., the server(s) 1108 associated therewith) can make a determination as to whether the customer has the capacity to absorb the relevant charge associated with the payment transaction. In at least one example, the seller platform 1110 can serve as an issuer and/or can partner with an issuer. The transaction is either approved or rejected by the issuer and/or the card payment network (e.g., the server(s) 1108 associated therewith), and a payment authorization message is communicated from the issuer to the POS device via a path opposite of that described above, or via an alternate path.

The server(s) 1108 may send an authorization notification over the network(s) 1104 to the server(s) 1102, which may send the authorization notification to the POS system 1122 over the network(s) 1104 to indicate whether the transaction is authorized. The server(s) 1102 may also transmit additional information such as transaction identifiers to the POS system 1122. In one example, the server(s) 1102 may include a merchant application and/or other functional components for communicating with the POS system 1122 and/or the server(s) 1108 to authorize or decline transactions (e.g., the API 1130). In examples, the seller platform 1110 can enable the merchants to receive cash payments, payment card payments, and/or electronic payments from customers for POS transactions and the service provider can process transactions on behalf of the merchants.

Based on the authentication notification that is received by the POS system 1122 from server(s) 1102, the merchant may indicate to the customer whether the transaction has been approved. In some examples, approval may be indicated at the POS system 1122, for example, at a display of the POS system 1122. In some cases, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

The seller platform 1110 can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, media content (e.g., music, videos, etc.) management and/or subscription services, and so on. In some examples, the users 1106 can access all of the services. In some cases, the users 1106 can have gradated access to the services, which can be based on risk tolerance, IDV outputs, subscriptions, and so on. In at least one example, access to such services can be availed to the merchants via the POS application 1118. In additional or alternative examples, each service can be associated with its own access point (e.g., application, web browser, etc.).

As the seller platform 1110 processes transactions on behalf of the merchants, the seller platform 1110 can maintain accounts or balances for the merchants in one or more ledgers. For example, the seller platform 1110 can analyze transaction data received for a transaction to determine an amount of funds owed to a merchant for the transaction and deposit funds into an account of the merchant. The account can have a stored balance, which can be managed by the merchant seller 1110. The account can be different from a conventional bank account at least because the stored balance is managed by a ledger of the seller platform 1110 and the associated funds are accessible via various withdrawal channels including, but not limited to, scheduled deposit, same-day deposit, instant deposit, and a linked payment instrument.

A scheduled deposit can occur when the seller platform 1110 transfers funds associated with a stored balance of the merchant to a bank account of the merchant that is held at a bank or other financial institution (e.g., associated with the server(s) 1108). Scheduled deposits can occur at a prearranged time after a POS transaction is funded, which can be a business day after the POS transaction occurred, or sooner or later. In some examples, the merchant can access funds prior to a scheduled deposit (e.g., same-day deposits and/or real-time deposits). Further, in at least one example, the merchant can have a payment instrument that is linked to the stored balance that enables the merchant to access the funds without first transferring the funds from the account managed by the seller platform 1110 to the bank account of the merchant.

In at least one example, the seller platform 1110 may provide inventory management services. That is, the seller platform 1110 may provide inventory tracking and reporting. Inventory management services may enable the merchant to access and manage a database storing data associated with a quantity of each item that the merchant has available (i.e., an inventory). Furthermore, in at least one example, the seller platform 1110 can provide catalog management services to enable the merchant to maintain a catalog, which can be a database storing data associated with items that the merchant has available for acquisition (i.e., catalog management services). The seller platform 1110 can offer recommendations related to pricing of the items, placement of items on the catalog, and multi-party fulfillment of the inventory, to name a few examples.

In at least one example, the seller platform 1110 can provide business banking services, which allow the merchant to track deposits (from payment processing and/or other sources of funds) into an account of the merchant, payroll payments from the account (e.g., payments to employees of the merchant), payments to other merchants (e.g., business-to-business) directly from the account or from a linked debit card, withdrawals made via scheduled deposit and/or real-time deposit, configure allocations among multiple balances or accounts (e.g., spending, saving, taxes, etc.), etc. Furthermore, the business banking services can enable the merchant to obtain a customized payment instrument (e.g., credit card), check how much money the merchant is earning (e.g., via presentation of available earned balance), understand where the money of the merchant is going (e.g., via deposit reports (which can include a breakdown of fees), spend reports, etc.), access/use earned money (e.g., via scheduled deposit, real-time deposit, linked payment instrument, etc.), have improved control of the money of the merchant (e.g., via management of deposit schedule, deposit speed, linked instruments, etc.), etc. Moreover, the business banking services can enable the merchants to visualize their cash flow to track their financial health, set aside money for upcoming obligations (e.g., savings), organize money around goals, etc.

In at least one example, the seller platform 1110 can provide financing services and products, such as via business loans, consumer loans, fixed term loans, flexible term loans, and the like. In at least one example, the service provider can utilize one or more risk signals to determine whether to extend financing offers and/or terms associated with such financing offers. Such risk signals can be particular to an individual platform or service, as described herein, or can be based on aggregated data associated with multiple of the platforms or services. In at least one example, the seller platform 1110 can provide financing services for offering and/or lending a loan to a borrower that is to be used for, in some instances, financing the borrower's short-term operational needs (e.g., a capital loan). Additionally or alternatively, the seller platform 1110 can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant. The seller platform 1110 can generate the loan based at least in part on determining that the borrower purchased or intends to purchase the item from the merchant. Advances, loans, or other funds provided to a merchant or other user can be repaid via a variety of mechanisms. In some examples, loans can be repaid in installments (e.g., multiple payments over time), at a particular date, from a portion of incoming funds (e.g., payments processed for the merchant, tax refunds, direct deposits, etc.), or the like.

The seller platform 1110 can provide web-development services, which enable users 1116 who are unfamiliar with HTML, XML, Javascript, CSS, or other web design tools to create and maintain functional websites. Further, in addition to websites, the web-development services can create and maintain other online omni-channel presences, such as social media posts for example. In some examples, the resulting web page(s) and/or other content items can be used for offering item(s) for sale via an online/e-commerce platform. In at least one example, the seller platform 1110 can recommend and/or generate content items to supplement omni-channel presences of the merchants.

Furthermore, the seller platform 1110 can provide payroll services to enable employers to pay employees for work performed on behalf of employers. In at least one example, the seller platform 1110 can receive data that includes time worked by an employee (e.g., through imported timecards and/or POS interactions), sales made by the employee, gratuities received by the employee, and so forth. Based on such data, the seller platform 1110 can make payroll payments to employee(s) on behalf of an employer via the payroll service. For instance, the seller platform 1110 can facilitate the transfer of a total amount to be paid out for the payroll of an employee from the bank of the employer to the bank of the seller platform 1110 to be used to make payroll payments. In at least one example, when the funds have been received at the bank of the seller platform 1110, the seller platform 1110 can pay the employee, such as by check or direct deposit.

Moreover, in at least one example, the seller platform 1110 can provide employee management services for managing schedules of employees. Further, the seller platform 1110 can provide appointment services for enabling users 1116 to set schedules for scheduling appointments and/or users 1116 to schedule appointments.

In some examples, the seller platform 1110 can provide restaurant management services to enable users 1116 to make and/or manage reservations, to monitor front-of-house and/or back-of-house operations, and so on. In such examples, the seller device(s) 1106(A) and/or server(s) 1102 can be configured to communicate with one or more other computing devices, which can be located in the front-of-house (e.g., POS device(s)) and/or back-of-house (e.g., kitchen display system(s) (KDS)). In at least one example, the seller platform 1110 can provide order management services and/or fulfillment services to enable restaurants (or other merchant types) to manage open tickets, split tickets, and so on and/or manage fulfillment services.

In some examples, the seller platform 1110 can provide omni-channel fulfillment services. A fulfillment service includes item ordering and delivery services, such as via a courier. In some examples, the courier can be an unmanned aerial vehicle (e.g., a drone), an autonomous vehicle, or any other type of vehicle capable of receiving instructions for traveling between locations. For instance, if a customer places an order with a merchant and the merchant cannot fulfill the order because one or more items are out of stock or otherwise unavailable, the seller platform 1110 can leverage other merchants and/or sales channels that are part of the seller platform 1110 to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the seller platform 1110 can enable conversational commerce via conversational commerce services, which can use one or more machine learning mechanisms to analyze messages exchanged between two or more users 1116, voice inputs into a virtual assistant or the like, to determine intents of user(s) 1116. In some examples, the seller platform 1110 can utilize determined intents to automate customer service, offer promotions, provide recommendations, or otherwise interact with customers in real-time. In at least one example, the seller platform 1110 can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 1116 may be new to the seller platform 1110 such that the user 1116 that has not registered (e.g., subscribed to receive access to one or more services offered by the seller platform 1110) with the seller platform 1110. The seller platform 1110 can offer onboarding services for registering a potential user 1116 with the seller platform 1110. In some examples, onboarding can involve presenting various questions, prompts, and the like to a potential user 1116 to obtain information that can be used to generate a profile for the potential user 1116. In at least one example, the seller platform 1110 can provide limited or short-term access to its services prior to, or during, onboarding (e.g., a user of a peer-to-peer payment service can transfer and/or receive funds prior to being fully onboarded, a merchant can process payments prior to being fully onboarded, a user of a music streaming service can listen to music having advertisement breaks prior to being fully onboarded, etc.). In response to full or partial completion of onboarding, any limited or short-term access to services of the seller platform 1110 can be transitioned to more permissive (e.g., less limited) or longer-term access to such services.

The seller platform 1110 can be associated with IDV services, which can be used by the seller platform 1110 for compliance purposes and/or can be offered as a service, for instance to third-party service providers (e.g., associated with the server(s) 1108). That is, the seller platform 1110 can offer IDV services to verify the identity of users 1116 seeking to use or using their services. Identity verification may involve requesting a customer (or potential customer) to provide information that is used by compliance departments to prove that the information is associated with an identity of a real person or entity (e.g., an artist). In at least one example, the seller platform 1110 can perform services for determining whether identifying information provided by a user 1116 accurately identifies the customer (or potential customer).

Techniques described herein can be configured to operate in both real-time/online and offline modes. “Online” modes refer to modes when devices are capable of communicating with the seller platform 1110 while offline mode refers to modes when devices are unable to communicate with the server(s) 1108 due to network connectivity issue, for example. In such examples, devices may operate in “offline” mode where at least some payment data is stored (e.g., on the seller device(s) 1106(A)) and/or the server(s) 1102 until connectivity is restored and the payment data can be transmitted to the server(s) 1102 and/or the server(s) 1108 for processing.

In at least one example, the seller platform 1110 can be associated with a hub, such as an order hub, an inventory hub, a fulfillment hub and so on, which can enable integration with one or more additional service providers (e.g., associated with the additional server(s) 1108). In some examples, such additional service providers can offer additional or alternative services and the service provider can provide an interface or other computer-readable instructions to integrate functionality of the service provider into the one or more additional service providers.

Turning now to the P2P functionality provided by the environment 1100, the P2P platform 1112 can provide a peer-to-peer payment service that enables peer-to-peer payments between two or more of the users 1116. Two or more of the users 1116 may be considered “peers” in a peer-to-peer interaction, such as a payment. In at least one example, the P2P platform 1112 can communicate with instances of a payment application 1124 (or other access point) installed on end user devices 1106 configured for operation by the users 1116. In an example, an instance of the payment application 1124 executing on a first user device 1106(B) operated by a payor (e.g., one of the users 1116) can send a request to the P2P platform 1112 to transfer an asset (e.g., fiat currency, non-fiat currency, digital assets such as non-fungible tokens (NFTs), cryptocurrency, securities, gift cards, and/or related assets) from the payor to a payee (e.g., a different one of the users 1116) via a peer-to-peer payment. In some examples, assets associated with an account of the payor are transferred to an account of the payee. In some examples, assets can be held at least temporarily in an account of the P2P platform 1112 prior to transferring the assets to the account of the payee.

In some examples, the P2P platform 1112 can utilize a ledger system to track transfers of assets between users 1116. FIG. 12, below, provides additional details associated with such a ledger system. The ledger system can enable users 1116 to own fractional shares of assets that are not conventionally available. For instance, a user can own a fraction of a Bitcoin, an NFT, or a stock. Additional details are described herein.

In at least one example, the P2P platform 1112 can facilitate transfers and can send notifications related thereto to instances of the payment application 1124 executing on user device(s) of payee(s). As an example, the P2P platform 1112 can transfer assets from an account of a first user to an account of a second user and can send a notification to the user device 1106(B) of the second user for presentation via a user interface. The notification can indicate that a transfer is in process, a transfer is complete, or the like. In some examples, the P2P platform 1112 can send additional or alternative information to the instances of the payment application 1124 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the P2P platform 1112 funds the request to payee on behalf of the payor, to speed up the transfer process and compensate for lags that may be attributed to the payor's financial network.

In some examples, the P2P platform 1112 can trigger the peer-to-peer payment process through identification of a “payment proxy” having a particular syntax. The payment proxy is useable in lieu of payment data. That is, payment data and a payment proxy can be linked to, or otherwise associated with, a user account of a user and either can be used for making payments. In an example, the syntax can include a monetary currency indicator prefixing one or more alphanumeric characters (e.g., $Cash). The currency indicator operates as the tagging mechanism that indicates to the server(s) 1102 to treat the inputs as a request from the payor to transfer assets, where detection of the syntax triggers a transfer of assets. The currency indicator can correspond to various currencies including but not limited to, dollar ($), euro (€), pound (£), rupee ( [symbol] ), yuan (¥), etc. Although use of the dollar currency indicator ($) is used herein, it is to be understood that any currency symbol or other symbol could equally be used. In some examples, additional or alternative identifiers can be used to trigger the peer-to-peer payment process. For instance, email, telephone number, social media handles, artist or band names, and/or the like can be used to trigger and/or identify users of a peer-to-peer payment process.

In some examples, the peer-to-peer payment process can be initiated through instances of the payment application 1124 executing on the end user devices 1106. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can be a uniform resource locator (URL), which can include a payment proxy discussed above. The P2P platform 1112 can generate the landing page to enable the recipient to conveniently receive one or more payments from one or more senders.

In some examples, the peer-to-peer payment process can be implemented within a forum. The term “forum,” as used here, refers to a content provider's media channel (e.g., a social networking platform, a microblog, a blog, video sharing platform, a music sharing platform, etc.) that enables user interaction and engagement through streaming of content, comments, posts, messages on electronic bulletin boards, messages on a social networking platform, and/or any other types of messages. In some examples, the content provider can be the service provider as described with reference to FIG. 11 or a third-party service provider associated with the server(s) 1108. In examples where the content provider is a third-party service provider, the server(s) 1108 can be accessible via one or more APIs 1130 or other integrations. In some examples, “forum” may also refer to an application or webpage of an e-commerce or retail organization that offers products and/or services. Such websites can provide an online “form” to complete before or after the products or services are added to a virtual cart. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be internal to the P2P platform 1112 (e.g., the P2P platform 1112 offers a chat or messaging service that is within the payment application or accessible via the payment application). In some examples, the messaging application can be external to the P2P platform 1112. (e.g., the messaging application is hosted by a third-party service provider associated with the server(s) 1108, which can be accessible via one or more of the APIs 1130 or other integrations). The messaging application can include, for example, a text messaging application for communication between phones (e.g., conventional mobile telephones or smartphones), or a cross-platform instant messaging application for smartphones and phones that use the Internet for communication.

Funds received from payments can be stored in stored balances that are linked to, or otherwise associated with, user accounts. In some examples, the P2P platform 1112 can enable users 1116 to perform banking transactions via instances of the payment application 1124. For example, users can configure direct deposits, recurring deposits, or other deposits (e.g., tax refunds, loans, etc.) for adding assets to their various ledgers/balances. In some examples, users can deposit physical cash via ATMs or other deposit sources, which can include merchants, such as those merchants that utilize the payment processing system described above. In some examples, the P2P platform 1112 can enable users to allocate funds between different accounts, sub-accounts, or balances (e.g., spending, saving, different assets, different currencies), etc. Further, users 1116 can configure bill pay, recurring payments, and/or the like using assets associated with their accounts. In some examples, the P2P platform 1112, with consent of the user, can track individual transactions made using the payment application and can utilize such transaction data to make personalized or customized recommendations, determine creditworthiness, generate tax documentation, and/or the like.

In addition to sending and/or receiving assets via peer-to-peer transactions, the P2P platform 1112 enables users to buy and/or sell assets via asset networks such as cryptocurrency networks, securities networks, and/or the like. In some examples, acquisition of such assets can be in whole or fractional shares. The ledger system described below with reference to FIG. 12 can enable such assets to be acquired in fractional shares and/or in real-time or near real-time (by delaying or omitting the need to buy/sell assets via asset networks or exchanges). In some examples, users can “gift” assets to other users, for example, by transferring cryptocurrency, stocks, or the like to one another.

In some examples, the P2P platform 1112 can enable users to link payment instruments to their user accounts. As a result, users can use their linked payment instruments to access funds in their accounts or balances. In some examples, the payment instrument can be a credit card, debit card, card linked to multiple accounts or balances via software or hardware, a fob or other object having payment data stored thereon, or the like. In some examples, the payment instrument can be a virtual payment instrument or a physical payment instrument. In some examples, the virtual payment instrument can be issued in real-time or for temporary usage. In some examples, the virtual payment instrument can have the same or different payment data as a corresponding physical payment instrument. Payment instruments can be customizable using a design user interface of the payment application. Such customization can enable users to select colors, stamps, images, text, or the like for surface(s) of their payment instruments. In some examples, users can draw or otherwise interact with the design user interface to personalize surface(s) of their payment instruments.

In some examples, users can associate incentives with their payment instruments. Incentives can be recommended to users based on user preferences (inferred or explicitly identified), geolocation, propensity to redeem, value, and/or the like. In some examples, incentives can be particular to individual merchants, types of merchants, types of transactions, and/or the like. In at least one example, when a user uses their payment instrument at a merchant or type of merchant associated with an incentive, or for a transaction type associated with an incentive, the P2P platform 1112 can automatically apply the incentive to the transaction. In some examples, users can gift other users “gift cards” that can be associated with payment instruments. That is, a user can transfer an amount of funds to another user and such funds can be associated with a condition (e.g., merchant, merchant type, transaction type, location, etc.) that, upon satisfaction, enables the amount of funds, or a portion thereof, to be applied to a transaction. In at least one example, when a user uses their payment instrument for a transaction that satisfies the condition, the P2P platform 1112 can automatically apply the amount of funds associated with the gift card to the transaction.

In some examples, users can configure their account such that when they use their payment instruments, the P2P platform 1112 can deposit an amount of funds into a savings account, investing account, bitcoin account, or the like.

In some examples, users can search for or browse other users, merchants, items, or the like via the payment application. In some examples, search results can be personalized and/or customized for the user (e.g., based on user data collected with consent of the user). In some examples, users can shop or otherwise purchase items from other users, merchants, or the like from within the payment application or via a deep link to a merchant application or website.

The P2P platform 1112 can offer primary and secondary accounts, wherein a primary account is a sponsor or other delegate of one or more secondary accounts. Such accounts can be useful for families, wherein a parent or other guardian is a sponsor or delegate to one or more child accounts, or where a child is a sponsor or delegate of an elderly parent's account. In some examples, primary accounts can establish limits on secondary accounts, such as spending limits, or the like. In some examples, the primary account owner is the user legally responsible for the account and their identity may be verifiable for secondary user accounts to perform certain transactions, such as buying/selling cryptocurrency or stocks. In some examples, one or more primary accounts and one or more secondary accounts can form a “group” with shared goals, such as saving, investing, or the like.

The P2P platform 1112 can present activity data via an activity user interface of the payment application. In some examples, activity can be presented by merchant, date, time, amount, or the like. In some examples, interactions between entities can be represented in conversational communications such that each interaction or transaction is represented as a message. In some examples, users can interact with individual messages and/or send/request funds from within such a conversational communication. In some examples, such conversational communications can represent conversations of a group of two or more users. Groups can be used to pool funds, obtain group discounts or incentives, or enable multiple users to participate in financial transactions together (e.g., group investing, group savings, etc.).

The P2P platform 1112 can offer a variety of financial training or learning opportunities. In some examples, such training or learning can be personalized for individual users, for example, based on user data and/or transaction data of the user that is obtained with consent of the user. In some examples, such user data and/or transaction data can be analyzed to make actionable recommendations with respect to optimizing financial health of users of the P2P platform 1112.

In some examples, components of the environment 1100 may be integrated to enable payments at the point-of-sale using assets associated with user accounts of the P2P platform 1112. As illustrated in the environment 1100, the components can communicate with one another via the network 1104, where one or more APIs 1130 or other functional components can be used to facilitate such communication.

In at least one example, an integration can enable a customer to participate in a transaction via their own computing device (e.g., user device 1106(B)) instead of interacting with a merchant device of a merchant, such as the seller device 1106(A). In such an example, the POS application 1118, associated with a payment processing platform and executable by the seller device 1106(A) of the merchant, can present a Quick Response (QR) code, or other code that can be used to identify a transaction (e.g., a transaction code), in association with a transaction between the customer and the merchant. The QR code, or other transaction code, can be provided to the POS application 1118 via an API 1130 associated with the peer-to-peer payment platform. In an example, the customer can utilize their own computing device, such as the user device 1106(B), to capture the QR code, or the other transaction code, and to provide an indication of the captured QR code, or other transaction code, to server(s) 1102.

Based at least in part on the integration of the peer-to-peer payment platform and the payment processing platform (e.g., via the API 1130), the server(s) 1102 of the seller platform 1110 can exchange communications with a payment application 1124 associated with the P2P platform 1112 and/or the POS application 1118 to process payment for the transaction using a peer-to-peer payment where the customer is a first “peer” and the merchant is a second “peer.”

Based at least in part on receiving an indication of which payment method a user (e.g., customer or merchant) intends to use for a transaction, techniques described herein utilize an integration between the P2P platform 1112 and seller platform 1110 (which can be a first- or third-party integration) such that a QR code, or other transaction code, specific to the transaction can be used for providing transaction details, location details, customer details, or the like to a computing device of the customer, such as the user device 1106(B), to enable a contactless (peer-to-peer) payment for the transaction, and transferring funds from an account of the customer to an account of the merchant.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 1106(B), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 1118 and the payment application 1124, as described herein, can process a payment transaction by routing information input via the merchant application to the payment application for completing a “frictionless” payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. A customer computing device, such as the user device 1106(B), can be specially configured as a buyer-facing device having functionality similar to the functionality described above in the brick-and-mortar example.

In some examples, based at least in part on capturing the QR code, or other transaction code, the seller platform 1110 can provide transaction data to the P2P platform 1112 for presentation via the payment application 1118 on the computing device of the customer, such as the user device 1106B(B), to enable the customer to complete the transaction via their own computing device. In some examples, in response to receiving an indication that the QR code, or other transaction code, has been captured or otherwise interacted with via the customer computing device, the P2P platform 1112 can determine that the customer authorizes payment of the transaction using funds associated with a stored balance of the customer that is managed and/or maintained by the P2P platform 1112. Such authorization can be implicit such that the interaction with the transaction code can imply authorization of the customer. Alternatively or additionally, the P2P platform 1112 can request express authorization to process payment for the transaction using the funds associated with the stored balance and the customer can interact with the payment application to expressly authorize the settlement of the transaction. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the P2P platform 1112 can transfer funds from the stored balance of the customer to the seller platform 1110. In at least one example, the seller platform 1110 can deposit the funds, or a portion thereof, into a stored balance of the merchant that is managed and/or maintained by the seller platform 1110. In such an example, the seller platform 1110 can be a “peer” to the customer in a peer-to-peer transaction.

In some examples, techniques described herein can enable the customer to interact with the transaction after payment for the transaction has been settled. For example, in at least one example, the seller platform 1110 can cause a total amount of a transaction to be presented via a user interface associated with the payment application 1124 such that the customer can provide gratuity, feedback, loyalty information, or the like, via an interaction with the user interface. In another example, the seller platform 1110 can adjust a total amount of a transaction based on events during a shopping experience, such as adding or removing a charge to the total amount based on whether a media content item requested by the customer to be played during a shopping experience was in fact played. In some examples, because the customer has already authorized payment via the P2P platform 1112, if the customer inputs a tip and/or an event affecting the total amount of the transaction is triggered, the P2P platform 1112 can transfer additional funds, associated with the tip or event, to the seller platform 1110. This pre-authorization (or maintained authorization) of sorts can enable faster, more efficient payment processing when the tip is received and/or the event initiates the trigger. Further, the customer can provide feedback and/or loyalty information via the user interface presented by the payment application, which can be associated with the transaction. Using the pre-authorization techniques described herein results in fewer data transmissions and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 1124 (e.g., instead of a native camera, or other sensor), techniques described herein can utilize an indication of the QR code, or other transaction code, received from the payment application for two-factor authentication to enable more secure payments.

It should be noted that, while some techniques described herein are directed to contactless payments using QR codes or other transaction codes, in additional or alternative examples, techniques described herein can be applicable for contact payments. That is, in some examples, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. In some examples, the payment instrument can be associated with the P2P platform 1112 as described herein (e.g., a debit card linked to a stored balance of a customer) such that when the payment instrument is caused to interact with a payment reader, the seller platform 1110 can exchange communications with the P2P platform 1112 to authorize payment for a transaction and/or provision associated transaction data to a computing device of the customer associated with the transaction.

Turning now to media content functionality provided by the environment 1100, the media content platform 1114 can provide digital media to a content consumption device 1106(D) where playback may occur using “streaming.” In examples, “streaming” media content involves encoding the media content and transmitting the encoded media content over the network 1104 to a media player or a media application executing on a device (e.g., via a speaker). The device then decodes and plays the media content while data is being received. In some cases, a buffer queues some of the data of the media content (e.g., audio data, video data, etc.) ahead of the media being played. During moments of network congestion, which leads to lower available bandwidth, less media content data is added to the buffer, which drains down as media content is being dequeued during streaming playback. However, during moments of high network bandwidth, the buffer is replenished, adding media content data to the buffer.

In at least one example, the media content platform 1114 can provide a digital media streaming service (e.g., subscription-based, non-subscription-based) that enables a content consumption device 1106(D) to stream and/or download digital media content via a listener application 1126 installed on the content consumption device 1106(D). For instance, the media content platform 1114 may comprise a digital audio streaming service (e.g., for music, podcasts, audiobooks, etc.), a digital video streaming service, and/or a streaming service that provides streaming of various different types of digital media content or multimedia. In such cases where digital media content items are downloaded and stored locally on the content consumption devices 1106(D), the listener application 1126 may verify access rights to the digital media content items at time intervals, for instance intermittently (e.g., when the content consumption device 1106(D) has a network connection with the media content platform 1114 via the network(s) 1104), and/or at regular intervals (e.g., daily, weekly, monthly, etc.). In examples, access rights to the digital media content items may be provided when a subscription to the media content platform 1114 is active, while access rights to the digital media content items may be withheld when the subscription to the media content platform 1114 is terminated. Enabling storage on the end user devices 1106 and subsequent access to digital media content items via the listener application 1126 provides the users 1116 with the ability to access the digital media content items “offline” such as when a connection to the media content platform 1114 via the network(s) 1104 is unavailable or unreliable.

In some examples, the media content platform 1114 may additionally or alternatively provide an artist management service that enables the users 1116 to manage aspects of artist business via an artist application 1128 installed on the artist device 1106(E), such as data analytics and management (e.g., listener data, consumer data, etc.), marketing, regulatory obligations, cash flow management, publishing, customer relationship management (CRM), social media, event coordination, industry communications, digital media content ingestion and storage, and so forth. In some cases, the users 1116 can have graduated access to the services, which can be based on a user type (e.g., artist, group member, personal manager, business manager, attorney, agent, etc.), risk tolerance, artist verification status, listener and/or viewer analytics (e.g., number of streams in a month), and so on. In some cases, multiple users 1116 may have access to a single user account via respective end user devices 1106, with the various users having different access privileges to services provided by the artist management service. In various scenarios, an artist can designate functions provided by the artist management service to different members of the team associated with the artist, thus granting the respective team members access to services suited to the skills of the individual team members.

In some cases, the artist application 1128 and the listener application 1126 may be distinct applications having differing user experiences and verification processes for access, such as illustrated in the environment 1100. For instance, the media content platform 1114 may request additional verification, such as a link to an artist website, a sample of an artist's work, a verified credential supplied by a third party, etc. to grant access to the artist application 1128 in addition to information requested to access the listener application 1126. Further, the artist application 1128 may provide the artist management services described herein, without the subscription-based digital media streaming services described herein, and vice versa. However, examples are also considered in which functionality provided by the artist application 1128 and the listener application 1126 partially or fully overlap, and/or where verification processes for access are substantially similar.

In at least some examples, the media content platform 1114 enables interaction between the users 1116 utilizing the listener application 1126 installed on the content consumption devices 1106(D), and the users 1116 utilizing the artist application 1128 installed on the artist devices 1106(E). For example, the media content platform 1114 may provide interconnectivity between the subscription-based digital media streaming service and the artist management service. Functionality provided by the media content platform 1114 in such instances may include a communication channel between one or more of the users 1116 (e.g., a listener, fan, music supervisor, publisher, etc.) utilizing the listener application 1126 and another user (e.g., an artist) of the users 1116 utilizing the artist application 1128. The communication channel may include, for instance, a messaging platform (also referred to as a “messaging application” herein), a live streaming platform, a videoconferencing or teleconferencing platform, and/or a combination of these.

Additionally, in some cases, the media content platform 1114 may facilitate a resource transfer between the listener application 1126 and the artist application 1128. In an example, the media content platform 1114 may direct a resource, such as a portion of a subscription fee paid by one of the users 1116 designated as a listener, to one or more of the users 1116 designated as artists based on a number of instances that the listening user consumed (e.g., streamed, downloaded, etc.) content created by respective ones of the artist users. Alternatively or additionally, the media content platform 1114 may direct a resource, such as funds, from an account associated with a listening user to an account associated with an artist user (or vice versa), in accordance with transfers between accounts as described herein. The media content platform 1114 may facilitate resource transfers in examples such as merchandise purchases, event ticket purchases, “tipping” an artist, payments for royalties or other fees, and so forth.

In some examples, the media content platform 1114 enables interaction between individual ones of the users 1116 with one another via the listener application 1126 installed on the content consumption device 1106(D) and other of the content consumption devices 1106(D) via a communication channel as described above. In an example, the listener application 1126 may provide functionality via a communication channel for a user to stream an individual digital media item, a playlist, or the like to an audience comprising other ones of the content consumption devices 1106(D). Alternatively or additionally, the communication channel may facilitate sharing of individual digital media items, playlists, user and/or artist profiles, and the like between the users 1116 via messages, uniform resource locators (URLs), quick response (QR) codes, and so forth.

In some cases, the media content platform 1114 enables interaction between individual ones of the users 1116 with one another via the artist application 1128 installed on the artist device 1106(E) and other of the artist devices 1106 via a communication channel as described above. In some instances, the media content platform 1114 may provide recommendations for a particular user indicating which of the other users 1116 to communicate with. Such a recommendation may be based on a similarity (or dissimilarity) of content created by two or more of the users 1116, an overlap (or lack thereof) of audience members of the users 1116, a geographic location of the users 1116, a coinciding event location of the users 1116, and so forth. In some examples, a user may input parameters for a desired connection via the artist application 1128, and the media content platform 1114 may filter which of the users 1116 to surface for recommendations to the user based on the input parameters. Alternatively or additionally, the media content platform 1114 may implement one or more machine learning models to filter which of the users 1116 to surface for recommendations to the user. The recommendations provided by the media content platform 1114 may be data driven and thus increase relevance of communications presented to the users 1116 and reduce unsolicited communications that may be received by the users 1116.

The media content platform 1114 may interact with the server(s) 1108 associated with the third-party service providers to, for instance, ingest digital media items, report digital media consumption data, pay royalties, and the like. In some examples, the server(s) 1108 may be accessible by the media content platform 1114 via one or more APIs 1130 or other integrations. In some cases, the third-party service provider may be a digital media content provider (e.g., a record label, a performance rights organization (PRO), an independent artist, etc.). In such cases, the media content platform 1114 may receive digital media content items from the server(s) 1108, along with metadata associated with the digital media content items. The metadata, in some instances, may indicate individual contributors to a digital media content item such as an artist or artists, a songwriter (e.g., a composer, lyricist, author, etc.), a producer (which may further include a co-producer, a mastering engineer, a mixing engineer, a recording engineer, an arranger, a programmer, etc.), a musician (e.g., instrumentalist, vocalist, etc.), a visual artist, and so forth, with an indication of the role of the individual contributor. Alternatively or additionally, the metadata may indicate information such as release date, track title, track duration, clean or explicit version, jurisdiction information, and the like. The media content platform 1114 may use the metadata to associate the digital media content item as being created by a particular user, to provide search results to the users 1116, to generate playlists, and so forth. Further, the media content platform 1114 may provide payments (e.g., royalties) to the third-party service provider based on a number of streams and/or downloads of individual digital media content items by the users 1126 via the listener application 1126.

Techniques described herein are directed to services provided via a distributed system of end user devices 1106 that are in communication with server(s) 1102 of the service provider. That is, techniques described herein are directed to a specific implementation—or, a practical application—of utilizing a distributed system of end user devices 1106 that are in communication with server(s) 1102 of the seller platform 1110, the P2P platform 1112, and/or the media content platform 1114 to perform a variety of services, as described above. The unconventional configuration of the distributed system described herein enables the server(s) 1102 that are remotely-located from end-users (e.g., users 1116) to intelligently offer services based on aggregated data associated with the end-users, such as the users 1116 (e.g., data associated with multiple, different merchants and/or multiple, different buyers; data associated with multiple different listeners and/or multiple different artists, etc.), in some examples, in near-real time. Accordingly, techniques described herein are directed to a particular arrangement of elements that offer technical improvements over conventional techniques for performing payment processing services, P2P payment services, media content services, and the like. For small business owners and artists in particular, the business environment is typically fragmented and relies on unrelated tools and programs, making it difficult for an owner or an artist to manually consolidate and view such data. The techniques described herein constantly or periodically monitor disparate and distinct user accounts, e.g., accounts within the control of the seller platform 1110, the P2P platform 1112, and/or the media content platform 1114, and those outside of the control of these service providers, to track the standing (payables, receivables, payroll, invoices, appointments, capital, balances, collaborations, etc.) of the users 1116. The techniques herein provide a consolidated view of a user's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services, P2P payment services, media content services, and/or additional or alternative services described herein. In some implementations, the distributed system is capable of applying the intelligence derived from an existing user base to a new user, thereby making the onboarding experience for the new user personalized and frictionless when compared to traditional onboarding methods. Further, models or algorithms that are used to implement techniques described herein may be retrained over time to improve outcomes for subsequent scenarios based on outcomes of previous scenarios. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 1116 and end user devices 1106. Furthermore, such features are changed dynamically based on the profiles of the users involved interacting with the GUIs. As such, techniques described herein are directed to improvements to computing systems.

The seller platform 1110, the P2P platform 1112, and/or the media content platform 1114 are capable of providing additional or alternative services, and the services described above are offered as a sampling of services. In at least one example, the seller platform 1110, the P2P platform 1112, and/or the media content platform 1114 can exchange data with the server(s) 1108 associated with third-party service providers. Such third-party service providers can provide information that enables the seller platform 1110, the P2P platform 1112, and/or the media content platform 1114 to provide services, such as those described above. In additional or alternative examples, such third-party service providers can access services of the seller platform 1110, the P2P platform 1112, and/or the media content platform 1114. That is, in some examples, the third-party service providers can be subscribers, or otherwise access, services of the seller platform 1110, the P2P platform 1112, and/or the media content platform 1114.

FIG. 12 illustrates an example environment 1200 including a service provider system 1202 which may be associated with the server(s) 1102 of FIG. 11. The environment 1200 may also include a user device 1204, which may correspond to any of the end user devices 1106 described in relation to FIG. 11. In examples, the service provider system 1202 may include one or a combination of the seller platform 1110, the P2P platform 1112, or the media content platform 1114, as well as one or more data store(s) 1206 that can store assets in an asset storage 1208, as well as data in user account(s) 1210. In some examples, the environment 1200 may also include a public blockchain 1214, one or more nodes 1216, and/or a hardware wallet 1218. The service provider system 1202, the user device 1204, public blockchain 1214, the node(s) 1216, and the hardware wallet 1218 may be connected and able to communicate via one or more networks 1220, which may have the same or similar functionality described in relation to the network 1104 of FIG. 11.

In some examples, user account(s) 1210 can include merchant account(s), customer account(s), media content subscriber account(s), artist account(s), and so forth. In at least one example, the asset storage 1208 can be used to record whether individual assets are registered to a user account 1210. For example, the asset storage 1208 can include asset wallet(s) 1222 for storing records of assets owned by the service provider system 1202, such as cryptocurrency, securities, NFTs, or the like, and communicating with one or more asset networks, such as cryptocurrency networks, NFT networks, securities networks, or the like. In some examples, the asset network can be a first-party network or a third-party network, such as a cryptocurrency exchange or the stock market. In examples where the asset network is a third-party network, the server(s) 1108 of FIG. 11 can be associated therewith.

The asset wallet 1222 can be associated with one or more addresses and can vary addresses used to acquire assets (e.g., from the asset network(s)) so that its holdings are represented under a variety of addresses on the asset network. In examples where the service provider system 1202 has holdings of cryptocurrency (e.g., in the asset wallet 1222), a user can acquire cryptocurrency directly from the service provider system 1202. In some examples, the service provider system 1202 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In some scenarios, the buying and selling of cryptocurrency, and therefore the associated updating of the public ledger of an asset network can be separate from a customer-merchant transaction or a peer-to-peer transaction, and therefore not necessarily time-sensitive. This can enable batching transactions to reduce computational resources and/or costs. The service provider system 1202 can provide the same or similar functionality for securities or other assets.

The asset storage 1208 may contain ledgers that store records of assignments of assets to users 1116. Specifically, the asset storage 1208 may include asset ledger 1224, fiat currency ledger 1226, and/or other ledger(s) 1228, which can be used to record transfers of assets between users 1116 and/or one or more third-parties (e.g., merchant network(s), payment card network(s), ACH network(s), equities network(s), the asset network, securities networks, etc.). In doing so, the asset storage 1208 can maintain a running balance of assets managed by the service provider system 1202. The ledger(s) of the asset storage 1208 can further indicate some of the running balance for individual ledger(s) stored in the asset storage 1208 are assigned or registered to one or more user account(s) 1210.

In at least one example, the asset storage 1208 can include transaction logs 1230, which can include, as transaction data, records of past transactions involving the service provider system 1202 and/or the user account 1210. In some examples, the data store(s) 1206 can store a private blockchain 1232. A private blockchain 1232 can function to record sender addresses, recipient addresses, public keys, values of cryptocurrency transferred, and/or can be used to verify ownership of cryptocurrency tokens to be transferred. In some examples, the service provider system 1202 can record transactions involving cryptocurrency until the number of transactions has exceeded a determined limit (e.g., number of transactions, storage space allocation, etc.). Based at least in part on determining that the limit has been reached, the service provider system 1202 can publish the transactions in the private blockchain 1232 to the public blockchain 1214 (e.g., associated with the asset network), where miners can verify the transactions and record the transactions to blocks on the public blockchain 1214. In at least one example, the service provider system 1202 can participate as miner(s) at least for transactions to which the respective platform is a party to, to be posted to the public blockchain 1214.

In some cases, the data store(s) 1206 can store and/or manage multiple user accounts, an example of which is described in relation to the user account 1210. In at least one example, the user account 1210 can include user account data 1234, which can include, but is not limited to, data associated with user identifying information (e.g., name, phone number, address, artist or band name, verified credentials, etc.), user identifier(s) (e.g., alphanumeric identifiers, etc.), user preferences (e.g., learned or user-specified), purchase history data (e.g., identifying one or more items purchased (and respective item information), subscription tier information, etc.), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 1234 can include account activity 1236 and user wallet key(s) 1238. In some examples, the user wallet key(s) 1238 can include a public-private key-pair and a respective address associated with the asset network or other asset networks. In some examples, the user wallet key(s) 1238 may include one or more key pairs, which can be unique to the asset network or other asset networks.

In addition to the user account data 1234, the user account 1210 can include ledger(s) for account(s) managed by the service provider system 1202, for the user. For example, the user account 1210 may include an asset ledger 1224, a fiat currency ledger 1226, and/or one or more other ledgers 1228. The ledger(s) can indicate that a corresponding user utilizes the service provider system 1202 to manage corresponding accounts (e.g., a cryptocurrency account, a securities account, a fiat currency account, an artist account, etc.). It should be noted that in some examples, the ledger(s) can be logical ledger(s) and the data can be represented in a single database. In some examples, individual ones of the ledger(s), or portions thereof, can be maintained by the service provider system 1202.

In some examples, the asset ledger 1224 can store a balance for each of one or more cryptocurrencies (e.g., Bitcoin, Ethereum, Litecoin, etc.) registered to the user account 1210. In at least one example, the asset ledger 1224 can further record transactions of cryptocurrency assets associated with the user account 1210. For example, the user account 1210 can receive cryptocurrency from the asset network using the user wallet key(s) 1238. In some examples, the user wallet key(s) 1238 may be generated for the user upon request. User wallet key(s) 1238 can be requested by the user in order to send, exchange, or otherwise control the balance of cryptocurrency held by the service provider system 1202 (e.g., in the asset wallet 1222) and registered to the user. In some examples, the user wallet key(s) 1238 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider system 1202 and the value is credited as a balance in asset ledger 1224), by purchasing currency in the form associated with the account using currency in a different form (e.g., buying a value of cryptocurrency from the service provider system 1202 using a value of fiat currency reflected in fiat currency ledger 1234, and crediting the value of cryptocurrency in asset ledger 1224), or by conducting a transaction with another user (customer or merchant) of the service provider system 1202 wherein the account receives incoming currency (which can be in the form associated with the account or a different form, in which the incoming currency may be converted to the form associated with the account).

With specific reference to funding a cryptocurrency account, a user may have a balance of cryptocurrency stored in another cryptocurrency wallet. In some examples, the other cryptocurrency wallet can be associated with a third-party unrelated to the service provider system 1202 (i.e., an external account). Such a transaction can request that the user to transfer an amount of the cryptocurrency in a message signed by user's private key to an address provided by the service provider system 1202. In at least one example, the transaction can be sent to miners to bundle the transaction into a block of transactions and to verify the authenticity of the transactions in the block. Once a miner has verified the block, the block is written to the public blockchain 1214 where the service provider system 1202 can then verify that the transaction has been confirmed and can credit the user's asset ledger 1224 with the transferred amount. When an account is funded by transferring cryptocurrency from a third-party cryptocurrency wallet, an update can be made to the public blockchain 1214. In some cases, this update of the public blockchain 1214 need not take place at a time-critical moment, such as when a transaction is being processed by a merchant in store or online.

In some examples, a user can purchase cryptocurrency to fund their cryptocurrency account. In some examples, the user can purchase cryptocurrency through services offered by the service provider system 1202. As described above, in some examples, the service provider system 1202 can acquire cryptocurrency from a third-party source. In examples where the service provider system 1202 has its own cryptocurrency assets, cryptocurrency transferred in a transaction (e.g., data with address provided for receipt of transaction and a balance of cryptocurrency transferred in the transaction) can be stored in an asset wallet 1222 associated with the service provider system 1202. In at least one example, the service provider system 1202 can credit the asset ledger 1224 of the user. Additionally, while the service provider system 1202 recognizes that the user retains the value of the transferred cryptocurrency through crediting the asset ledger 1224, an inspection of the blockchain will show the cryptocurrency as having been transferred to the service provider system 1202. In some examples, the asset wallet 1222 can be associated with many different addresses. In such examples, an inspection of the blockchain may not necessarily associate all cryptocurrency stored in asset wallet 1222 as belonging to the same entity. The presence of a private ledger used for real-time transactions and maintained by the service provider system 1202, combined with updates to the public ledger at other times, allows for extremely fast transactions using cryptocurrency to be achieved. In some examples, the “private ledger” can refer to the asset ledger 1224, which in some examples, can utilize the private blockchain 1232, as described herein. The “public ledger” can correspond to the public blockchain 1214 associated with the asset network.

In at least one example, an asset ledger 1224, fiat currency ledger 1226, or the like associated with the user account 1210 can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 1224. In some examples, a user can receive fiat currency or another currency in the form of payment for a transaction with another user. In at least one example, at least a portion of such funds can be converted into cryptocurrency by the service provider system 1202 and used to fund the asset ledger 1224 of the user.

In examples, a user can also have an account in U.S. dollars, which can be tracked, for example, via the fiat currency ledger 1226. Such an account can be funded by transferring money from a bank account at a third-party bank to an account maintained by the service provider system 1202 as is conventionally known. In some examples, a user can receive fiat currency in the form of payment for a transaction with another user. In such examples, at least a portion of such funds can be used to fund the fiat currency ledger 1226.

In some examples, a user can have one or more internal payment cards registered with the service provider system 1202. Internal payment cards can be linked to one or more of the accounts associated with the user account 1210. In some embodiments, options with respect to internal payment cards can be adjusted and managed using an application (e.g., the payment application 1126, a wallet application 1212, etc.).

In at least one example, the user account 1210 can be associated with the asset wallet accessible via a wallet application 1212 of the user device 1204, or a stored balance for use in payment transactions, peer-to-peer transactions, payroll payments, etc. In at least one example, the asset wallet 1222 can store data indicating an address provided for receipt of a cryptocurrency transaction. In at least one example, the balance of the asset wallet 1222 can be based at least in part on a balance of the asset ledger 1224. In at least one example, funds availed via the asset wallet 1222 can be stored in the asset wallet 1222. Funds availed via the asset wallet 1222 can be tracked via the asset ledger 1224. The asset wallet 1222, however, can be associated with additional cryptocurrency funds.

In at least one example, when the service provider system 1202 includes a private blockchain 1232 for recording and validating cryptocurrency transactions, the asset wallet 1222 can be used instead of, or in addition to, the asset ledger 1224. For example, a merchant can provide the address of the asset wallet 1222 for receiving payments. In an example where a customer is paying in cryptocurrency and the customer has their own cryptocurrency wallet account associated with the service provider system 1202, the customer can send a message signed by its private key including its wallet address (i.e., of the customer) and identifying the cryptocurrency and value to be transferred to the merchant's asset wallet 1222. The service provider system 1202 can complete the transaction by reducing the cryptocurrency balance in the customer's cryptocurrency wallet and increasing the cryptocurrency balance in the merchant's asset wallet 1222. In addition to recording the transaction in the respective cryptocurrency wallets, the transaction can be recorded in the private blockchain 1232 and the transaction can be confirmed. A user can perform a similar transaction with cryptocurrency in a peer-to-peer transaction as described above.

While the asset ledger 1224 and/or asset wallet 1222 are each described above with reference to cryptocurrency, the asset ledger 1224 and/or asset wallet 1222 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider system 1202 is an aspect of the technology disclosed that enables technical advantages of increased processing speed and improved security.

The description of the environment 1200 above generally relates to a centralized service provider 1202 that at least partially facilitates storing and managing assets in the data store 1206. However, the environment 1200 may also facilitate decentralized storage and management of assets alternatively or in addition to centralized storage and management as described above. For instance, the environment 1200 may include a decentralized platform implemented using a plurality of nodes (e.g., web nodes), an example of which is illustrated as node 1216. The node 1216 is representative of a computer or other device tasked with validating transactions and/or maintaining a copy of a blockchain ledger, such as a ledger associated with the public blockchain 1214. The decentralized platform may be implemented via the environment 1200 through use of decentralized identifiers and verifiable credentials that are stored and managed by user devices 1204. A decentralized identifier is configured as a self-owned identifier that supports decentralized authentication and routing. A self-owned identifier in a blockchain network is a unique identifier that is owned and controlled by an individual entity on the blockchain, as contrasted with an entity controlled by a centralized authority (e.g., the service provider system 1202). The decentralized identity referenced by a decentralized identifier gives an entity control over what data can be accessed, stored, modified, and so forth by other entities, such as the service provider system 1202.

The node 1216, as representative of one of a plurality of decentralized nodes (e.g., decentralized web nodes), supports data storage and relays that allows entities, service provider systems, individuals, organizations and so forth to send, store, and receive encrypted or public messages and data. The node 1216 is universally addressable and is “crawlable” using data addressing in relation to the decentralized identifiers. The node 1216 is also configured to support decentralized replication of data across the nodes that is consistent across multiple nodes over time through continued data communication between the nodes in the decentralized platform. The node 1216 is configurable to support secure encryption through use of a cryptographic key associated with an individual's decentralized identifier and support semantic discovery to discover different forms of published data.

Verifiable credentials are an open standard for digital credentials, and employ a data format for cryptographic presentation and verification of claims. A verifiable credential represents an indication of trust of a piece of information related to an entity. For example, a verifiable credential indicates that the issuer of the verifiable credential trusts the holder of the verifiable credential; the holder trusts a verifier of the verifiable credential; and that the verifier trusts the issuer. Verifiable credentials may be issued by anyone, about anything, and can be presented to and verified by everyone granted access to the verifiable credential. Accordingly, a user of the user device 1204 may be an issuer, a holder, and/or a verifier, as can the service provider system 1202.

In some examples, the user device 1204 may implement a wallet application 1212 configured to manage decentralized identifiers and/or verifiable credentials. For instance, the wallet application 1212 may provide a user interface for implementation of access controls to various data associated with the decentralized identifier by the service provider system 1202, to other user devices, and so forth. Additionally, the wallet application 1212 may be configured to provide functionality for resource transfers (e.g., cryptocurrency, fiat currency, etc.) with the service provider system 1202, other user devices, and the like, based on techniques described herein.

In some examples, the hardware wallet 1218 may store cryptocurrency assets in combination with the wallet application 1212 and the service provider system 1202. For instance, the hardware wallet 1218, the wallet application 1212, and the service provider system 1202 may each store a respective, different private key, where a transaction with the cryptocurrency assets is signed by at least two of the three private keys. The user interface provided by the wallet application 1212 may allow a user to request a transaction. The wallet application 1212 may then sign the transaction with the private key of the wallet application 1212, have either the hardware wallet 1218 or the service provider system 1202 use a second of the three private keys to sign the transaction, and then provide the transaction with two signatures to the public blockchain 1214 for processing.

FIG. 13 depicts an illustrative block diagram illustrating a system 1300 for performing techniques described herein. The system 1300 includes a user device 1302, that communicates with server computing device(s) (e.g., server(s) 1304) via network(s) 1306 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 1302 is illustrated, in additional or alternate examples, the system 1300 can have multiple user devices, as described above with reference to FIG. 11.

For example, in some implementations, a user interface such as interface 120, 700, 800, or 900 may be deployed at user device 1302 and/or generative AI models deployed at server 1304. In this manner, listeners, users, artists, content creators, and others may leverage the techniques described herein to receive relevant outputs from generative AI models.

In at least one example, the user device 1302 can be any suitable type of computing device, e.g., portable, semi-portable, semi-stationary, or stationary. Some examples of the user device 1302 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, a speaker device, an automobile or other vehicle type, an Internet of Things (IoT) device, etc. That is, the user device 1302 can be any computing device capable of sending communications and performing the functions according to the techniques described herein. The user device 1302 can include devices, e.g., payment card readers, or components capable of accepting payments, as described below. The user device 1302 may be representative of, and provide functionality for, the user devices 1106 described in relation to FIG. 11.

In the illustrated example, the user device 1302 includes one or more processors 1308, one or more computer-readable media 1310, one or more communication interface(s) 1312, one or more input/output (I/O) devices 1314, a display 1316, sensor(s) 1318, one or more encoders 1346, and one or more decoders 1348.

In at least one example, each processor 1308 can itself comprise one or more processors or processing cores. For example, the processor(s) 1308 can be implemented as one or more microprocessors, microcomputers, microcontrollers, digital signal processors, central processing units, state machines, logic circuitries, and/or any devices that manipulate signals based on operational instructions. In some examples, the processor(s) 1308 can be one or more hardware processors and/or logic circuits of any suitable type specifically programmed or configured to execute the algorithms and processes described herein. The processor(s) 1308 can be configured to fetch and execute computer-readable processor-executable instructions stored in the computer-readable media 1310.

Depending on the configuration of the user device 1302, the computer-readable media 1310 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 1310 can include, but is not limited to, RAM, ROM, EEPROM, flash memory, solid-state storage, magnetic disk storage, optical storage, and/or other computer-readable media technology. Further, in some examples, the user device 1302 can access external storage, such as RAID storage systems, storage arrays, network attached storage, storage area networks, cloud storage, or any other medium that can be used to store information and that can be accessed by the processor(s) 1308 directly or through another computing device or network. Accordingly, the computer-readable media 1310 can be computer storage media able to store instructions, components or components that can be executed by the processor(s) 1308. Further, when mentioned, non-transitory computer-readable media exclude media such as energy, carrier signals, electromagnetic waves, and signals per se.

The computer-readable media 1310 can be used to store and maintain any number of functional components that are executable by the processor(s) 1308. In some implementations, these functional components comprise instructions or programs that are executable by the processor(s) 1308 and that, when executed, implement operational logic for performing the actions and services attributed above to the user device 1302. Functional components stored in the computer-readable media 1310 can include a user interface 1320 to enable users to interact with the user device 1302, and thus the server(s) 1304 and/or other networked devices. In some examples, the user interface 1320 can be similar to user interfaces 120, 700, 800, and/or 900. In at least one example, a user can interact with the user interface via touch input, spoken input, gesture, or any other type of input. The word “input” is also used to describe “contextual” input that may not be directly provided by the user via the user interface 1320. For example, user's interactions with the user interface 1320 are analyzed using, e.g., natural language processing techniques, user movement tracking techniques, eye tracking techniques, etc. to determine context or intent of the user, which may be treated in a manner similar to “direct” user input.

Depending on the type of the user device 1302, the computer-readable media 1310 can also optionally include other functional components and data, such as other components and data 1322, which can include programs, drivers, etc., and the data used or generated by the functional components. In addition, the computer-readable media 1310 can also store data, data structures and the like, that are used by the functional components. Further, the user device 1302 can include many other logical, programmatic and physical components, of which those described are merely examples that are related to the discussion herein.

In at least one example, the computer-readable media 1310 can include additional functional components, such as an operating system 1324 for controlling and managing various functions of the user device 1302 and for enabling user interactions.

The communication interface(s) 1312 can include one or more interfaces and hardware components for enabling communication with various other devices, such as over the network(s) 1306 or directly. For example, communication interface(s) 1312 can enable communication through one or more network(s) 1306, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 1306 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 1302 can further include one or more input/output (I/O) devices 1314. The I/O devices 1314 can include speakers, a microphone, a camera, and various user controls (e.g., buttons, a joystick, a keyboard, a keypad, etc.), a haptic output device, and so forth. The I/O devices 1314 can also include attachments that leverage the accessories (audio-jack, USB-C, Bluetooth, etc.) to connect with the user device 1302.

In at least one example, user device 1302 can include a display 1316. Depending on the type of computing device(s) used as the user device 1302, the display 1316 can employ any suitable display technology. For example, the display 1316 can be a liquid crystal display, a plasma display, a light emitting diode display, an OLED (organic light-emitting diode) display, an electronic paper display, or any other suitable type of display able to present digital content thereon. In at least one example, the display 1316 can be an augmented reality display, a virtual reality display, or any other display able to present and/or project digital content. In some examples, the display 1316 can have a touch sensor associated with the display 1316 to provide a touchscreen display configured to receive touch inputs for enabling interaction with a graphic interface presented on the display 1316. Accordingly, implementations herein are not limited to any particular display technology. In some examples, the user device 1302 may not include the display 1316, and information can be presented by other means, such as aurally, haptically, etc.

In addition, the user device 1302 can include sensor(s) 1318. The sensor(s) 1318 can include a global positioning system (“GPS”) device able to indicate location information. Further, the sensor(s) 1318 can include, but are not limited to, an accelerometer, gyroscope, compass, proximity sensor, camera, microphone, and/or a switch.

In some examples, the GPS device can be used to identify a location of a user. In at least one example, the location of the user can be used by the seller platform 1110, the P2P platform 1112, and/or the media content platform 1114, described above, to provide one or more services. That is, in some examples, the service provider can implement geofencing to provide particular services to users by the seller platform 1110, the P2P platform 1112, and/or the media content platform 1114.

In examples, the user device 1302 includes a codec system, which may comprise an encoder 1346 and/or a decoder 1348. The encoder 1346 is configured to encode a data stream or signal from an analog signal (e.g., an analog audio signal, an analog video signal, etc.) to a digital signal for transmission or storage. The decoder 1348 is configured to convert the digital signal back to an analog signal, such as for playback or editing. In some cases, the encoder 1346 may be configured to encode the data stream or analog signal in an encrypted format, and the decoder 1348 may accordingly be configured to decrypt the digital signal as part of the decoding process (e.g., using a cryptographic key). Additionally, in some examples, the encoder 1346 may compress data to reduce transmission bandwidth and/or storage space for the digital signal. One example of a compression codec system is a lossless codec, in which the digital data stream is a compressed format of the original data stream, but retains the information present in the original data stream. Another example of a compression codec system is a lossy codec which reduces the quality of the digital data stream but can increase the compression of the data stream relative to lossless codec systems. The codec system comprising the encoder 1346 and/or the decoder 1348 may be specialized to accomplish various different objectives, such as to preserve motion, preserve color, minimize latency, maintain fidelity, minimize bit-rate, optimize for different output device types, maintain synchronization of audio and video (e.g., using a metadata synchronization data stream), and so on. Although not explicitly illustrated in the example system 1300, the server 1304 may include an encoder 1346 and/or a decoder 1348 as well.

Additionally, the user device 1302 can include various other components that are not shown, examples of which include removable storage, a power source, such as a battery and power control unit, a barcode scanner, a printer, a cash drawer, and so forth.

In addition, as described in relation to FIG. 11, the user device 1302 can include, be connectable to, or otherwise be coupled to a reader device 1326, for reading payment instruments and/or identifiers associated with payment objects. The reader device 1326 can include a read head for reading a magnetic strip of a payment card, and further can include encryption technology for encrypting the information read from the magnetic strip. Additionally or alternatively, the reader device 1326 can be an EMV payment reader, which in some examples, can be embedded in the user device 1302. Moreover, numerous other types of readers can be employed with the user device 1302 herein, depending on the type and configuration of the user device 1302.

The reader device 1326 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data from various types of payment instruments. Accordingly, the reader device 1326 may include hardware implementation, such as slots, magnetic tracks, and rails with one or more sensors or electrical contacts to facilitate detection and acceptance of a payment instrument. That is, the reader device 1326 may include hardware implementations to enable the reader device 1326 to interact with a payment instrument via a swipe, a dip, or a tap to obtain payment data associated with a customer. Additionally or optionally, the reader device 1326 may also include a biometric sensor to receive and process biometric characteristics and process them as payment instruments, given that such biometric characteristics are registered with the payment service and connected to a financial account with a bank server. The reader device 1326 may include processing unit(s), computer-readable media, a reader chip, a transaction chip, a timer, a clock, a network interface, a power supply, and so on. That is, the reader device 1326 may include any of the computing components described herein with reference to the user device 1302 to implement the functionality provided by the reader device 1326.

In examples, the reader device 1326 includes a reader chip, which may perform functionality to control the power supply, among other functionality of the reader device 1326. The power supply may include one or more power supplies such as a physical connection to AC power or a battery. Power supply may include power conversion circuitry for converting AC power and generating a plurality of DC voltages for use by components of reader device 1326. When power supply includes a battery, the battery may be charged via a physical power connection, via inductive charging, or via any other suitable method.

The reader device 1326 may also include a transaction chip that may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. The transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While the user device 1302, which can be a POS terminal, and the reader device 1326 are shown as separate devices, in additional or alternative examples, the user device 1302 and the reader device 1326 can be part of a single device, which may be a battery-operated device. In some examples, the reader device 1326 can have a display integrated therewith, which can be in addition to (or as an alternative of) the display 1316 associated with the user device 1302.

The server(s) 1304 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 1304 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 1304 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 1304 can include one or more processors 1328, one or more computer-readable media 1330, one or more I/O devices 1332, and one or more communication interfaces 1334. Each processor 1328 can be a single processing unit or a number of processing units, and can include single or multiple computing units or multiple processing cores. The processor(s) 1328 can be implemented as one or more microprocessors, microcomputers, microcontrollers, digital signal processors, central processing units, state machines, logic circuitries, and/or any devices that manipulate signals based on operational instructions. For example, the processor(s) 1328 can be one or more hardware processors and/or logic circuits of any suitable type specifically programmed or configured to execute the algorithms and processes described herein. The processor(s) 1328 can be configured to fetch and execute computer-readable instructions stored in the computer-readable media 1330, which can program the processor(s) 1328 to perform the functions described herein.

The computer-readable media 1330 can include volatile and nonvolatile memory and/or removable and non-removable media implemented in any type of technology for storage of information, such as computer-readable instructions, data structures, program components, or other data. Such computer-readable media 1330 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 1304, the computer-readable media 1330 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 1330 can be used to store any number of functional components that are executable by the processor(s) 1328. In many implementations, these functional components comprise instructions or programs that are executable by the processors 1328 and that, when executed, specifically configure the one or more processors 1328 to perform the actions attributed above to the seller platform 1110, the P2P platform 1112, and/or the media content platform 1114, and/or perform the methods described herein. Functional components stored in the computer-readable media 1330 can optionally include a merchant component 1336, a training component 1338, and one or more other components and data 1340. The computer-readable media 1330 can additionally include an operating system 1342 for controlling and managing various functions of the server(s) 1304.

The merchant component 1336 can be configured to receive transaction data from POS systems. The merchant component 1336 can transmit requests (e.g., authorization, capture, settlement, etc.) to payment service server computing device(s) to facilitate POS transactions between merchants and customers. The merchant component 1336 can communicate the successes or failures of the POS transactions to the POS systems.

The training component 1338 can be configured to train models using machine-learning mechanisms, as well as retrain the models to improve outputs provided by the models based on feedback received over time. For example, a machine-learning mechanism can analyze training data to train a data model that generates an output, which can be a recommendation, a score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a datastore associated with the user device(s) 1302 and/or the server(s) 1304 for use at a time after the data models have been trained (e.g., at runtime).

The one or more other components and data 1340 can include generative AI models 141 and 143 (and/or content recommendation service 164), prompt generator service 142, and/or paraphraser component 154, the functionality of which is described, at least partially, above. Further, the one or more other components and data 1340 can include programs, drivers, etc., and the data used or generated by the functional components. Further, the server(s) 1304 can include many other logical, programmatic and physical components, of which those described above are merely examples that are related to the discussion herein.

The one or more software components referenced herein may be implemented as more components or as fewer components, and functions described for the software components may be redistributed depending on the details of the implementation. Software used herein is stored on non-transitory storage medium (e.g., volatile or non-volatile memory for a computing device), hardware, or firmware (or any combination thereof) components. Modules are typically functional such that they may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a software component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The communication interface(s) 1334 can include one or more interfaces and hardware components for enabling communication with various other devices, such as over the network(s) 1306 or directly. For example, communication interface(s) 1334 can enable communication through one or more network(s) 1306, which can include, but are not limited any type of network known in the art, as described herein.

The server(s) 1304 can further be equipped with various I/O devices 1332. Such I/O devices 1332 can include a display, various user interface controls (e.g., buttons, joystick, keyboard, mouse, touch screen, biometric or sensory input devices, etc.), audio speakers, connection ports and so forth.

In at least one example, the system 1300 can include a datastore 1344 that can be configured to store data that is accessible, manageable, and updatable. In some examples, the datastore 1344 can be integrated with the user device 1302 and/or the server(s) 1304. In other examples, as shown in FIG. 13, the datastore 1344 can be located remotely from the server(s) 1304 and can be accessible to the server(s) 1304. The datastore 1344 can comprise multiple databases and/or servers connected locally and/or remotely via the network(s) 1306. In at least one example, the datastore 1344 can store user profiles, which can include merchant profiles, customer profiles, artist profiles, and so on.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, media content consumption data (e.g., number of streams of media content and by which artists, direct artist payouts, playlists generated or “favorited,” durations of listening and/or watching individual media content items, actions performed while consuming media content (e.g., skips, repeats, volume changes, etc.), locations at which media content is consumed, devices used to consume media content, activities during which media content is consumed, etc.), etc.

Artist profiles can store data including, but not limited to, artist information (e.g., artist's performance or stage name, band name, artist's legal name, record label, phone number, address, social media handles, website address, banking information, etc.), artist preferences (e.g., learned or artist-specified), media content (and/or associated data) at least partially attributed to the artist (e.g., songs, videos, artists in a same genre or having shared listeners, etc.), event data (e.g., tour dates, appearance dates, appointments, etc.), financial data (e.g., advance data, recoupment data, royalty data, payouts data, etc.), payroll data (e.g., employees, contractors, venues, payroll frequency, etc.), listening data (e.g., number of streams on media content platform(s), listening trends, etc.), fan data (number of followers on media content platform(s), number of followers on social media platform(s), etc.), reservations data (e.g., venue reservations, studio recording reservations, previous reservations, upcoming (scheduled) reservations, reservation duration, interactions associated with such reservations, etc.), inventory data (e.g., merchandise inventory), customer service data, and so forth.

Furthermore, in at least one example, the datastore 1344 can store inventory database(s) and/or catalog database(s). As described above, an inventory can store data associated with a quantity of each item that a merchant has available to the merchant. Furthermore, a catalog can store data associated with items that a merchant has available for acquisition. The datastore 1344 can store additional or alternative types of data as described herein.

### EXAMPLE CLAUSES

Clause 1. A computer-implemented method of refining generative artificial intelligence (AI) model outputs, the method comprising: receiving, from a first device, a component list for an item that is to be included in a menu of items, the component list including a plurality of components; generating, using a first generative AI model, a text natural language response that includes a description for the item based on the component list; obtaining visual media data of the item that depicts one or more components of the plurality of components of the component list; providing the text natural language response and the visual media data of the item to a second generative AI model; modifying, using the second generative AI model, the description for the item of the text natural language response based on detection in the visual media data of at least one component in the component list by the second generative AI model; and providing the modified description to the first device for inclusion in the menu of items.

Clause 2. The subject matter according to any preceding clause, wherein the visual media data includes at least one of: one or more images or one or more videos.

Clause 3. The subject matter according to any preceding clause, wherein the item is a food item, the plurality of components are a plurality of ingredients of the food item, and the component list is an ingredients list that lists the plurality of ingredients of the food item.

Clause 4. The subject matter according to any preceding clause, further comprising: determining a prompt for the first generative AI model that is based on the component list and is based on one or more example descriptions associated with the item, wherein the example descriptions are associated with one or more other items that are different than the item and are retrieved from a database of descriptions; and providing the prompt to the first generative AI model.

Clause 5. The subject matter according to any preceding clause, wherein modifying the description includes at least one of: adding a component to the modified description based on detection of the component in the visual media data by the second generative AI model; or removing a component in the component list from the modified description based on lack of detection of the component in the visual media data by the second generative AI model.

Clause 6. The subject matter according to any preceding clause, wherein modifying the description includes detecting in the visual media data, by the second AI model, the components in the component list, wherein the second generative AI model is trained to detect features including objects in visual media data.

Clause 7. The subject matter according to any preceding clause, wherein detecting the components in the visual media data includes segmenting the visual media data, detecting a plurality of objects in the visual media data, and ignoring one or more of the objects, wherein the one or more ignored objects: are of a particular category; or are below a threshold relevance score associated with the item.

Clause 8. The subject matter according to any preceding clause, modifying the description includes identifying one or more components of the item in the visual media data that present a potential hazard to a user of the item; and modifying the description to include an indication of the potential hazard.

Clause 9. A computer-implemented method of refining generative artificial intelligence (AI) model outputs, the method comprising: receiving, from a first device, a component list for an item that is to be included in a menu of items, the component list including a plurality of components; obtaining context data associated with the item; determining a prompt for a first generative AI model that includes or is based on the component list and is based on the context data; providing the prompt to the first generative AI model; generating, using the first generative AI model, a text natural language response that includes a description for the item based on the prompt; obtaining visual media data of the item that depicts one or more components of the plurality of components of the component list; providing the text natural language response and the visual media data of the item to a second generative AI model; modifying, using the second generative AI model, the description for the item of the text natural language response based on detection in the visual media data of at least one component in the component list by the second generative AI model; and providing the modified description to the first device for inclusion in the menu of items.

Clause 10. The subject matter according to any preceding clause, wherein the context data includes one or more example descriptions associated with the item, wherein at least one of the example descriptions is associated with one or more other items that are different than the item and include one or more characteristics of the item.

Clause 11. The subject matter according to any preceding clause, wherein the context data includes at least one of: user information indicating one or more characteristics of a user requesting the description for the item, or entity information indicating one or more characteristics of an entity associated with the user.

Clause 12. The subject matter according to any preceding clause, further comprising: determining, by the second AI model, that one or more components detected in the visual media data differ from components in the component list; and providing an indication to the first device of the one or more components that differ.

Clause 13. The subject matter according to any preceding clause, further comprising: determining, by the second AI model, that one or more components detected in the visual media data mismatch components in the component list; and generating new visual media data based on the visual media data and based on the components in the component list, if a threshold number of mismatches are detected between the components in the component list and the one or more detected components in the visual media data.

Clause 14. The subject matter according to any preceding clause, further comprising: generating modified visual media data based on the visual media data, wherein the modified visual media data includes components from the component list that are not detected in the visual media data.

Clause 15. A system comprising: one or more processors; and one or more memories having computer-readable instructions stored thereon, which when executed by one or more processors of the system, cause the system to perform operations comprising: receiving, from a first device, a component list for an item that is to be included in a menu of items, the component list including a plurality of components; generating, using a first generative AI model, a text natural language response that includes a description for the item based on the component list; obtaining visual media data of the item that depicts one or more components of the plurality of components of the component list; providing the text natural language response and the visual media data of the item to a second generative AI model; modifying, using the second generative AI model, the description for the item of the text natural language response based on detection in the visual media data of at least one component in the component list by the second generative AI model; and providing the modified description to the first device for inclusion in the menu of items.

Clause 16. The subject matter according to any preceding clause, further comprising operations of: obtaining an identification of the item; and generating the component list using the first generative AI model based on the identification.

Clause 17. The subject matter according to any preceding clause, further comprising operations of: determining a description tone based on at least the visual media data and context data associated with the item; and modifying the description, by at least one of the first or second AI model, based on the description tone.

Clause 18. The subject matter according to any preceding clause, further comprising operations of: determining a category of the item by the first generative AI model; and modifying the description, by at least one of the first or second AI model, based on the category.

Clause 19. The subject matter according to any preceding clause, wherein the operation of modifying the description based on the category includes modifying one or more characteristics of the description, wherein the one or more characteristics includes at least one of a length of the description and a tone of the description.

Clause 20. The subject matter according to any preceding clause, further comprising operations of: obtaining user feedback data based on one or more actions of a user, wherein the user feedback data is based on the modified description, wherein the user feedback data includes at least one of: an indication that the user changed the modified description and indications of the changes made to the modified description by the user; or an indication that the user used the modified description in the menu; receiving a request to generate a second description of the item; and modifying a prompt based on the user feedback data and providing the prompt to the first generative AI model or the second generative AI model to generate the second description of the item.

Clause 21. The subject matter according to any preceding clause, wherein the visual media data includes a plurality of images and/or videos, wherein in at least one of the plurality of images and/or videos, the item is absent from depiction and one or more characteristics are depicted to be associated with the item in the description.

Clause 22. The subject matter according to any preceding clause, wherein the text natural language response that includes a description for the item is in a particular format, wherein the particular format includes one of: a list of the plurality of components, or a descriptive sentence of the item.

Clause 23. The subject matter according to any preceding clause, wherein determining a prompt includes formatting, by a prompt generator, the prompt comprising at least respective portions of the component list and context data associated with the item.

Clause 24. The subject matter according to any preceding clause, further comprising receiving one or more additional user inputs after providing the description to the first device; and generating, by the generative AI model and responsive to the one or more additional user inputs, a new description based on the one or more changes made by the user to the description or to the context data.

### CONCLUSION

Although the subject matter has been described in language specific to structural features and/or methodological acts, it is to be understood that the subject matter defined in the appended claims is not necessarily limited to the specific features or acts described. Rather, the specific features and steps are disclosed as example forms of implementing the claims.

The methods and processes described above may be embodied in, and fully or partially automated via, software code modules executed by one or more general purpose computers or processors. The code modules may be stored in any type of computer-readable storage medium or other computer storage device. Some or all of the methods may additionally or alternatively be embodied in specialized computer hardware.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described in the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A computer-implemented method of refining generative artificial intelligence (AI) model outputs, the method comprising:
receiving, from a first device, a component list for an item that is to be included in a menu of items, the component list including a plurality of components;
generating, using a first generative AI model, a text natural language response that includes a description for the item based on the component list;
obtaining visual media data of the item that depicts one or more components of the plurality of components of the component list;
providing the text natural language response and the visual media data of the item to a second generative AI model;
modifying, using the second generative AI model, the description for the item of the text natural language response based on detection in the visual media data of at least one component in the component list by the second generative AI model; and
providing the modified description to the first device for inclusion in the menu of items.

2. The computer-implemented method of claim 1, wherein the visual media data includes at least one of: one or more images or one or more videos.

3. The computer-implemented method of claim 1, wherein the item is a food item, the plurality of components are a plurality of ingredients of the food item, and the component list is an ingredients list that lists the plurality of ingredients of the food item.

4. The computer-implemented method of claim 1, further comprising:
determining a prompt for the first generative AI model that is based on the component list and is based on one or more example descriptions associated with the item, wherein the example descriptions are associated with one or more other items that are different than the item and are retrieved from a database of descriptions; and
providing the prompt to the first generative AI model.

5. The computer-implemented method of claim 1, wherein modifying the description includes at least one of:
adding a component to the modified description based on detection of the component in the visual media data by the second generative AI model; or
removing a component in the component list from the modified description based on lack of detection of the component in the visual media data by the second generative AI model.

6. The computer-implemented method of claim 1, wherein modifying the description includes detecting in the visual media data, by the second AI model, the components in the component list, wherein the second generative AI model is trained to detect features including objects in visual media data.

7. The computer-implemented method of claim 6, wherein detecting the components in the visual media data includes segmenting the visual media data, detecting a plurality of objects in the visual media data, and ignoring one or more of the objects, wherein the one or more ignored objects:
are of a particular category; or
are below a threshold relevance score associated with the item.

8. The computer-implemented method of claim 1, wherein modifying the description includes identifying one or more components of the item in the visual media data that present a potential hazard to a user of the item; and
modifying the description to include an indication of the potential hazard.

9. A computer-implemented method of refining generative artificial intelligence (AI) model outputs, the method comprising:
receiving, from a first device, a component list for an item that is to be included in a menu of items, the component list including a plurality of components;
obtaining context data associated with the item;
determining a prompt for a first generative AI model that includes or is based on the component list and is based on the context data;
providing the prompt to the first generative AI model;
generating, using the first generative AI model, a text natural language response that includes a description for the item based on the prompt;
obtaining visual media data of the item that depicts one or more components of the plurality of components of the component list;
providing the text natural language response and the visual media data of the item to a second generative AI model;
modifying, using the second generative AI model, the description for the item of the text natural language response based on detection in the visual media data of at least one component in the component list by the second generative AI model; and
providing the modified description to the first device for inclusion in the menu of items.

10. The computer-implemented method of claim 9, wherein the context data includes one or more example descriptions associated with the item, wherein at least one of the example descriptions is associated with one or more other items that are different than the item and include one or more characteristics of the item.

11. The computer-implemented method of claim 9, wherein the context data includes at least one of: user information indicating one or more characteristics of a user requesting the description for the item, or entity information indicating one or more characteristics of an entity associated with the user.

12. The computer-implemented method of claim 9, further comprising:
determining, by the second AI model, that one or more components detected in the visual media data differ from components in the component list; and
providing an indication to the first device of the one or more components that differ.

13. The computer-implemented method of claim 9, further comprising:
determining, by the second AI model, that one or more components detected in the visual media data mismatch components in the component list; and
generating new visual media data based on the visual media data and based on the components in the component list, if a threshold number of mismatches are detected between the components in the component list and the one or more detected components in the visual media data.

14. The computer-implemented method of claim 9, further comprising:
generating modified visual media data based on the visual media data, wherein the modified visual media data includes components from the component list that are not detected in the visual media data.

15. A system comprising:
one or more processors; and
one or more memories having computer-readable instructions stored thereon, which when executed by one or more processors of the system, cause the system to perform operations comprising:
receiving, from a first device, a component list for an item that is to be included in a menu of items, the component list including a plurality of components;
generating, using a first generative AI model, a text natural language response that includes a description for the item based on the component list;
obtaining visual media data of the item that depicts one or more components of the plurality of components of the component list;
providing the text natural language response and the visual media data of the item to a second generative AI model;
modifying, using the second generative AI model, the description for the item of the text natural language response based on detection in the visual media data of at least one component in the component list by the second generative AI model; and
providing the modified description to the first device for inclusion in the menu of items.

16. The system of claim 15, wherein the operations further comprise:
obtaining an identification of the item; and
generating the component list using the first generative AI model based on the identification.

17. The system of claim 15, wherein the operations further comprise:
determining a description tone based on at least the visual media data and context data associated with the item; and
modifying the description, by at least one of the first or second AI model, based on the description tone.

18. The system of claim 15, wherein the operations further comprise:
determining a category of the item by the first generative AI model; and
modifying the description, by at least one of the first or second AI model, based on the category.

19. The system of claim 18, wherein the operation of modifying the description based on the category includes modifying one or more characteristics of the description, wherein the one or more characteristics includes at least one of a length of the description and a tone of the description.

20. The system of claim 15, wherein the operations further comprise:
obtaining user feedback data based on one or more actions of a user, wherein the user feedback data is based on the modified description, wherein the user feedback data includes at least one of:
an indication that the user changed the modified description and indications of the changes made to the modified description by the user; or
an indication that the user used the modified description in the menu;
receiving a request to generate a second description of the item; and
modifying a prompt based on the user feedback data and providing the prompt to the first generative AI model or the second generative AI model to generate the second description of the item.
